(19) United States
(12) Patent Application Publication
(10) Pub. No.: US 2026/0147742 A1
(43) Pub. Date: May 28, 2026

(54) Data Processing Systems Using Hierarchical and Recursive Architectures and Non abelian Associative Operations

(71) Applicant: Mahesh Godavarti, Cupertino, CA (US)

(72) Inventor: Mahesh Godavarti, Cupertino, CA (US)

(21) Appl. No.: 19/438,131

(22) Filed: Dec. 31, 2025

Related U.S. Application Data
(63) Continuation of application No. PCT/US02/57398, filed on Nov. 27, 2025.
(60) Provisional application No. 63/726,109, filed on Nov. 27, 2024.
(60) Provisional application No. 63/798,309, filed on May 1, 2025.
(60) Provisional application No. 63/800,618, filed on May 6, 2025.
(60) Provisional application No. 63/801,399, filed on May 7, 2025.

(51) Int. Cl. G06F 16/22

(52) U.S. Cl. CPC G06F 16/2264; G06F 16/2237

(57) ABSTRACT

Methods, systems, and apparatus, including computer programs encoded on computer storage media, for processing multidimensional multisets of data values including systems and methods utilizing non-abelian mathematical sets equipped with non-abelian associative binary operations and systems and methods utilizing hierarchical and look-ahead multidimensional recursive transducer architectures.

### CROSS-REFERENCE TO RELATED APPLICATIONS

This application is a continuation of International Application No. PCT/US25/57398 filed Nov. 27, 2025 entitled “Data Processing Systems Using Hierarchical and Recursive Architectures and Non-abelian Associative Operations” which claims priority to U.S. Provisional Patent Application No. 63/726,109 filed Nov. 27, 2024 entitled “Improved Sentience Processing”, U.S. Provisional Patent Application No. 63/798,309 filed May 1, 2025 entitled “Data Processing Systems Using Hierarchical Architectures and Non-Abelian Associative Operations”, U.S. Provisional Patent Application No. 63/800,618 filed May 6, 2025 entitled “Data Processing Systems Using Hierarchical Architectures and Non-Abelian Associative Operations”, and U.S. Provisional Patent Application No. 63/801,399 filed May 7, 2025 entitled “Data Processing Systems Using Hierarchical Architectures and Non-Abelian Associative Operations”, each of which is incorporated by reference herein in its entirety.

### BACKGROUND OF THE INVENTION

The present disclosure relates generally to data processing and machine-learning systems and, more particularly, to techniques for representing and processing structured, sequential, and multidimensional data, including text, images, audio signals, video signals, biological sequences, and sensor streams.

Processing of such data typically includes ingesting and normalizing inputs, transforming them into numeric representations (“embeddings”), and applying one or more transducer components (for example, encoder-decoder, autoregressive, or sequence-to-sequence models) to produce intermediate and final outputs.

Such systems may be implemented in software, hardware, or combinations thereof; trained using supervised, semi-supervised, self-supervised, or reinforcement learning; and deployed across cloud, on-premises, or edge environments. They may operate on single- or multi-modal inputs, handle variable-length sequences and multidimensional signals, and integrate with storage, indexing, and retrieval components to support downstream tasks such as classification, prediction, transformation, and generation.

### SUMMARY OF THE INVENTION

The present disclosure describes three aspects of data processing systems: (1) non-abelian embedding constructions with non-abelian associative operations that reflect real-world composition and enable a range of data-processing architectures, training methodologies, and applications; (2) hierarchical transducer architectures that provide effectively infinite context and memory; and (3) recursive transducer architectures that, during inference, emit the next value together with a learned correction embedding applied immediately to integrate the prediction into context for the next step, reducing multi-layer recontextualization and compute. The disclosure further provides systems, methods, and non-transitory computer-readable media for implementing these aspects.

### BRIEF DESCRIPTION OF THE DRAWINGS

FIG. 1 is a block diagram of an example data processing system that receives input data from client devices over a network in accordance with an example of the disclosure;

FIG. 2 is a block diagram of an example embedding and custom embedding subsystem in accordance with an example of the disclosure;

FIG. 3A is a block diagram of an example hierarchical sequence processing subsystem including an input layer, one or more processing layer groups, and an output layer in accordance with an example of the disclosure;

FIG. 3B is a block diagram of a recursive autoregressive generative neural network and a corresponding parent neural network, illustrating an input layer, stacked processing layers and layer groups, a storage device for contextual correction embeddings, and an output head in accordance with an example of the disclosure;

FIG. 4 is a flow chart of an example method for generating and using custom embeddings in accordance with an example of the disclosure; and

FIG. 5 is a flow chart of an example method for training and using sequence processing architectures in accordance with an example of the disclosure.

### DETAILED DESCRIPTION OF THE INVENTION

### Definitions

To enable a clear understanding of the disclosure, the following terms have the meanings set forth below. These definitions are provided for clarity and convenience only and are not intended to be limiting. Unless explicitly stated otherwise, the defined terms should be interpreted broadly and, in a manner, consistent with the ordinary and customary meaning of each term as understood by a person of ordinary skill in the art. The absence of a definition for a particular term does not imply any intent to limit the scope of that term, and other terms may be construed in accordance with their plain and ordinary meaning.

Data value: A data value is an individual item or unit of data that can be at least one of represented, stored, and processed by a data processing system. Some examples of data values include words in a sentence, features extracted from an image, pixels in an image, audio segments in an audio waveform, etc.

Data Dimension: A data dimension is an independent axis or coordinate along which data values are organized, ordered, or indexed (e.g. audio signals have one data dimension, images have two data dimensions, and video signals have three data dimensions).

Embedding: An embedding is a numeric representation of a data value, wherein the numeric representation is an element of a mathematical set (e.g. vector space, mathematical group).

Embedding Dimension: Embedding dimension is the number of numerical components in the numeric representation and is unrelated to data dimensions.

Element: An element is an individual member of a set that may represent a data value, an embedding, or another set.

Multiset: A multiset is a grouping of elements in which each element may occur more than once and the number of occurrences of each element is significant, irrespective of the order of the elements. Multisets can contain homogeneous elements (all of the same type) or heterogeneous elements (of different types).

Collection: A collection refers to a multiset where the elements may not follow any specific order. Examples of collections include:
Set of features extracted from an image,
Set of sentences in a training data,
Set of structured census records, and
Set of documents stored in a folder.

Sequence: A sequence refers to a multiset where the position of each element is significant (i.e. the elements in the multiset exhibit a strict order relationship), and all elements may be of the same type. The index of each element in a sequence may be derived from:
The position of the element in the sequence (e.g., words in a sentence), or
An external coordinate system (e.g., time in a sequence of audio samples). (possibly real-valued, including fractional indices)

In this specification, when a sequence is indexed by an external coordinate axis system it may be referred to as a signal.

Coordinate Axis System: Unless stated otherwise, a coordinate axis system refers to a Cartesian coordinate system having a plurality of mutually orthogonal axes.

Signal: A signal is a sequence where the index may be determined by external coordinates, such as spatial coordinates or temporal coordinates. Examples include:
A one-dimensional signal, such as audio samples indexed by time, and
A two-dimensional signal, such as an image where elements (pixels) are indexed by spatial coordinates.

Multi-dimensional Signal: A multidimensional signal extends the concept of a signal to two or more dimensions, where indexing may arise from an external coordinate system. Examples include:
A two-dimensional signal (image) where elements are pixels indexed by spatial coordinates, and
A three-dimensional signal (video) where elements are pixels indexed by spatial and temporal coordinates.

Signal Size: Signal size refers to the number of positions in a signal or multidimensional signal at which data values are defined. For a discrete one-dimensional signal, the signal size may be represented by a length (e.g., a number of audio samples). For a discrete multidimensional signal, the signal size may be represented by one or more extents along the data dimensions (e.g., the height and width of an image in pixels, or the height, width, and number of frames of a video). Unless stated otherwise, signal size refers to the number of positions in the index set of the signal and does not refer to the number of numerical components in an embedding.

Signal Support Shape: A signal support shape refers to the geometric shape of a region of a coordinate axis system on which a signal or multidimensional signal has defined data values. Examples of signal support shapes include:
A rectangular region of a two-dimensional grid containing pixel values of an image,
A circular or elliptical region of a two-dimensional grid corresponding to a region-of-interest in an image, and
An arbitrary irregular region of a multidimensional grid corresponding to a mask or subset of positions in a multidimensional signal.

Unless stated otherwise, the signal support shape is determined by which positions in the coordinate axis system are populated with data values and is independent of the embedding dimensions used to represent those data values.

Minimal Bounding Prism: A minimal bounding prism for a multidimensional signal refers to an axis-aligned region in a coordinate axis system that has one corner at an origin and that encloses all positions at which the signal has defined data values, with the region being minimal with respect to its extents along the coordinate axes. Along each data dimension, the minimal bounding prism extends from a coordinate value of zero at the origin to a maximum coordinate value at which the signal has defined data values along that dimension. The maximum coordinate value along a data dimension of the minimal bounding prism may be used as a length or extent of the signal along that data dimension. In examples in which the signal is represented or sampled on a discrete grid, the coordinate values along a data dimension may be spaced at regular intervals, and a number of sample positions or intervals along that dimension may likewise be interpreted as a length or extent of the signal along that dimension.

In this specification, the number of data dimensions of a signal or multidimensional signal (e.g., one-dimensional, two-dimensional, or three-dimensional) determines the number of coordinate axes in a coordinate axis system used to index positions of the signal. The embedding dimensions (the number of numerical components in the numeric representation) and the sizes of matrices that act on the embedding vector space are fixed for a given system configuration and are independent of the signal size or the signal support shape.

Remapping Between Structures: In certain cases, a collection of sequences (or signals) can be remapped to a sequence (or signal) of collections when the sequences (or signals) in the collection exhibit a one-to-one correspondence between their elements (e.g. when indexed by an external coordinate system). For example:
A collection of red, green, and blue two-dimensional signals corresponding to the components of an image can be remapped into a two-dimensional signal of (R, G, B) collections, where each (R, G, B) collection represents a pixel.

In contrast, remapping may not be possible for collections where the elements do not exhibit such correspondence. For instance, a collection of books, where each book is a sequence of words, may not be remapped into a sequence of collections of words because there may not be meaningful one-to-one correspondence between the words at the same position in different books.

### Additional Examples to Clarify the Definitions

A movie can be viewed as a one-dimensional signal of collections, where each collection contains:
   An audio frame represented as a one-dimensional signal of audio samples, and
   An image frame represented as a two-dimensional signal of collections, where each collection contains the red, green, and blue (R, G, B) components of a pixel.
Alternatively, a movie can also be viewed as a collection containing a one-dimensional audio signal and a three-dimensional video signal.
A remote sensing dataset can be viewed as a multidimensional signal whose positions are indexed by spatial coordinates (x, y), time t, and spectral band index λ, optionally together with one or more additional axes such as altitude z or feature-channel index c. For example, a sequence of multispectral satellite images over time can be represented as a signal over a 4D or 5D coordinate axis system (x, y, t, λ[, c]).
A medical imaging study can be viewed as a multidimensional signal where elements are voxels indexed by spatial coordinates (x, y, z), optionally with an additional time axis t for dynamic scans. For example, a 3D MRI volume is a three-dimensional signal, and a series of such volumes acquired over time forms a four-dimensional signal.
A log or event stream can be viewed as a one-dimensional signal whose coordinate axis is time. Each element at a position on the time axis is a collection describing a single event, including fields such as a timestamp, a device identifier, and a vector of measured features. In some implementations, separate log streams for different devices are modeled as separate one-dimensional signals indexed by time.

Partially-ordered nested multiset: When every element of the set including the set itself is either a collection, a sequence, or a data value. For example, a collection of sequences is a partially-ordered nested multiset. So is a sequence of collections. Data from an array of sensors is a collection of sequences and, hence, is a partially-ordered nested multiset of data values.

In some examples of multisets, the data values in the multisets may be drawn from a finite predetermined source set of data values. E.g. there are only a finite number of words in the vocabulary.

In some examples of multisets, the data values in the multisets may be drawn from a countably infinite predetermined source set of data values. E.g. a set of dates on which an event can possibly occur in a collection of all dates an event has occurred.

In some examples of multisets, the data values in the multisets may be drawn from an uncountably infinite predetermined source set of data values. E.g. a set of all values an audio sample can possibly take at a given instant in a waveform.

In the drawings, boxes represent functional modules or components that may be implemented in hardware, software, or any combination thereof, and lines and arrows represent information or control flow between modules. Where appropriate, the arrows are annotated with the types of data or mathematical objects carried along those arrows, and the drawings are schematic, not to scale, and intended to illustrate logical relationships rather than physical layouts.

In some drawings, a single position of a sequence or multidimensional signal is illustrated schematically, and squares surrounding that position are used to indicate different context windows. A smaller square represents a smaller context window, a larger square represents a larger context window, and a square drawn with missing sides and sides that transition from solid to dotted represents a context window that effectively extends across all positions of the sequence or multidimensional signal. Ellipses are used to indicate omitted repetitions, such as additional layers within a layer group or additional layer groups beyond those explicitly shown, and curly braces are used to indicate that a label applies to a collection of similar elements. These visual conventions are illustrative only and are not intended to limit the scope of the claims.

In some drawings, different arrow styles are used schematically to distinguish direct connections from delayed or past-only connections. A line with a solid arrowhead indicates a direct flow of values or representations. A line with an arrowhead drawn as a hollow or unfilled triangle (that is, a white triangular arrowhead) is used to indicate a delay operation, where the values or representations provided at the output of the arrow correspond to past positions in a sequence or multidimensional signal and exclude the current position. This convention is used, for example, to illustrate that certain computations, such as the computation of a contextual correction embedding for a position, are performed using only past values or past contextualized embeddings and not the current value at that position. The delay arrows are illustrative of causal or past-only dependencies and are not intended to imply any particular hardware implementation of a delay line.

For clarity, certain figures and descriptions emphasize elements most pertinent to understanding and omit well-known components that would be apparent to a person of ordinary skill in the art.

In the drawings, any bus, interconnect, or similar line that is drawn between multiple modules is intended to schematically represent one or more communication mechanisms rather than a single physical bus. For example, such an interconnect may correspond to any combination of shared-memory busses, point-to-point links, network connections, message-passing interfaces, or other communication fabrics, and the illustrated modules may exchange data using any suitable communication protocol.

### First Aspect

The present disclosure describes a system that involves up to three algebraic properties applied to real-world compositions.

The first algebraic property is non-commutativity, which ensures that the order of elements affects the result. Many forms of data are inherently ordered: in language, for example, the sequence “a man bit a dog” has a meaning distinct from “a dog bit a man.”

The second algebraic property is associativity, which ensures that the grouping of elements does not alter the outcome. Associativity allows parts of a structure to be combined incrementally or in parallel without changing the final representation. For instance, when composing the three elements A, B, and C, the representation of (A+B)+C should be identical to A+(B+C). In language, this is analogous to combining the phrase “a man” with “bit a dog” or, equivalently, combining “a man bit” with “a dog” to obtain “a man bit a dog.” Both groupings describe the same sentence.

The third property, particularly relevant to images, spatial grids, and other multidimensional signals, is commutativity across axes. When constructing an image, composition along the x-axis followed by the y-axis produces the same image as composition along the y-axis followed by the x-axis. In other words, an image is the same irrespective of whether it is assembled row-by-row or column-by-column.

Accordingly, the first aspect of this disclosure is to represent data values using embeddings that mimic the algebraic properties of composition observed in the real world, thereby preserving relationships among the underlying data values, wherein the embeddings are custom embeddings (CEs) that are elements of a custom non-abelian mathematical set (CNM set), wherein the CNM set is a mathematical set that may be equipped with one or more non-abelian associative binary operations where the non-abelian associative binary operations may have one-to-one correspondence with the data dimensions, and may additionally be equipped with an abelian associative binary operation.

Note that a CE may be obtained from other CEs via a non-abelian or an abelian binary operation.

Some examples of CNM sets equipped with one non-abelian associative binary operation include, but are not limited to:
the matrix group equipped with matrix multiplication as the non-abelian associative binary operation;
the unitary group equipped with matrix multiplication as the non-abelian associative binary operation;
the affine group equipped with matrix multiplication as the non-abelian associative binary operation;
the quaternion group equipped with quaternion product as the non-abelian associative binary operation; and
the dual quaternion group equipped with dual-quaternion product as the non-abelian associative binary operation.

A CNM set may be a non-abelian mathematical group featuring an identity element, and an inverse element corresponding to every element in the set with respect to the non-abelian associative binary operation.

A CNM set may also be isomorphic to a direct product of a sequence of plurality of not-necessarily distinct primary mathematical sets wherein at least one of the primary mathematical sets is a CNM set.

Some examples of CNM sets equipped with both a non-abelian associative binary operation and an abelian associative binary operation include, but are not limited to:
the set of all N×N matrices equipped with matrix multiplication as the non-abelian associative binary operation and matrix addition as the abelian associative operation,
the quaternion group equipped with quaternion product as the non-abelian associative binary operation and quaternion addition as the abelian associative binary operation, and
the dual quaternion group equipped with dual-quaternion product as the non-abelian associative binary operation and dual quaternion addition as the abelian associative binary operation
the set of all N×N upper triangular matrices with positive diagonal entries wherein the non-abelian associative binary operation is matrix multiplication, and the abelian associative binary operation is matrix addition.

Some examples of CNM sets equipped with two non-abelian associative binary operations include, but are not limited to:
A set formed from pairs of matrices (A, B), where one binary operation is defined as (A, B)⊕(A′, B′)=(A+T(A′), B+B′) for an appropriately chosen linear transform T, and the other operation switches the roles of the components. Both operations are associative, but not commutative, due to the transformation T acting on the second operand.
A set formed from pairs of quaternions (q₁, q₂), where the first operation might be (q₁, q₂)⊕(q₁′, q₂′)=(q₁+L (q₁′), q₂+q₂′) and the second operation reverses the pattern, with L a linear operator on the quaternions. The ordering matters, making these operations non-abelian.
A set formed from pairs of dual quaternions (d₁, d₂) can be similarly defined. As with the above examples, the introduction of a linear transform on one operand ensures the operations are associative yet non-commutative.
A set formed from matrices, where one binary operation is defined as A⊕A′=A+T(A′) and the other as A⊕A′=A+S(A′) for appropriately chosen commutative linear transformations T and S. Both binary operations are associative, but not commutative, due to the transformation by T and S of the second operand.

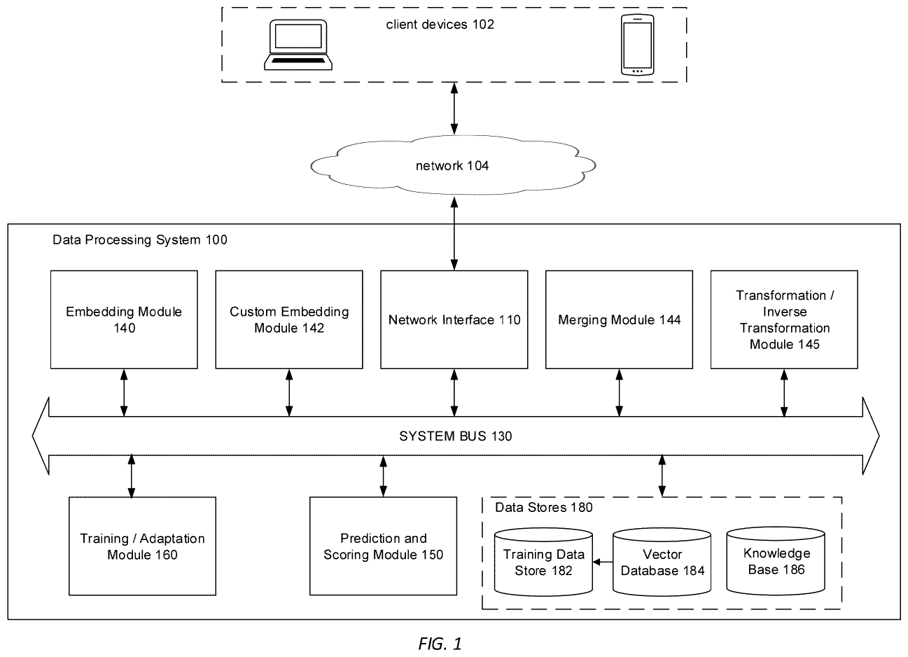

In general, an example of the first aspect can be realized in a method for processing a multidimensional multiset of data values in a data-processing system, such as data processing system 100 illustrated in FIG. 1, the method comprising at least one of:
obtaining, by an embedding-function module such as custom embedding module 142, a custom embedding (CE) of an input data value;
mapping, by a module such as transformation/inverse transformation module 144, a vector of numeric values to one or more elements of the CNM set (CEs) for further processing;
mapping, by a module such as transformation/inverse transformation module 144, one or more CEs to a vector of numeric values for further processing wherein the term ‘inverse-transformation’ is used only in the sense that the mapping acts in the opposite direction along the data flow; it is not required to be a mathematical inverse of the forward transformation;
merging, by a module such as merging module 145, two or more CEs to obtain a resulting CE using the non-abelian associative binary operation of the CNM set (including, for multidimensional multisets, applying the operation designated for a selected dimension and, where defined, performing abelian aggregation across positions or windows);
merging, in applicable cases, by a module such as merging module 145, two or more CEs to obtain a resulting CE using the abelian associative binary operation of the CNM set;
computing, by a module such as merging module 145, a difference CE from an ordered pair of CEs using the inverse under the relevant non-abelian operation when the CNM set provides inverses; and
computing, by a module such as prediction and scoring module 150, a similarity metric between CEs (including between a CE of a single data value and a CE of a multiset).

In general, an example of the first aspect can be realized in a data-processing system, such as a data processing system 100 illustrated in FIG. 1, the data-processing system comprising: a network interface 110 configured to receive input data from client devices 102 over a network 104; an input or feature module 120 configured to generate input features from the received data; a system bus 130 configured to convey data between modules of the data-processing system, wherein system bus 130 is illustrated schematically to represent one or more communication mechanisms between the modules and is not intended to require any particular physical bus or interconnect topology; an embedding module 140 configured to receive the input features and to generate vectors of numeric values (standard embeddings) in a vector space from the input features; a custom embedding module 142 configured to receive and operate on custom embeddings; a merging module 144 configured to perform merging or aggregation operations on custom embeddings, including non-abelian merging operations, to produce merged or aggregated custom embeddings; a transformation and inverse-transformation module 145 configured to map standard embeddings generated by embedding module 140 to custom embeddings in one or more non-abelian mathematical sets and, in some implementations, to map custom embeddings back to standard embeddings; a training or adaptation module 160 configured to adapt parameters of one or more of embedding module 140, custom embedding module 142, merging module 144, transformation and inverse-transformation module 145, and prediction and scoring module(s) 150 using training data; prediction and scoring module(s) 150 configured to generate outputs, such as predicted values, class labels, similarity scores, alignment scores, or other scores, from custom embeddings and merged custom embeddings; and one or more data stores 180 configured to store data values, embeddings, custom embeddings, supervision signals, and related metadata, the one or more data stores 180 optionally including a knowledge base 186, a vector database 184, and a training data store 182.

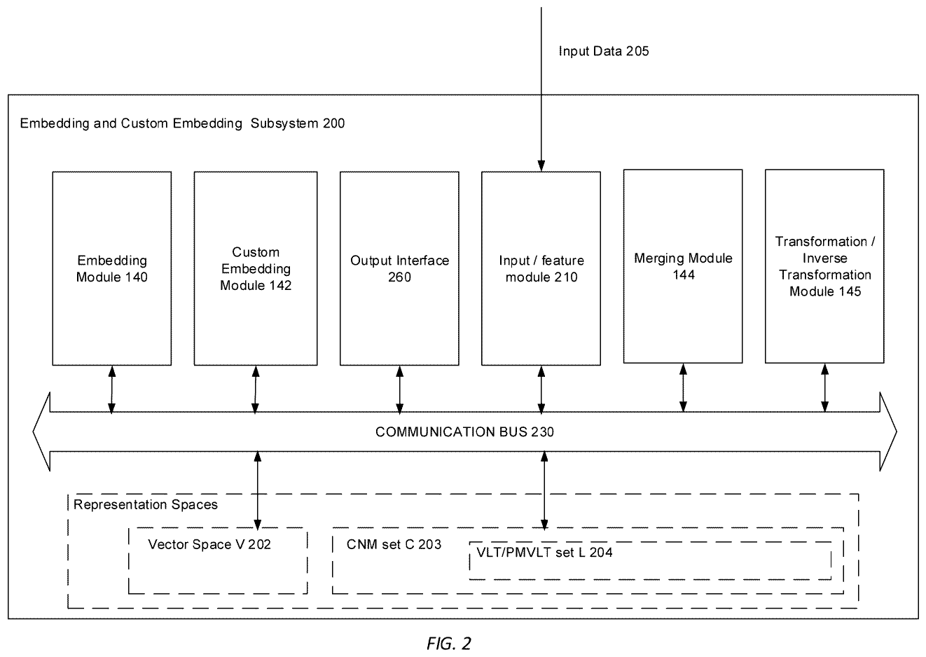

Another example of the first aspect can be realized in an embedding and custom embedding subsystem 200 as illustrated in FIG. 2. Embedding and custom embedding subsystem 200 may receive input data from a data-processing system or another component and comprises: an input or feature module 210 configured to receive input data and to generate input features from the input data; an embedding module 140 configured to receive the input features and to generate vectors of numeric values (standard embeddings) in a vector space V 202 from the input features; a custom embedding module 142 configured to receive and operate on custom embeddings; a merging module 144 configured to receive custom embeddings and to perform merging or aggregation operations, including non-abelian merging operations, to produce merged or aggregated custom embeddings; a transformation and inverse-transformation module 145 configured to map standard embeddings generated by embedding module 140 to custom embeddings in one or more non-abelian mathematical sets and, in some implementations, to map custom embeddings back to standard embeddings; an output interface 260 configured to provide custom embeddings and merged custom embeddings for use by other components of a data-processing system; and a communication bus 230 to which modules 210, 140, 142, 144, 145, and 260 are coupled, wherein communication bus 230 is illustrated schematically to represent communication of representations between these modules and underlying representation spaces and is not intended to require any particular physical bus or interconnect topology. In the example of FIG. 2, representation spaces are shown schematically by boxes labeled vector space V 202, CNM set C 203, and VLT/PMVLT set L 204, where VLT/PMVLT set L 204 is depicted as a subset of CNM set C 203 and these boxes indicate mathematical sets in which vectors, custom embeddings, and related representations reside rather than physical storage devices. Embedding module 140 generates vectors in vector space V 202 from the input features, transformation and inverse-transformation module 145 maps vectors in vector space V 202 to custom embeddings in CNM set C 203, including elements of VLT/PMVLT set L 204, and may, in some implementations, map custom embeddings back to vectors of numeric values in vector space V 202. Custom embedding module 142 and merging module 144 operate on custom embeddings in these non-abelian sets, and output interface 260 provides the resulting custom embeddings and merged custom embeddings for further processing. As used herein, the term “inverse-transformation” is used only in the sense that the mapping performed by transformation and inverse-transformation module 145 in the reverse direction acts in the opposite direction along the data flow relative to the forward mapping of the same module, and the reverse mapping is not required to be a mathematical inverse of the forward transformation.

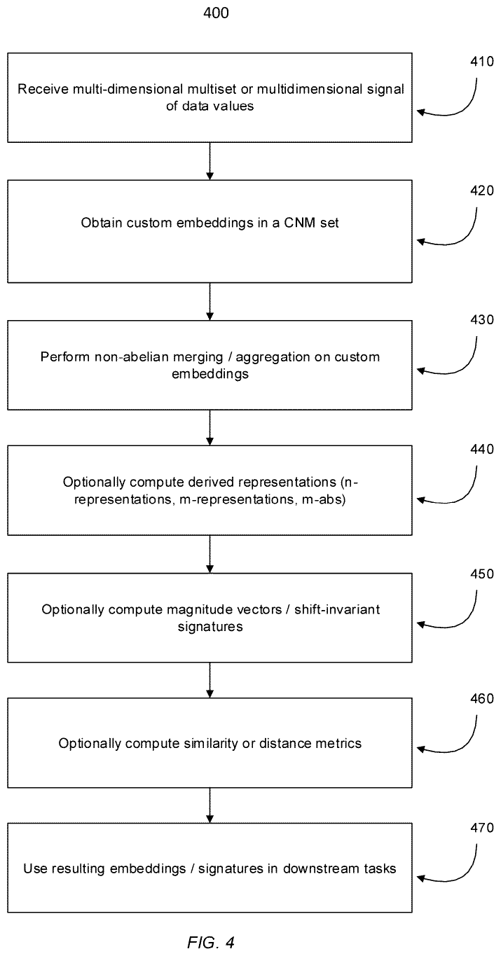

Another example of the first aspect can be realized in a method 400 for processing a multidimensional multiset or multidimensional signal of data values, as illustrated in FIG. 4, the method 400 comprising: at step 410, receiving a multidimensional multiset or multidimensional signal of data values; at step 420, obtaining custom embeddings in a custom non-abelian mathematical set from the received data values, wherein obtaining the custom embeddings may comprise one or more of mapping data values directly to custom embeddings, computing features from the data values and mapping the features to custom embeddings, and computing vectors of numeric values (standard embeddings) and mapping the standard embeddings to custom embeddings in the custom non-abelian mathematical set; at step 430, performing one or more non-abelian merging or aggregation operations on a multiset of custom embeddings to generate one or more merged or aggregated custom embeddings; at step 440, optionally computing one or more derived representations from the custom embeddings or merged custom embeddings, such as n-representations, m-representations, or m-abs representations; at step 450, optionally computing one or more magnitude vectors or other shift-invariant signatures from custom embeddings or merged custom embeddings; at step 460, optionally computing one or more similarity or distance measures between custom embeddings, merged custom embeddings, or corresponding magnitude vectors; and at step 470, using the resulting custom embeddings, merged custom embeddings, derived representations, magnitude vectors, or similarity measures in one or more downstream tasks, such as prediction, classification, retrieval, or alignment, or storing them in one or more data stores for later use.

One example of the first aspect relates to methods that may obtain a single CE of a sequence of data values by first converting the individual data values into their respective CEs and then merging the individual CEs by repeatedly invoking the non-abelian binary operation of the CNM set to obtain the desired single CE of the sequence.

One example of the first aspect relates to methods that may obtain a single CE of a collection of data values by first converting the individual data values into their respective CEs and then merging the individual CEs by repeatedly invoking the abelian binary operation of the CNM set to obtain the desired single CE of the collection.

One example of the first aspect can be realized in data processing methods that include the actions of receiving an input comprising a multiset of data values; invoking the embedding generation or retrieval methods to associate each data value in the input with its respective CE to generate a multiset of CEs; invoking the non-abelian and abelian associative binary operations of the CNM set of CEs to merge the individual embeddings in the multiset of embeddings to obtain a single embedding of the multiset of data values.

One example of the first aspect can be realized in methods that may obtain a single CE of a multidimensional signal of data values by first converting the individual data values into their respective CEs, and then sequentially merging the individual CEs along each dimension using the non-abelian binary operation in one-to-one correspondence with the dimension, to obtain the desired single CE of the multidimensional signal, wherein the single CE of the multidimensional signal may be independent of the order of the dimensions chosen for merging.

Another example of the first aspect relates to methods that may obtain a CE of the result of the concatenation of two sequences of data values by merging the individual CEs of each sequence using the non-abelian binary operation of the CNM set to obtain the desired CE of the concatenated sequence.

Another example of the first aspect relates to methods that may obtain a CE of the result of the concatenation of two multidimensional signals of data values along a particular axis by merging the individual CEs of each signal using the non-abelian binary operation of the CNM set in one-to-one correspondence with that axis to obtain the desired CE of the concatenated signal.

Another example of the first aspect relates to methods that may measure similarity between CEs to establish relationships between associated data values or multisets.

Another example of the first aspect relates to methods that may employ a mathematical group as a CNM set and compute a “difference” between two CEs by performing the non-abelian binary operation between the inverse of the second CE and the first as a measure of the relationship between associated data values or multisets.

Another example of the first aspect relates to methods that may constrain the components of CEs to have unit norm to facilitate infinite context and to prevent exploding or vanishing gradients during training.

Another example of the first aspect relates to methods that may obtain a single n-representation of a sequence of N data values by first generating N−n+1 subsequences of n data values using a sliding window of length n across the original sequence, generating N−n+1 CEs for each subsequence by merging the individual CEs of the data values in the subsequence using the non-abelian binary operation of the CNM set, and then merging the N−n+1 CEs of each subsequence using the abelian binary operation of CNM set to obtain the desired n-representation of the original sequence. Accordingly, an N-representation of a sequence of N data values is the same as generating the CE of the entire sequence by merging the individual CEs of the data values in the sequence using the non-abelian binary operation of the CNM set. Similarly, 1-representation of the sequence is the same as generating the CE of the sequence by merging the individual CEs of the data values in the sequence using the abelian binary operation of the CNM.

In general, one example of the first aspect described in this specification can be realized in a multiple sequence alignment method that generates m-representations of sequences, wherein m-representations belong to a non-abelian custom mathematical set, and uses the similarity measure of the non-abelian custom mathematical set to cluster multiple similar sequences before refinement. The method can further involve first clustering similar sequences using their 1-representations and further refining the clusters by using m-representations with increasing values of m. A high similarity score between m-representations of two sequences might indicate that two sequences share many m-tuples irrespective of the gap between the m-tuples. E.g. “ABCD” and “CDEFAB” might have a high similarity score between their 1-representations since they share “A”, “B”, “C” and “D”; might have a good similarity score between their 2-representations since they share “AB” and “CD”, but may have a low similarity score between their 3-representations and 4-representations since they do not share any 3- or 4-tuples.

In general, one example of the first aspect can be realized in a sequence alignment method that may comprise computing an m-left-right-representation for a target data value in the sequence wherein the m-left-right-representation of the target data value is obtained by constructing a left and right sequence by taking data values to the left and right of the target data value respectively while including the target data value in both cases; computing m-representations of the left and right sequences wherein the m-representation may simply be the non-abelian CE or may not be defined if the length of the left or right sequence is less than m; and concatenating the m-representations into the desired m-left-right-representation of a data value; using the m-left-right representations to identify anchor points in the two sequences using a compound similarity measure wherein the compound similarity measure is the sum of the individual similarity measures of the m-representations of the left and right sequences and wherein an individual similarity measure may simply be zero if the corresponding m-representation is not defined.

Another example of the first aspect extends the n-representation to two dimensions, the method comprising: (i) sliding an n×m window over an N×M signal to produce (N−n+1)(M−m+1) patches; (ii) transforming each patch into a CE using the non-abelian operation(s) of the CNM set; and (iii) merging the resulting CEs using the CNM set's abelian operation to yield a single (n, m)-representation of the original signal. This construction generalizes to higher dimensions in the same manner.

Another example of the first aspect relates to methods that may leverage the associative property of the binary operation to reduce computational time by reusing previously computed values, partitioning, parallelizing, distributing across multiple processing units and then recombining in an iterative manner.

Alternative examples of the first aspect include established AI methods wherein conventional representations of data values in a multiset may be replaced with CEs of data values in the multiset. In other alternative examples of this aspect the conventional representations may be replaced with representations derived from CEs.

Some examples of the first aspect can be realized in embedding generation methods that further comprise the actions of obtaining a CE of a particular data value in a multiset of data values by processing the data value using an embedding function, configured in accordance with a set of embedding function parameters, to receive the data value as input and map the data value to its respective CE.

In some examples of the embedding generation methods, the embedding function might include the actions of extracting one or more features from the input data value and then mapping the extracted features to a CE.

Some examples of embedding generation methods can be realized in embedding retrieval methods that further comprise the actions of querying a data set stored on one or more non-transitory computer readable media that associates a data value in the data set with the respective CE of the data value, wherein the query comprises a data value; and receiving a response, wherein the response comprises an indication of success or failure of a successful retrieval, and in case of a successful retrieval the response also includes the CE of the data value.

Other examples of the first aspect can be realized in vector query methods that further include the actions of querying a data set stored on one or more non-transitory computer readable media that associates CEs with data values in multisets of data values and wherein the data set also organizes the CEs, using the similarity metric of CEs, into a hierarchical vector index for faster query responses; and wherein the query comprises a query CE; traversing the hierarchical index using the similarity metric to identify relevant CEs that are similar to the query CE; and providing the identified CEs and the associated data values in response to the request.

Some examples of embedding function determination methods can be realized in transformation methods, useful for obtaining the desired embedding function by composing an existing embedding function with a transformation function, wherein the transformation function maps the output of the existing embedding function to the CNM set of CEs. The transformation methods include the actions of determining the transformation function and determining the desired embedding function by composing the existing embedding function with the transformation function.

Some examples of transformation methods might further include the actions of mapping a pair of real numbers into a complex number to transform a vector of real numbers into a vector of complex numbers; mapping a quartet of real numbers into a quaternion to transform a vector of real numbers into a vector of quaternions; partitioning a vector of real numbers into sub-vectors of 4 real numbers, then reshaping each sub-vector into a 2×2 matrix, to transform a vector of real numbers into a vector of 2×2 matrices; reshaping a vector of real numbers into a square matrix; applying the Gram-Schmidt orthogonalization to transform a square matrix into an orthogonal matrix; reshaping a vector of complex numbers into a square matrix of complex numbers; applying the Gram-Schmidt orthogonalization to transform a matrix of complex numbers into a unitary matrix; reshaping a vector of real numbers into an upper triangular matrix; applying the Newton-Schulz iteration to transform a square matrix into an approximately orthogonal matrix through iterative matrix multiplications; and the like.

Another example of transformation methods includes mapping a vector of N-real numbers into a 2N×2N block-diagonal orthogonal matrix where the i^{th} matrix on the diagonal is a 2×2 orthogonal matrix given by

$$[ \begin{matrix}cos α & - sin α \\ sin α & cos α\end{matrix} ]$$

where α is the corresponding i^{th} element in the vector of N-real numbers.

Other examples of embedding function determination methods can be realized in derivation methods useful for deriving the desired target embedding function from existing source embeddings that include the actions of obtaining a set of training data, wherein the training data comprises a predetermined source set of data values and their respective source embeddings, training the desired target embedding function that maps data values to their respective target CEs, and obtaining the trained parameters of the desired embedding function; wherein the training the target embedding function comprises the actions of selecting a pair of data values and their respective source embeddings, computing a source similarly score between the pair of source embeddings using the similarity metric defined on the set of source embeddings, and adjusting the target embedding function parameters such that the similarity score between the target CEs, computed using the similarity metric of the CNM set of target CEs, gets closer to the source similarity score.

Other examples of the embedding function determination methods can be realized in assignment methods, wherein the data values in multiset of data values are drawn from a predetermined source set of data values, determining the embedding function can involve creating a data set that associates each data value from the source set of data values with the respective CE of the data value, wherein the CE is determined using a one-to-one injective mapping from the source set of data values to the CNM set of CEs; and storing the data set on one or more non-transitory computer readable media.

Other examples of assignment methods can include the actions of manually determining the parameters of an embedding function layer which takes data values as inputs and maps them to their respective embeddings.

Other examples of the embedding function determination methods can be realized in training methods that comprise collecting sequences of data values, whether discrete linguistic tokens, latent image codes, audio spectra, numerical telemetry, or other modality-specific representations. The training methods may be supervised or unsupervised. Training may involve converting data values into CEs via an input layer (e.g., token look-ups, linear projections, convolutional stems, or vector-quantization encoders). The resulting embeddings are propagated through one or more processing layers that may implement non-abelian merging operations of the CNM set, multi-head self-attention, feed-forward transformations, and normalization. Upon exiting the final processing layer, the embeddings are projected through an output head, which may take the form of a vocabulary-sized linear layer with SoftMax for discrete targets, an unbounded or bounded regression head for continuous values, a probabilistic parameter head for heteroscedastic signals, or a codebook-logit head for latent codes. A loss function appropriate to the output head-such as cross-entropy, mean-squared error, Gaussian negative log-likelihood, mixture density likelihood, or perceptual similarity—is evaluated against reference targets derived from the training data. In supervised training, these targets correspond to labeled reference outputs, whereas in unsupervised training they are inferred from the data itself through reconstruction, prediction, or contrastive learning objectives. In both cases, all learnable parameters are updated via back-propagation in conjunction with any suitable optimization algorithm (for example, stochastic gradient descent, Adam, or their variants) executed on parallel processing hardware. Optional curriculum scheduling, mixed-precision arithmetic, gradient accumulation, and distributed data-parallel or pipeline-parallel execution may be employed as needed to accommodate variable sequence lengths, high-resolution inputs, or model sizes, with individual systems freely omitting, reordering, or substituting these techniques while remaining within the scope of the present description.

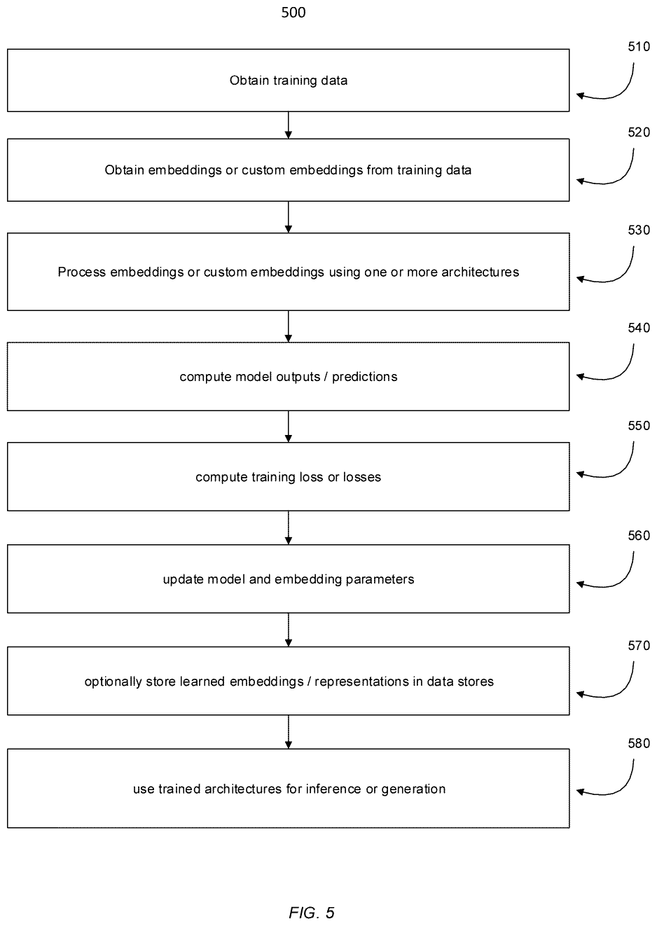

Other examples of the embedding function determination methods can be realized in training and usage methods 500, as illustrated in FIG. 5. In some implementations, method 500 comprises: at step 510, obtaining training data comprising sequences or multidimensional signals of values; at step 520, obtaining embeddings or custom embeddings from the training data, for example by using one or more embedding functions, custom embedding modules, or transformation modules as described herein, such as in an embedding and custom embedding subsystem 200 of FIG. 2; at step 530, processing the embeddings or custom embeddings using one or more sequence transduction or multidimensional signal processing models described in this specification, such as autoregressive generative neural networks, hierarchical architectures, or recursive and parent architectures, without limitation to any particular model structure; at step 540, computing model outputs or predictions from the processed embeddings or contextualized embeddings, for example predicted next values, class labels, similarity scores, alignment scores, or other scores; at step 550, computing one or more training losses based at least in part on differences between the model outputs or predictions and corresponding target values; at step 560, updating parameters of one or more models and embedding functions based on the one or more training losses, such as parameters of an embedding and custom embedding subsystem 200 or other components of a data processing system 100; at step 570, optionally storing learned embeddings, custom embeddings, derived representations, magnitude vectors, or related signatures in one or more data stores for later retrieval and use, such as data stores 180 of FIG. 1; and at step 580, using the trained models and stored representations during inference or generation, for example by applying a trained data processing system 100 to process new sequences or multidimensional signals of values in prediction, classification, retrieval, or alignment tasks.

In some examples, training of CEs may be performed using an autodifferentiation framework—such as PyTorch, TensorFlow, JAX, or Theano—that inherently enforces desired structural or algebraic constraints on the embeddings. For example, a Gram-Schmidt orthogonalization constraint may be applied to generate CEs comprising orthogonal matrices, while a unit-norm constraint may regulate embedding magnitude. Alternatively, the Newton-Schulz iteration may be used to obtain an approximate inverse square root of a square matrix, thereby transforming it into an approximately orthogonal matrix through iterative matrix multiplications. These constraints are embedded directly within the computational graph of the loss function, allowing the autodifferentiation mechanism to compute gradients that respect the permissible parameter space.

Other examples of the embedding function determination methods can be realized in methods for training CEs from sequential data, wherein the training data comprises sequences of data values and the training process includes generating data triples from neighboring pairs of data values. Each data triple may consist of a first data value serving as a head, a second data value serving as a tail, and a relationship expressing the positional or contextual linkage between them, such as the right or left neighbor of the first data value, the relationship itself optionally being a function of the first data value. These triples form the basis for constructing knowledge graphs that capture sequential and structural dependencies among data values.

Other examples of the unsupervised training methods can include knowledge graph-based methods that comprise obtaining a knowledge graph consisting of data triples, wherein each data triple includes a head data value, a tail data value, and a relationship, the relationship being an element of a predetermined finite set of relationships. An embedding function may be trained on such data, receiving both data values and relationship values and mapping them to respective CEs in accordance with a set of embedding function parameters, wherein the CEs of data values and relationship values are elements of the same custom non-abelian mathematical (CNM) set. Each data triple is processed to generate a head CE, relationship CE, and tail CE; the head and relationship embeddings are merged to form a composite CE; and the distance or similarity between this composite CE and the tail CE is used to compute a score representing the likelihood that the head and tail data values are related via the relationship. The parameters of the embedding function are adjusted to increase the score for valid triples sampled from the training data and to decrease the score for invalid triples sampled from a preconfigured distribution over all possible triples.

In some examples, the training may be jointly performed on both knowledge graphs and multisets of data values, enabling unified learning across structured and unstructured data. The score computation may involve the distance between merged and tail embeddings, pairwise similarity metrics among CEs, or aggregated distance metrics processed by a classifier to yield a single likelihood score. The knowledge graph may be derived from multisets of data values, where relationships encode positional or contextual relationships between elements, or from existing embeddings, where relationships represent measured similarity between embedding vectors. In some cases, the CEs of neighboring data values may be merged into a single higher-level embedding to reinforce contextual coherence.

In further examples, training may incorporate partially ordered multisets of data values alongside knowledge graphs, enabling local and relational consistency. The embedding and merging functions may map neighborhoods of candidate data values to multisets of CEs, and the parameters of these functions may be optimized by decreasing intra-neighborhood distances when candidate data values occupy correct positions and increasing distances when they do not. Scores derived from merged and tail embeddings may likewise be adjusted based on the likelihood that a candidate tail value is correctly related to a head value under a given relationship.

Other examples may include joint classifier-based training involving a plurality of classifiers, an embedding function, and a merging function trained together on the same data. The embedding function maps data values to CEs, while the merging function combines partially ordered multisets of CEs into single representations. A first classifier may correspond to positional relationships among elements in neighborhoods of data values, while a second classifier corresponds to relational links among triples. The first classifier generates scores indicating whether candidate data values appear in correct neighborhood positions, and the second classifier generates scores indicating whether head-tail pairs are correctly related by a relationship. The embedding and classifier parameters are updated to increase scores for correct configurations and decrease them for incorrect ones, ensuring consistency across structural and relational contexts.

In some examples, transformer architectures may be trained on knowledge graph data by treating entities and relationships as tokens and each triple as a three-token sentence, adopting a masked language modeling objective wherein the head or tail entity is masked and predicted. Training minimizes cross-entropy loss to maximize the likelihood of correctly predicting the masked entity. The transformer may include one or more layers employing full attention, with inputs and outputs corresponding to embeddings of entities and relationships, and the final output layer predicting the masked entity. This framework enables the integration of non-abelian embeddings within attention-based architectures for learning relational dependencies from both textual and graph-structured data.

The methods disclosed herein can be designed to operate in conjunction with and as extensions of existing training frameworks used in large-scale model development. Such frameworks typically comprise multiple stages, including an initial training or pre-training phase, in which a model is trained on a large corpus of textual data comprising sequences of words to predict subsequent tokens using a sequence-to-sequence transducer or transformer architecture; a supervised fine-tuning phase, in which the model parameters are refined using curated prompt-response pairs to produce contextually appropriate outputs aligned with human-provided examples; and a reinforcement learning phase, in which one or more objective functions are optimized using reward signals derived from sources such as direct human feedback, automated evaluation systems, or domain-specific performance metrics.

Other examples of the embedding function determination methods can further include the following features. The predetermined source set of data values can be a finite set of data values; each data value in the predetermined source set of data values can be processed using the embedding function in accordance with the trained values of the embedding function parameters to generate a respective CE of each data value in the predetermined source set of data values; and a data set can be created that associates each data value in the predetermined source set of data values with its respective CE of the data value and the created data set can be stored on one or more non-transitory computer readable storage media.

Other examples of embedding determination methods can each optionally include one or more of the following features. The CNM set can be a commutative mathematical semigroup isomorphic to a mathematical semigroup obtained by unwrapping each embedding into either a vector of real numbers or a vector of complex numbers and defining a commutative mathematical semigroup on the unwrapped vectors. The similarity measure can be obtained by unwrapping each embedding into a vector of real or complex numbers and computing the similarity measure between the unwrapped vectors. In some cases, the similarity measure can be a decreasing function of the distance measure obtained by unwrapping each embedding into a vector of real or complex numbers and computing the distance measure between the unwrapped vectors.

Other examples of the first aspect include corresponding systems, apparatus, and computer programs, configured to perform the actions of the methods disclosed herein, encoded on computer storage devices.

In another example of the first aspect, the abelian summation of elements from a multidimensional signal or sequence—widely used in many existing data processing systems—may be replaced by a non-abelian summation. For instance, in digital signal processing, samples from an audio signal are summed to produce averaged or combined signals; natural language processing frameworks often average word embeddings to represent entire sentences or documents; and in transformer-based models, attention mechanisms linearly combine weighted value vectors. In this example, the replacement of abelian summation by non-abelian summation may be achieved by (1) transforming each element of the multidimensional signal or sequence into an element of a CNM set; (2) performing the summation in the transformed domain using the non-abelian binary operation; and (3) mapping the result back to the original domain to obtain the non-abelian sum.

A specific example of the non-abelian summation can be realized in a sequence transduction system comprising one or more computers and one or more storage devices storing instructions that when executed by the one or more computers cause the one or more computers to implement a system for transducing an input sequence of input data values into an output sequence of output data values, the sequence transduction system comprising one or more sequence transduction subsystems, each sequence transduction subsystem configured to receive the output of preceding subsystem, wherein at least one of the subsystems may comprise: a self-attention unit for generating a context vector for a target position in the input sequence of data values using self-attention, comprising: a receiving module configured to receive the sequence of output representations from a preceding subsystem as input representations of the input data values, a computational module configured to produce query, key, and value vectors from the input representations of each input data value, an attention calculation module configured to compute attention scores from the query vector computed from the input representation at the target position and key vectors computed from input representations in the sequence, apply scaling, and generate a sequence of weighted value vectors, a non-abelian summation module that receives the sequence of weighted value vectors to produce a context vector for the target position.

In general, an example of the non-abelian summation can be realized in a multidimensional system comprising one or more computers and one or more storage devices storing instructions that when executed by the one or more computers cause the one or more computers to implement a multidimensional transduction system for transducing a multidimensional input signal of input data values into a multidimensional output signal of output data values, the multidimensional transduction system comprising one or more multidimensional transduction subsystems, each multidimensional transduction subsystem configured to receive the output of preceding subsystem, wherein at least one of the subsystems comprises: A self-attention unit for generating context vectors of input data values in the multidimensional input signal using self-attention, comprising: a receiving module configured to receive the multidimensional signal of output representations from a preceding subsystem as multidimensional signal of input representations of each input data value, a computational module configured to produce query, key, and value vectors from the input representations of each input data value, an attention calculation module configured to compute attention scores from the query vector of the input data value at the target position and key vectors of other input data values in the multidimensional signal, apply scaling, and generate a multidimensional signal of weighted value vectors, a multidimensional non-abelian aggregation module that receives the multidimensional signal of weighted value vectors produces a context vector for that target position.

Another example of the first aspect relates to a non-abelian merging layer in a sequence-to-sequence transducer that receives an embedding for each position from the previous layer and computes a context vector for each position by performing a non-abelian sum of the current position and previous m positions and transforming the sum using a feedforward neural network.

A specific example of the above example can be realized in a CNM-based sequence transduction system comprising one or more computers and one or more storage devices storing instructions that when executed by the one or more computers cause the one or more computers to transduce an input sequence of data values into an output sequence, the CNM-based sequence transduction system comprising one or more CNM-based sequence transduction subsystems, each CNM-based sequence transduction subsystem configured to receive as input (u(t)) the output (y(t)) of preceding subsystem, wherein one of the subsystems may be of the form x(t+1)=f(u(t−m))·x(t)·f(u(t))⁻¹ and y(t)=g(x(t))+u(t) wherein x(t) is the state of the subsystem at time t and is an element of a CNM set wherein the CNM set is a non-abelian group G, f( ) is a mapping from [symbol] ^{M} to G, g( ) is a mapping from G to [symbol] ^{M}, u(t) is the complex vector input to the subsystem at time t of size M×1, and y(t) is the complex vector output of the subsystem at time t of size M×1, and wherein z⁻¹ denotes the inverse of z in G and “⋅” denotes the non-abelian binary operation of G.

In some examples of the embedding system, the embedding system can include an embedding storage and retrieval system comprising one or more non-transitory computer storage media encoded with a data set, the data set associating a data value in the data set with a respective CE of the data value, wherein the data value belongs to a multiset of data values, a query system configured to receive a query comprising a query data value and a response system configured to provide a response comprising a CE of the data value.

In some examples of the embedding storage and retrieval systems, the data set might also comprise multisets of data values wherein a multiset of data values might have a respective CE. Some examples of storage and retrieval systems might also maintain an index of data values for faster query lookups and retrievals.

Other examples of sequence embedding generation system can each optionally include one or more of the following features. The sequence embedding generation system may further comprise: an embedding function unit configured to: receive an input sequence comprising a plurality of data values, invoke the embedding function module on each data value in the input sequence to generate a sequence of primary CEs corresponding to the input sequence of data values; a processing unit configured to: receive a sequence of primary CEs corresponding to an input sequence of data values, perform a non-abelian binary operation of the CNM set on the primary CEs in the order of their position in the sequence to generate a merged CE of the sequence of data values. The data values in the sequence may be arranged in a sequential order from left-to-right. The data values in the sequence may be arranged in a sequential order from right-to-left.

An example of the embedding generation system can be realized in a text token embedding system comprising: a character-based embedding function module that receives a text character as input and generates a CE of the character (character CE); and an embedding function unit configured to: receive a text token wherein a text token is a sequence of text characters, invoke the character-based embedding function module on each character in the input token to generate a sequence of character CEs corresponding to the input sequence of characters; a processing unit configured to: receive a sequence of character CEs corresponding to an input sequence of text characters, perform a non-abelian binary operation of the CNM set on the character CEs in the order of their position in the sequence to generate a CE of the input text token (token CE).

In general, an example of a sequence embedding generation can be realized in a system comprising one or more computers and one or more storage devices storing instructions that when executed by the one or more computers cause the one or more computers to receive a data value as input and return a CE of the input data value, wherein the CE is an (N+1)×(N+1) affine matrix, wherein the affine matrix comprises an N×N orthogonal matrix and an N×1 vector.

In another example, the sequence embedding generation system may further comprise: an embedding function unit configured to: receive an input sequence comprising a plurality of data values, apply the embedding function to each data value in the input sequence to generate a sequence of (N+1)×(N+1)-dimensional affine matrices corresponding to the input sequence of data values; a processing unit configured to: receive a sequence of (N+1)×(N+1)-dimensional affine matrices corresponding to an input sequence of data values, perform a matrix multiplication of the (N+1)×(N+1) affine matrices in the order of their position in the sequence to generate a composite (N+1)×(N+1) affine matrix representation of the sequence of data values.

One example of the first aspect can be realized in a decoder only transformer-based text processing system comprising a self-attention module that is based on leveraging the insight that plain text is a knowledge graph where the relationship between tokens is <neighbor of>.

In another example of the first aspect described in this specification can be realized in a vector database system comprising one or more non-transitory computer storage media encoded with a data set, the data set associating a CE in the data set with a data value, wherein the data value belongs to a multiset of data values, and the data set also organizing the CEs, using the similarity metric of CEs, into a hierarchical vector index for faster query responses; a query receiver configured to receive a query CE representing a query item; a similarity calculator configured to calculate a similarity score between the query CE and each CE based on the similarity metric of the CNM set of CEs; a ranking module configured to rank the CEs based on their similarity scores to the query embeddings; a retrieval generator configured to generate a retrieval result comprising a subset of the CEs based on the ranking; and an output module configured to output the retrieval result.

In general, one example of the first aspect described in this specification can be realized in a data processing system implemented in one or more computers that can be configured to transform data values or multisets of data values into CEs, wherein the data values are drawn from a predetermined source set of data values. The data processing system may comprise an embedding system configured to receive input data values and map them to their respective CEs to generate a multiset of CEs, optionally including a feature extraction module that generates a collection of features from each data value, and an embedding layer configured to receive a partially ordered nested multiset of features and to generate a corresponding partially ordered nested multiset of CEs. The system may further comprise a processing unit configured to perform a merging operation to generate a merged CE from a multiset of CEs—wherein the multiset of CEs may be ordered, partially ordered, or unordered, and wherein the merged CE depends on both the individual CEs and any order present in the set of CEs—and to perform a difference operation to generate a difference CE from an ordered pair of input CEs, wherein the difference CE depends on both the input CEs and their order. The data processing system may also include a similarity metric computation unit configured to generate a similarity measure between two CEs to produce a similarity measure between a pair of data values, a data value and a multiset of data values, or a pair of multisets of data values.

Other examples of the data processing system may have the following features. Data values may be images, audio segments, sensor data values, or other structured or unstructured information that can be represented numerically. In some examples, the data values may correspond to text tokens, video frames, biological sequences, or telemetry measurements. The feature extraction module may be domain-specific, employing convolutional feature maps for images, spectral feature transforms for audio, token or subword embeddings for text, or statistical encoders for numerical or sensor data. The embedding layer may map extracted features to CEs in accordance with the CNM set, while preserving relevant structural or temporal relationships. The processing unit may further comprise multiple submodules configured to perform hierarchical or recursive merging operations to support multi-scale or multi-modal data. In some examples, the similarity metric computation unit may employ a distance or similarity function defined on the non-abelian set, such as cosine similarity, geodesic distance, or group-invariant measures, to evaluate correspondence between CEs of distinct data values or multisets.

An example of a string processing system can be realized in a string alignment system that further comprises a method for aligning two strings that comprises receiving, as input, two sequences of CEs, one CE for each token in both strings; computing a similarity matrix by comparing the CE of each token in the first sequence with the CE of each token in the second sequence, thereby yielding a learned, context-dependent scoring function; applying a dynamic programming algorithm, such as Smith-Waterman or Needleman-Wunsch, to this similarity matrix in place of a conventional substitution matrix, optionally incorporating learned or predefined gap penalties; identifying an optimal path through the matrix, aligning tokens in the first sequence to tokens in the second sequence according to these learned similarity scores.

In general, one example of a data processing system can include a classifier implemented in one or more computers, comprising: an embedding generation system configured to receive an input comprising one or more data values and to map the input into a corresponding CE; and a classifier layer configured to process the CE of the input to generate a respective score for each label in a predetermined set of labels, wherein each of the respective scores represents a predicted likelihood that the input corresponds to the associated label.

Other examples of the data processing system may include one or more of the following features. The data values may be audio segments in a command recognition system, images in an image classification system, text tokens in a natural language processing system, or sensor measurements in an event detection system. The classifier layer may be implemented using one or more neural network architectures, including feed-forward networks, convolutional networks, recurrent networks, or transformer-based networks. In some examples, the classifier may be trained using supervised, semi-supervised, or reinforcement learning methods, and the labels may correspond to categories, commands, classes, or actions. The embedding generation system may employ domain-specific feature extraction prior to generating CEs, and the classifier layer may use similarity scores, distance metrics, or learned transformations of the CEs to compute the predicted likelihoods.

In general, one example of a data processing system can include a prediction system implemented in one or more computers configured to receive a sequence of data values and predict a subsequent data value in the sequence, comprising: a plurality of processing subsystems each configured to receive a subsequence of data values, wherein each subsequence is a subset of the original sequence, and to map the subsequence into a corresponding subsequence CE; and a classifier layer configured to receive and process all subsequence CEs to generate a respective score for each candidate data value in a predetermined set of possible outputs, wherein each of the respective scores represents a predicted likelihood that the candidate data value is the next value in the sequence.

Other examples of the data processing system may have the following features. The data values may be words in a text sequence, tokens in a programming language, frames in a video, or samples in an audio signal. The classifier layer may employ a vocabulary-sized linear layer with SoftMax for discrete prediction tasks, a regression layer for continuous values, or another output head suited to the data modality. The processing subsystems may include hierarchical or recurrent modules that capture context across varying lengths, such as transformer layers, long short-term memory units, or recursive networks. In some examples, the prediction system may be trained using supervised, unsupervised, or reinforcement learning methods, and may generate one or more predicted values in parallel. The embeddings produced by the processing subsystems may incorporate contextual corrections, hierarchical representations, or attention-based mechanisms to improve predictive accuracy.

Particular examples of the data processing system can be implemented so as to realize one or more of the following advantages. Unknown data values in a sequence can be effectively predicted when surrounding data values are known. Data values surrounding a known data value in a sequence can likewise be inferred. CEs of data values within a defined vocabulary or dataset can be easily and effectively generated. The CEs can reveal structural, contextual, or semantic similarities and relationships between the data values that they represent. CEs of multiple data values can be merged to obtain CEs of higher-level groupings—such as phrases, sentences, images, or temporal segments—that capture broader compositional relationships within the data.

In general, one example of the first aspect described in this specification can be realized in a sequence-to-sequence transducer system, configured to receive a sequence of input data values and generate a sequence of output data values, the sequence-to-sequence transducer comprising an encoder and a decoder, wherein the encoder comprises a data processing system configured to transform the sequence of input data values into an input CE; and wherein the decoder comprises a sequence generation system configured to receive the input CE and generate a sequence of output data values.

Another example of a data processing system can include a text prediction system implemented in one or more computers configured to receive a sequence of words and predict the next word in the sequence. The system may comprise a source vocabulary that includes one or more disambiguated versions of each word; an embedding system configured to map each word and each disambiguated version to its respective embedding; and a disambiguation system comprising a classifier layer configured to process the embeddings of words in the neighborhood of a target word together with the embeddings of each disambiguated version of the target word to generate a predicted likelihood for each disambiguated version, wherein each score represents a likelihood that a particular disambiguated version corresponds to the correct sense of the target word. The system may select the disambiguated version with the maximum predicted likelihood for each word in the sequence, thereby translating the input sequence of words into a sequence of disambiguated versions of words. A plurality of text processing subsystems may then each receive a subsequence of disambiguated versions of words—each subsequence being a subset of the original sequence—and map the subsequence into a corresponding embedding. A classifier layer may process the embeddings arising from all subsequences to generate a respective score for each disambiguated version of each word in the vocabulary, wherein each score represents a predicted likelihood that the particular disambiguated version of the word is the next word in the sequence.

In related examples, the data processing system may include a method for generating and training a multi-sense vocabulary, wherein each word is represented by one or more disambiguated versions. Each disambiguated version may be indicated by a label appended to the word, and an embedding may be generated for every entry in the multi-sense vocabulary. The method may comprise obtaining training data comprising sequences of words, training a classifier and an embedding function jointly on the training data, and disambiguating each word by processing the words in its neighborhood via the embedding function and classifier to obtain a predicted word. If the predicted word is produced with a likelihood exceeding a threshold and differs from the selected word, a label is appended to form a new disambiguated version of the selected word. When a new disambiguated version is created, it is added to the multi-sense vocabulary, and the embedding function is expanded so that the embedding of the new disambiguated version initially equals that of the original word. The occurrences of each new disambiguated version may be counted in the disambiguated training data, and any version whose count falls below a threshold may be removed from the vocabulary, with the corresponding labels also removed from the training data. The embedding function parameters corresponding to all remaining disambiguated versions may then be fine-tuned on the disambiguated training data. The foregoing text prediction and vocabulary-generation systems, apparatus, and computer programs may each be implemented as instructions encoded on one or more non-transitory computer-readable storage media configured to perform the described operations.

In some examples of the first aspect, the custom non-abelian mathematical (CNM) set is a vector-linear transformation (VLT) set, and the custom embedding (CE) is a vector-linear transformation embedding (VLE) that is an element of the VLT set. A VLT set is a CNM set equipped with a plurality of non-abelian associative binary operations, defined by a vector space and a plurality of transformation semigroups of linear transformations from the vector space to itself, wherein each transformation semigroup defines a non-abelian associative binary operation and the linear transformations within the same semigroup and across semigroups may commute with each other. A VLE is a tuple comprising a vector component that is an element of the vector space, and a plurality of linear-transformation components, one drawn from each transformation semigroup of the VLT set, such that the number of linear-transformation components equals the number of binary operations. A non-abelian associative binary operation on a first VLE and a second VLE may only be defined when the linear-transformation components defining all other non-abelian binary operations in the first and second VLEs are identical; in such cases (i) the linear-transformation components defining all other non-abelian binary operations are carried through unchanged, (ii) the linear-transformation component defining the selected non-abelian binary operation is obtained by composing the corresponding linear-transformation components of the first and second VLEs, and (iii) the vector component is obtained by applying the first VLE's linear-transformation component defining the selected non-abelian binary operation to the second VLE's vector component to obtain a transformed vector component and then adding the first VLE's vector component.

A variation of the above example may have the following features. The VLT set may further comprise an additional abelian binary operation, and wherein: the abelian binary operation is only defined when the linear transformation components in the first and second VLE are identical, wherein: the linear transformation components of the resulting VLE is the same as the linear transformation components of the first and second VLEs; and the vector component of the resulting VLE is obtained by performing a vector addition of the vector components of the first and second VLEs.

An exemplary expression for the first non-abelian associative binary operation in a VLT set with two such operations is (a, A, D)⊕(b, B, D)=(a+Ab, AB, D), where a, b are vectors in a vector space, A, B are linear transformations in the semigroup corresponding to the selected operation, and D is the linear transformation in the semigroup corresponding to the other operation.

In one example, images may be represented using VLEs. If the VLEs of two images, whose dimensions along the y-axis are identical, are (a, Aₓ, D_{y}) and (b, Bₓ, D_{y})—wherein the first linear transformation component is in one-to-one correspondence with the x-axis and the second linear transformation component is in one-to-one correspondence with the y-axis-then the VLE of the concatenation of the two images along the x-axis can be obtained by (a, Aₓ, D_{y})⊕ₓ(b, Bₓ, D_{y})=(a, Aₓb, AₓBₓ, D_{y}) wherein ⊕ₓ denotes the non-abelian binary operation in one-to-one correspondence with the x-axis. Similarly, the VLE of the concatenation along the y-axis of two images, whose dimensions along the x-axis are identical, can be obtained by (a, Dₓ, A_{y})⊕_{y}(b, Dₓ, B_{y})=(a+A_{y}b, Dₓ, A_{y}B_{y}).

In another example, the VLT set may be a single-operation VLT (SVLT)—a VLT set with exactly one non-abelian associative binary operation determined by a vector space and a single transformation semigroup on that space. In the SVLT case, each element (SVLE) comprises a vector component from the vector space and one linear-transformation component from the transformation semigroup. Because there is only one non-abelian operation, the domain-agreement condition on ‘other’ transformation components is vacuously satisfied; accordingly, the non-abelian operation on any pair of SVLEs is always defined.

An exemplary mathematical expression of the SVLT operation above is (a, A)⊕(b, B)=(a+Ab, AB).

In an alternative example of the SVLT, the vector component a may be an N-dimensional vector of real values and the linear transformation component A may be a real-valued matrix of size N×N.

In another alternative example of the SVLT, the transformation component A may be restricted to an integer power of a fixed N×N matrix M. i.e. (a, Mⁿ)⊕(b, Mⁿ)=(a+M^{m}b, M^{m+n}) with an equivalent form given by (a, m)⊕(b, n)=(a+M^{m}b, m+n).

In another example of the SVLT, a and b may be vectors of real numbers, and A and B may be block diagonal matrices where every matrix on the diagonal is a 2×2 orthogonal matrix then the equivalent example may be given by (a, a)⊕(b, β)=(a+e^{iα}b, α+β) where α and β are vectors of angles and are half the length of a and b, e^{iα} denotes converting the vector of N/2 angles into a N×N matrix block diagonal orthogonal matrix using the angles in α.

In one example, text tokens may be represented using SVLEs. If the SVLEs of two text tokens are (a, A) and (b, B), then the SVLE of the sequence obtained by concatenating the two tokens can be obtained by (a, A)⊕(b, B)=(a+Ab, AB).

An example of the first aspect can be realized in SVLE methods, wherein the methods comprise representing data values using single operation vector-linear transformation embeddings (SVLEs) by applying a mapping function that, for data values selected for embedding, maps each value to a VLE whose components are defined by the SVLT.

In another example, the VLT set may be a power-matrix VLT (PMVLT) equipped with a plurality of transformation semigroups and base linear transformations wherein each base linear transformation is in one-to-one correspondence with a transformation semigroup. In this example, a VLE is an PMVLE that comprises a vector component and, for each non-abelian binary operation in the PMVLT, one linear-transformation component that is an integer power of the base transformation defining that operation.

Variations of the PMVLT may have the following features. The base transformations may be orthogonal or unitary operators. When the PMVLT includes more than one non-abelian operation (for example, one per coordinate axis), the base transformations may be chosen to commute so that cross-axis compositions are order-independent. The single-operation special case is a power-matrix SVLT (PM-SVLT), in which each VLE is a PM-SVLE and consists of a vector component and one transformation component that is an integer power of a single base transformation, and the non-abelian operation is always defined.

An example of the first aspect can be realized in PMVLE methods, wherein the methods comprise representing data values using power-matrix vector-linear transformation embeddings (PMVLEs) by applying a mapping function that, for data values selected for embedding, maps each value to a VLE whose components are defined by the PMVLT: a vector component in the vector space and a plurality of transformation components, one per non-abelian operation, wherein each transformation component is the base transformation defining that operation.

In general, one example of multidimensional non-abelian summation can be realized in a VLE merging unit, one or more computers and one or more storage devices storing instructions that, when executed by the one or more computers, cause the one or more computers to receive a multidimensional signal of vectors of real numbers as input and generate an output vector; wherein the non-abelian merging unit may be configured to: receive a signal of vectors of real numbers; invoke a mapping function that maps each vector in the signal at its coordinate position to a VLE to generate a signal of VLEs; perform a non-abelian binary operation on the VLEs by proceeding in a fixed order of coordinate axes and, for each selected axis, combining VLEs in the order of their indices along that axis while the linear-transformation components for the non-selected axes are equal, to generate a merged VLE; and extract the vector component of the merged VLE as the output vector of the merging unit.

In some examples, when the per-axis linear transformations commute, the result of the non-abelian summation is independent of the chosen order of coordinate axes used to perform the merging.

In general, an example of the multidimensional non-abelian summation can be realized in a PMVLE merging system, wherein a VLE is a PMVLE equipped with a plurality of orthogonal matrices independent of the input signal, wherein each orthogonal matrix is in one-to-one correspondence with a dimension of the multidimensional input, serves as the base linear transformation for the non-abelian binary operation for that dimension, and wherein the orthogonal matrices commute with each other; and wherein the system comprises one or more computers and one or more storage devices storing instructions that, when executed by the one or more computers, cause the one or more computers to receive a signal of vectors and produce an output vector that is a non-abelian summation of the vectors, the system comprising: a non-abelian merging unit, wherein the non-abelian merging unit is configured to: for each vector in the multidimensional signal, generate a powered orthogonal matrix by, for each dimension of the multidimensional signal, raising the corresponding orthogonal matrix to a power equal to the vector's index along that dimension to produce dimensional powered orthogonal matrices; multiply the dimensional powered orthogonal matrices to generate a powered matrix in one-to-one correspondence with that vector; multiply each vector by its corresponding powered orthogonal matrix to produce a multidimensional signal of transformed vectors; and perform vector addition of the transformed vectors by summing corresponding elements of the transformed vectors to produce the output vector.

A specific example of the PMVLE aggregation system for a two-dimensional signal relates to generating the non-abelian context vector at position (i, j) in a self-attention module as

$${\sum }_{k = 0}^{N} {\sum }_{l = 0}^{M} {R}_{x}^{k} {R}_{y}^{l} v ( i - k , j - l )$$

where Rₓ and R_{y} are the orthogonal matrices corresponding to x- and y-axes respectively, Rₓ and R_{y} commute with each other, and v(i, j) is the weighted value vector at (i, j).

A specific example of the above example relates to the case where Rₓ and R_{y} are block diagonal matrices where each block along the diagonal is a 2×2 orthogonal matrix.

A specific example of the PMVLE aggregation system can be realized in a single-operation PMVLE (SPMVLE) aggregation system, wherein the input has a single dimension and the index of each data value may be given by its position in the sequence.

A specific example of the SPMVLE aggregation system relates to generating the context vector at position i in a self-attention module as

$${\sum }_{j = 0}^{M} {R}^{j} {v}_{i - j}$$

where R is the orthogonal matrix and vᵢ is the weighted value vector at position i.

An equivalent example of the SPMVLE aggregation system relates to mapping a vector, vᵢ, of floating point numbers of length N to an (N+1)×(N+1) affine matrix of the form [R vᵢ; 0 1] where R is a fixed N×N orthogonal matrix, vᵢ is the vector portion of the affine matrix and is the same as the original vector vᵢ, and 0 is a 1×N vector of zeros and the non-abelian sum is simply the matrix product of the affine matrices

$$( {\prod }_{j = 0}^{M} [ R {v}_{i - j} ; 01 ] ) .$$

The mapping of the non-abelian sum from the transformed domain to the output vector relates to simply extracting the vector portion from the final matrix product.

In some variations involving multi-headed latent attention, value vectors may be up-projected from a shared latent vector prior to aggregation; the non-abelian context computation then operates on the up-projected value vectors head-wise, and head outputs are concatenated or summed before the feed-forward transformation.

In some variations, involving multi-token prediction, multiple non-abelian context vectors at position i can be generated as

$${V}_{k} = {\sum }_{j = 0}^{M} {R}^{j + k - 1} {v}_{i - j}$$

where k≥1 and a single output layer may process Vₖ to predict the output at position i+k.

In general, one example of the embedding system can be realized in an embedding system comprising a PMVLE aggregation system, the embedding system implemented in one or more computers and one or more storage devices storing instructions that, when executed by the one or more computers, cause the computers to receive a multidimensional input signal of data values and generate a PMVLE of the signal as output; wherein the embedding system comprises a coordinate system used to define the positions of the data values in the multidimensional input signal, the number of axes matching the number of dimensions of the multidimensional input signal; a plurality of orthogonal matrices independent of the input data values, each orthogonal matrix being in one-to-one correspondence with a coordinate axis and the orthogonal matrices commuting with each other; wherein the embedding system further comprises a mapping function configured to map each input data value at its position to an embedding vector to produce a multidimensional signal of vectors; wherein the PMVLE aggregation system receives the signal of vectors and generates the non-abelian summation of these vectors using the coordinate system and the plurality of orthogonal matrices, and the resulting non-abelian summation is set as the vector component of the PMVLE; and wherein the transformation components of the PMVLE are set by the embedding system to the orthogonal matrices for the respective axes raised to exponents equal to the length of the input signal along the corresponding axes.

An exemplary PMVLE of a M×N image is a 3-tuple and is given by

$$( {\sum }_{i = 0}^{M - 1} {\sum }_{j = 0}^{N - 1} {R}_{x}^{i} {R}_{y}^{j} v ( i , j ) , {R}_{x}^{M} , {R}_{y}^{N} )$$

where Rₓ is the orthogonal matrix in one-to-one correspondence with the x-axis, R_{y} is the orthogonal matrix in one-to-one correspondence with the y-axis and v(i, j) is the embedding vector at the position (i, j).

An exemplary application may be representing images using PMVLEs that are elements of the above example; and wherein if the PMVLEs of two images, both of size M×N, are given by

$$( a , {R}_{x}^{M} , {R}_{y}^{N} ) and ( b , {R}_{x}^{M} , {R}_{y}^{N} )$$

then the PMVLE of the concatenation of the two images along the x-axis can be obtained by

$$( a , {R}_{x}^{M} , {R}_{y}^{N} ) {⊕}_{x} ( b , {R}_{x}^{M} , {R}_{y}^{N} ) = ( a + {R}_{x}^{M} b , {R}_{x}^{2 M} , {R}_{y}^{N} )$$

wherein ⊕ₓ denotes the non-abelian binary operation in one-to-one correspondence with the x-axis. Similarly, the VLE of the concatenation along the y-axis of two images can be obtained by

$$( a , {R}_{x}^{M} , {R}_{y}^{N} ) {⊕}_{y} ( b , {R}_{x}^{M} , {R}_{y}^{N} ) = ( a + {R}_{y}^{N} b , {R}_{x}^{M} , {R}_{y}^{2 N} ) .$$

In another example, the matrix components of a PMVLE may be represented by integers that encode the exponents of the axis base transformations, yielding an equivalent integer-parameterized form. For an M×N image, an equivalent PMVLE may be written as

$$( {\sum }_{i = 0}^{M - 1} {\sum }_{j = 0}^{N - 1} {R}_{x}^{i} {R}_{y}^{j} v ( i , j ) , M , N )$$

whose vector component is the non-abelian summation of the position-wise transformed embedding vectors defined for PMVLE aggregation, and whose two integer components are M and N, indicating the powers of the x-axis and y-axis base transformations, Rₓ and R_{y} respectively. In this integer form, if two images are both of size M×N, and their PMVLEs are (a, M, N) and (b, M, N) then concatenation of the two images along the x-axis yields

$$( a , M , N ) {⊕}_{x} ( b , M , N ) = ( a + {R}_{x}^{M} b , 2 M , N ) .$$

Similarly, concatenation along the y-axis of two images yields

$$( a , M , N ) {⊕}_{y} ( b , M , N ) = ( a + {R}_{y}^{N} b , M , 2 N ) .$$

In some examples, the PMVLE aggregation unit is implemented as a chip-level accelerator (e.g., ASIC, DSP, or FPGA fabric) that natively realizes power-matrix vector-linear transformation embeddings (PMVLEs) and their non-abelian aggregation: the device stores per-axis base transformations (e.g., orthogonal or unitary matrices selected to commute across axes) and, for each input coordinate, generates exponentiated transforms, multiplies them to form a powered matrix, left-multiplies the local embedding vector by that powered matrix, and performs the non-abelian summation by accumulating the transformed vectors in streaming fashion; in some designs the base transforms are block-diagonal with 2×2 orthogonal blocks, and the matrix components are encoded by integer exponents to reduce storage and update only dimension metadata on concatenation (“power-and-add”) rather than re-materializing full matrices; the accelerator further exposes a single-dimension SPMVLE mode for sequence processing and attention, realized either by repeated application of a fixed R or by an equivalent affine-product formulation, a magnitude-vector unit that forms block norms of the composite embedding to produce shift-invariant signatures for retrieval and comparison, and an optional alignment engine that evaluates candidate shifts by multiplying the composite vector by exponentiated transforms per axis; variations support multi-head up-projection and head-wise non-abelian context computation, and the vector component can be real-, quaternion-, or dual-quaternion-valued to match modality needs.

In some examples, a single-operation power-matrix vector-linear transformation embedding (SPMVLE) is used to represent a sequence of words indexed by an external time coordinate, wherein the index derives from temporal coordinates and each word is associated with a learnable duration that determines the power applied to a learned base transformation R along the time axis; at position t, local embedding vectors for words contribute via R^{Δt} where Δt accumulates the learned per-word durations and may be a real number (i.e. can take on non-integer values), and the non-abelian sum is formed as in the SPMVLE aggregation by applying the powered transform and accumulating transformed vectors (or, equivalently, by the affine-product formulation). In particular implementations, R corresponds to the time axis and is learned jointly with the durations; R may be block-diagonal with 2×2 orthogonal blocks, in which case learning R corresponds to learning per-block rotation frequencies so that the duration of each word advances phase accordingly. An equivalent index-parameterized form may encode only the exponents associated with the time axis, providing a compact representation while preserving the non-abelian composition along time.

Other examples of multidimensional embedding generation system can each optionally include one or more of the following features. The embedding generation system may further comprise: an embedding function unit configured to: receive a multidimensional input signal comprising a plurality of data values, invoke the embedding function module on each data value in the input signal to generate a multidimensional signal of primary PMVLEs corresponding to the input signal of data values; a processing unit configured to: receive a multidimensional signal of primary PMVLEs corresponding to a multidimensional input signal of data values, perform a non-abelian binary operation of the PMVLT set on the primary PMVLEs in the order of their position in the multidimensional signal to generate a merged PMVLE of the multidimensional input signal of data values.

In other examples of multidimensional embedding generation system the vector component may be a vector of real numbers, and the linear transformation component may be a square matrix. The vector component may be a vector of quaternions, and the linear transformation component may be a diagonal square matrix wherein the diagonal entries are quaternions. The vector component may be a vector of dual quaternions, and the linear transformation component may be a diagonal square matrix wherein the diagonal entries are dual quaternions. The linear transformation component may be an orthogonal matrix. The linear transformation component may be a block diagonal matrix wherein each submatrix on the diagonal is a 2×2 orthogonal matrix. The linear transformation components of the primary PMVLEs may be identical.

Another example of the data processing system may further store a fixed orthogonal block diagonal matrix independent of input data, wherein each submatrix on the diagonal is a 2×2 orthogonal matrix, and wherein the mapping function maps an input vector to a composite element wherein the vector component of the composite element is equal to the input vector, and the matrix component is the fixed orthogonal block diagonal matrix.

In general, one example of the first aspect can be realized in a multidimensional signal alignment system comprising one or more computers and one or more storage devices storing instructions that, when executed by the one or more computers, cause the computers to receive first and second multidimensional input signals of data values and generate a multidimensional alignment result between the first and second multidimensional signals; wherein the system comprises: a coordinate system used to define the positions of the data values in the multidimensional input signal, the number of axes matching the number of dimensions of the multidimensional input signal; a plurality of orthogonal matrices independent of the input data values, each orthogonal matrix being in one-to-one correspondence with a coordinate axis and the orthogonal matrices commuting with each other; a multidimensional embedding generation unit configured to receive the first and second multidimensional input signals and generate a first and a second PMVLE using the coordinate system and the orthogonal matrices; and an alignment unit configured to receive the first and second PMVLEs and return a maximum alignment score and the multidimensional alignment result, wherein the maximum alignment score is the maximum over all candidate alignment scores, each candidate score uniquely identifying a candidate multidimensional alignment, and the returned alignment being the candidate with the maximum score; and wherein each coordinate of a candidate multidimensional alignment lies between a corresponding lower and upper limit for that coordinate, the limits depending on the lengths of the first and second multidimensional signals along the corresponding axis; and wherein the candidate alignment score is a similarity between a transformed first vector and a second vector, the transformed first vector being the vector component of the first PMVLE multiplied by a product of exponentiated orthogonal matrices, formed by, for each axis, raising that axis's orthogonal matrix to the candidate alignment's coordinate along that axis, and the second vector being the vector component of the second PMVLE.

In an alternative example, the orthogonal matrices are block-diagonal, each diagonal block being a 2×2 orthogonal matrix, and the multidimensional signal alignment system further comprises a similarity unit configured to return a rough alignment score. The similarity unit receives a first and a second vector, where the first vector is the vector component of a first PMVLE and the second vector is the vector component of a second PMVLE, forms corresponding magnitude vectors by grouping each input vector into consecutive pairs of elements and taking the Euclidean norm of each pair (thereby halving the length), and returns the rough alignment score as a similarity between the two magnitude vectors.

A specific example of the multidimensional alignment system can be realized in a sequence alignment system wherein the input signals have a single dimension and are sequences, and the index of each data value is its position in the sequence; wherein an alignment is an integer shift of one sequence relative to the other.

Other examples of the sequence alignment system may have the following optional features. The vectors may be N-dimensional vectors and the orthogonal matrix may be a block diagonal N×N matrix wherein each submatrix along the diagonal is a m×m orthogonal matrix, and wherein the sequence alignment system further comprises: a similarity unit configure to: receive a first and second N-dimensional vectors, generate a first and second N/m-dimensional magnitude vectors by: selecting a N-dimensional vector, selecting each m-tuple of consecutive elements from the N-dimensional vector, computing the Euclidean norm of each selected m-tuple to form the corresponding N/m-dimensional magnitude vector; obtain a similarity score between the first magnitude vector and the second magnitude vector; return the similarity score as the similarity score between the two sequences.

In other examples, the sequence of N-dimensional vectors corresponding to a sequence of input data values may come from a multi-layered transducer wherein each N-dimensional vector corresponding to a data value incorporates contextual information from the surrounding data values.

In some examples of the sequence alignment system, to align vectors a and b under powers of a unitary place operator R taken as block-diagonal with real 2×2 rotation blocks R(θⱼ), we first compute a closed-form estimate k₀ and then refine by a small discrete search around k₀. Using the real-to-complex identification per block, let aⱼ:=a₂ⱼ₋₁+ia₂ⱼ and bⱼ:=b₂ⱼ₋₁+ib₂ⱼ. If all blocks share a common angle θ, define C:=Σⱼaⱼb̅ⱼ̅ and set

$${k}_{0} = round ( - \frac{arg C}{θ} ) .$$

If the angles {θⱼ} differ, form per-block suggestions \tilde{k}ⱼ=−arg(aⱼb̅ⱼ)/θⱼ (taken modulo 2π/θⱼ), compute their weighted circular mean with weights |aⱼb̅ⱼ| to obtain k₀, and round to the nearest integer. In both cases, finalize the shift by evaluating

$${k}^{*} = arg {max}_{k ∈ \{ {k}_{0} - r , … , {k}_{0} + r \}} Re {\sum }_{j} {a}_{j} {\overline{b}}_{j} , {e}^{i k {θ}_{j}} ,$$

for a small radius r (e.g., r∈{2,3,4}), thereby selecting the exact maximizer in a tight neighborhood of the analytic estimate.

In another example of the first aspect, an m-abs representation of a sequence is obtained from subsequences of length m, comprising: forming, from a sequence of length N, the N−m+1 contiguous subsequences of length m by sliding a window along the sequence; for each subsequence, applying a mapping function to produce a signal of vectors and generating a PMVLE; computing a magnitude vector from the subsequence PMVLE's vector component; and performing an abelian summation of the magnitude vectors from all length-m subsequences to yield the m-abs representation of the sequence. As special cases, setting m=N yields the representation obtained by computing a PMVLE for the entire sequence and then applying the same magnitude operation to its vector component, and setting m=1 yields the abelian sum of per-element magnitude vectors.

In general, one example of the first aspect is a multiple-sequence alignment method that uses the m-abs representations. The method comprises computing, for each sequence and for selected values of m, the corresponding m-abs representations; evaluating similarity between sequences by a similarity measure on those m-abs representations; and clustering sequences by that similarity. Refinement may proceed by first clustering on the 1−abs representation and then iteratively re-clustering on m-abs representations for increasing m. High similarity at a given m indicates that the sequences share many length-m patterns even when those patterns occur at different positions or with gaps.

In another example of the first aspect, a sequence-alignment method computes an m-abs left-right representation for a target data value using the previously defined m-abs construction. The method comprises forming a left subsequence and a right subsequence by taking, respectively, the data values to the left and to the right of the target (including the target in both), computing the m-abs representation of each subsequence as previously defined, concatenating the two results to obtain the m-abs left-right representation of the target, and identifying anchor points between two sequences by a compound similarity equal to the sum of the similarities of the left and right m-abs parts. If a subsequence is shorter than m, its contribution to the compound similarity is taken to be zero.

In another example, the m-abs representation can be extended to two dimensions, comprising: for a two-dimensional signal of size N×M, forming the (N−n+1)×(M−m+1) sub-windows of size n×m by sliding a window across the signal; for each sub-window, applying the mapping function to produce a vector signal and generating a PMVLE; computing a magnitude vector from the sub-window PMVLE's vector component; and performing an abelian summation of all sub-window magnitude vectors to obtain the (n, m)−abs representation of the original signal. This construction extends to higher-dimensional signals by sliding a hyper-rectangular window along each dimension and summing the resulting magnitude vectors.

In one example of a PMVLE-based sentence embedding system, a sequence of word embeddings is obtained using a pre-trained model and combined by a position-weighted summation in which a fixed block-diagonal rotary transformation is applied to each word embedding according to its index; the resulting embedding vector is partitioned into fixed-size blocks and a magnitude vector is formed by taking the Euclidean norm of each block, the magnitude vector being provided to a classifier trained under a supervised loss.

In one example of a PMVLE-based multidimensional embedding generation system, an input occupying an N₁×N₂× . . . ×Nₖ grid is embedded by summing local embedding vectors left-multiplied by the product of axis-specific block-diagonal rotary transformations raised to coordinate powers, the axis transformations commuting with one another; a magnitude vector is then constructed from fixed-size blocks of the composite embedding and used as input to a downstream module.

In one example of a PMVLE-based similarity and retrieval method, magnitude vectors constructed from block norms of composite embeddings serve as shift-invariant signatures: uniform translations of the input along any axis do not change the magnitude vector while preserving sensitivity to content through the underlying composite embedding; these signatures support classification, retrieval, and comparison without explicit alignment.

In one example of a PMVLE-based one-dimensional signal embedding method, each data value may be mapped to a fixed-dimensional embedding and a rotary transformation raised to a position-dependent power is applied prior to summation; the derived magnitude vector may incorporate dropout during training and serves as input to a classifier or other downstream module.

In one example of a PMVLE-based multidimensional embedding method for sparse or non-rectangular inputs, the object may be enclosed in a minimal bounding prism, undefined locations are mapped to zero vectors, and the same axis-powered transformation summation is applied; the resulting embedding preserves spatial extents and remains compatible with algebraic composition, concatenation, and alignment procedures.

In one example of a PMVLE-based embedding concatenation operator, concatenation along axis k may be defined so that adding one signal along that axis maps to adding the axis-powered transformation of one vector component into the other and updating only the axis-k size by addition while taking the maximum size along other axes, thereby preserving dimensional metadata and directional composition.

In one example of the PMVLE-based VLT framework, the axis transformations may be required only to be pairwise commutative and need not be orthogonal, thereby preserving order-independence across axes while broadening the class of admissible transformations for multidimensional embedding, merging, and alignment.

In one example of a PMVLE-based vector-database retrieval system, similarity between two multidimensional signals may be computed as a distance or similarity between their shift-invariant magnitude vectors derived from rotary-powered composite embeddings; the magnitude vectors are stored as indexable keys for nearest-neighbor search and retrieval.

In one example of a PMVLE-based residual processing layer, each layer may output an additive update to a base representation, the update at position i depending only on other positions (and, in masked settings, excluding masked positions), thereby producing context-derived correction embeddings that are added to form updated embeddings; a final rotary-weighted sentence embedding and its magnitude vector are then computed for supervised prediction.

In one example of a PMVLE-based sequence concatenation and storage method, concatenation of one-dimensional sequences may be realized by storing the vector component formed by applying the fixed or learned transformation the requisite number of times to the second sequence's vector and adding it to the first sequence's vector, together with an integer representing total length; the multidimensional generalization stores (vector, per-axis powered transformations) and composes along a selected axis using the same power-and-add rule.

A variation of the CNM-based sequence transduction system can have the following features. G may be a PMVLT set wherein an PMVLE of a data value in the input sequence is a composite element with two components, a complex vector component and a fixed N×N unitary matrix A. Then the subsystem may take the form x(t+1)=Ax(t)−A^{m}f(u(t−m))+f(u(t)) and y(t)=g(x(t))+u(t) wherein A is an N×N unitary matrix, x(t) is the state of the subsystem at time t and is an N×1 complex vector, f( ) is a mapping [symbol] ^{M}→ [symbol] ^{N}, g( ) is a mapping [symbol] ^{N}→ [symbol] ^{M}, u(t) is the complex vector input to the subsystem at time t of size M×1, and y(t) is the complex vector output of the subsystem at time t of size M×1.

In general, other examples of the first aspect of the subject matter described in this specification can include methods that comprise the actions of obtaining a set of training data, wherein the set of training data comprises a knowledge graph comprising data triples, wherein a data triple consists of a relationship and two entities, wherein the first entity is a head entity and the second entity is a tail entity and wherein the relationship is an element of a pre-determined finite set of relationships; training a transducer on the training data wherein the transducer comprises one or more transduction subsystems, each transduction subsystem configured to receive the output of the preceding subsystem, wherein the input (uₕ and uₜ) and output (yₕ and yₜ) are a pair of embeddings corresponding to the head and tail entities, and the input to the output layer is the output of the final layer wherein the output layer is configured to predict entities and wherein R_{y}_{ₕ} may be used to predict the tail entity and R⁻¹yₜ may be used to predict the head entity, and wherein training involves minimizing the cross-entropy loss and maximizing the likelihood that the predicted entity is the correct entity, and wherein:
yₕ and yₜ may be computed using a non-abelian layer, yₜ=Rf(R⁻¹uₜ)+uₜ and yₕ=R⁻¹f(Ruₕ)+uₕ where f( ) is a feedforward neural network of appropriate input and output dimensions and R is the square matrix representation of the relationship in the data triple.
Alternatively, yₕ and yₜ may be computed as yₜ=f(R⁻¹uₜ,uₜ) and yₕ=f(Ruₕ,uₕ) where f( ) is a feedforward neural network of appropriate input and output dimensions
Alternatively, yₕ and yₜ may be computed as yₜ=f(R⁻¹,uₜ)+uₜ and yₕ=f(R, uₕ)+uₕ where f( ) is a feedforward neural network of appropriate input and output dimensions
Alternatively, yₕ and yₜ may be computed as yₜ=f(R⁻¹)+uₜ and yₕ=f(R)+uₕ where f( ) is a feedforward neural network of appropriate input and output dimensions
R representing the relationship in a data triple may be the same across all layers, or each layer may have its own version of R

In general, other examples of SVLE methods can include methods that comprise the actions of obtaining a set of training data, wherein the set of training data comprises textual data in the form of sequences of text tokens, and a knowledge graph comprising data triples, wherein a data triple consists of a relationship and two entities consisting of sequence of text tokens, wherein the first entity is a head entity and the second entity is a tail entity and wherein the relationship is an element of a pre-determined finite set of relationships; training a transformer architecture on the combined training data, wherein the training might comprise:
Training an autoregressive language model by converting knowledge graph triples to text. E.g. “New Delhi <capital of> India” gets converted to “New Delhi is the capital of India”
Training an autoregressive language model by treating knowledge graph triple as a sentence itself where the relationship becomes part of the vocabulary, i.e. the tokens then would be “New”, “Delhi”, “<capital of>”, “India”
Training an autoregressive language model by treating every knowledge graph triple as two sentences, one forward and one reverse. E.g. “New Delhi <capital of> India” and “India <inverse of capital of> New Delhi”
Training an autoregressive language model by using masked language modeling on knowledge graph triples (by treating them as text) and autoregressive language modeling on textual data, wherein the same parameters are trained across both modeling methods

In general, other examples of SVLE methods can include methods that leverage the insight that plain text is a knowledge graph where the relationship between entities is <neighbor of>. E.g. “New Delhi is the capital of India” may be treated as “New <neighbor of Delhi> Delhi <neighbor of is> is <neighbor of the> the <neighbor of capital> capital <neighbor of of> of <neighbor of India> India” as opposed to the data triple “New <neighbor of Delhi> Delhi <capital of> India”. In the examples above “New”, “Delhi”, “is”, “the”, “capital”, “of”, “India” are text tokens. Alternatively, the knowledge triple can be treated as text where “New”, “Delhi”, “<capital of>”, “India” are text tokens and the knowledge graph treatment applied as “New <neighbor of Delhi> Delhi <neighbor of capital of > capital of <neighbor of India> India” where italicization of “<capital of>” shows treating “<capital of>” as a text token rather than a relationship; wherein the methods further comprise the actions of obtaining a set of training data, wherein the set of training data comprises textual data in the form of sequences of text tokens, and a knowledge graph comprising data triples, wherein a data triple consists of a relationship and two entities consisting of sequence of text tokens, wherein the first entity is a head entity and the second entity is a tail entity and wherein the relationship is an element of a pre-determined finite set of relationships; training a transformer architecture on the combined training data, wherein the training might comprise a uniform strategy autoregressive language modeling on both textual data and knowledge graph triples, or might comprise a mixed-strategy with autoregressive language modeling on textual data with masked language modeling on knowledge graph triples, with the following steps regardless of strategy:
Let Rᵢ denote the relationship present between i and i−1 tokens and be a function of the i^{th} token (i.e. the VLE is a vector, matrix pair−(xᵢ,Rᵢ)).
Then for autoregressive modeling the context vector at the i^{th} position represented by Vᵢ is computed using the following expressions

$${A}_{i , j} = \frac{{q}_{i}^{T} ( {\prod }_{m = j + 1}^{i} {R}_{i + j + 1 - m} ) {k}_{j}}{\sqrt{d}} ,$$

where q₁=Qxᵢ, kᵢ=Kxᵢ, vᵢ=Vxᵢ, A_{i,j} is the attention logit between query position i and key position j, where j<i and the index increases further towards the future,

$${α}_{i , j} = \frac{exp ( {A}_{i , j} )}{{\sum }_{m = 0}^{i} exp ( {A}_{i , m} )} ,$$

where α_{i,j} is the attention weight between query position i and key position j,

$${V}_{i} = {\sum }_{j = 0}^{i} {α}_{i , j} {v}_{j} ,$$

is the abelian aggregation of weighted value vectors. Alternatively,

$${V}_{i} = {\sum }_{j = 0}^{i} {α}_{i , j} ( {\prod }_{m = j + 1}^{i} {R}_{i + j + 1 - m} ) {v}_{j}$$

is the non-abelian aggregation of weighted value vectors.
Then for masked language modeling with full attention the context vector at the i^{th} position represented by Vᵢ is computed using the following expressions

$${A}_{i , j} = \frac{{q}_{i}^{T} ( {\prod }_{m = j + 1}^{i} {R}_{i + j + 1 - m} ) {k}_{j}}{\sqrt{d}} when j < i and {A}_{i , j} = \frac{{q}_{i}^{T} ( {\prod }_{m = i + 1}^{j} {R}_{m}^{- 1} ) {k}_{j}}{\sqrt{d}}$$

$$when j > i , {α}_{i , j} = \frac{exp ( {A}_{i , j} )}{{\sum }_{m = 0}^{N} exp ( {A}_{i , m} )} , {V}_{i} = {\sum }_{j = 0}^{N} {α}_{i , j} {v}_{j} ,$$

is the abelian aggregation of weighted value vectors. Alternatively,

$${V}_{i} = {\sum }_{j = 0}^{i} {α}_{i , j} ( {\prod }_{m = j + 1}^{i} {R}_{i + j + 1 - m} ) {v}_{j} + {\sum }_{j = i + 1}^{N} {α}_{i , j} ( {\prod }_{m = i + 1}^{j} {R}_{m}^{- 1} ) {v}_{j}$$

is the non-abelian aggregation of weighted value vectors.
If every <neighbor of> relationship is set to a fixed matrix then Rᵢ=R for all i and the autoregressive expressions reduce to

$${A}_{i , j} = \frac{{q}_{i}^{T} {R}^{( i - j )} {k}_{j}}{\sqrt{d}} , {α}_{i , j} = \frac{exp {A}_{i , j}}{{\sum }_{m = 0}^{i} exp {A}_{i , m}}$$

with the corresponding abelian expression and non-abelian expressions for context vector given by

$${V}_{i} = {\sum }_{j = 0}^{i} {α}_{i , j} {v}_{j} and {V}_{i} = {\sum }_{j = 0}^{i} {α}_{i , j} {R}^{( i - j )} {v}_{j}$$

respectively.
If every <neighbor of> relationship is set to a fixed matrix then Rᵢ=R for all i and the relationship in a knowledge triple is not treated as a text token, but as a relationship, and the relationship lies between m and m−1 tokens where j<m<i, then the autoregressive equations reduce to

$${A}_{i , j} = \frac{{q}_{i}^{T} {R}^{( i - m )} {R}_{m} {R}^{( m - 1 - j )} {k}_{j}}{\sqrt{d}} , {α}_{i , j} = \frac{exp {A}_{i , j}}{{\sum }_{m = 0}^{i} exp {A}_{i , m}}$$

with the corresponding abelian expression and non-abelian expressions for context vector given by

$${V}_{i} = {\sum }_{j = 0}^{i} {α}_{i , j} {v}_{j} and {V}_{i} = {\sum }_{j = 0}^{i} {α}_{i , j} {R}^{( i - m )} {R}_{m} {R}^{( m - j - 1 )} {v}_{j}$$

respectively. And if Rₘ and R commute (e.g. if Rₘ and Rare block diagonal matrices and every matrix along the diagonal is a 2×2 orthogonal matrix) then the equations reduce to

$${A}_{i , j} = \frac{{q}_{i}^{T} {R}^{( i - j - 1 )} {R}_{m} {k}_{j}}{\sqrt{d}} , {α}_{i , j} = \frac{exp {A}_{i , j}}{{\sum }_{m = 0}^{i} exp {A}_{i , m}}$$

with the corresponding abelian expression and non-abelian expressions for context vector given by

$${V}_{i} = {\sum }_{j = 0}^{i} {α}_{i , j} {v}_{j} and {V}_{i} = {\sum }_{j = 0}^{i} {α}_{i , j} {R}^{( i - j - 1 )} {R}_{m} {v}_{j}$$

respectively.
The Rᵢ corresponding to a relationship may be common across all layers or each layer can have its own version
R corresponding to the relationship <neighbor of> may be a block diagonal matrix where every matrix along the diagonal is a 2×2 orthogonal matrix.
Rᵢ in one-to-one correspondence with a relationship will be learned and may be a block diagonal matrix with 2×2 matrices along the diagonal
Textual data corresponding to head and tail in a knowledge triple may be tokenized using the same vocabulary and tokenizer used to tokenize textual data
Alternative modeling may involve a multi-headed self-attention module wherein each self-attention module may feature a different combination of attention logit computation and aggregation of weighted-value vectors wherein attention logit computation may be selected from either

$${A}_{i , j} = \frac{{q}_{i}^{T} ( {\prod }_{m = j + 1}^{i} {R}_{i + j + 1 - m} ) {k}_{j}}{\sqrt{d}} or {A}_{i , j} = \frac{{q}_{i}^{T} {k}_{j}}{\sqrt{d}}$$

and the aggregation of weighted-value vectors may be selected from

$${V}_{i} = {\sum }_{j = 0}^{i} {α}_{i , j} {v}_{j} or {V}_{i} = {\sum }_{j = 0}^{i} {α}_{i , j} ( {\prod }_{m = j + 1}^{i} {R}_{i + j + 1 - m} ) {v}_{j}$$

Other examples of the above training methods may have the following features. The VLE of the i^{th} token maybe a vector, matrix, matrix-tuple (xᵢ, Rᵢ, Pᵢ) where Rᵢ may denote the look-back matrix, whereas Pᵢ may denote the look-ahead matrix. And the expressions for the attention logit maybe given by

$${A}_{i , j} = \frac{{q}_{i}^{T} ( {\prod }_{m = j + 1}^{i} {R}_{i + j + 1 - m} ) {k}_{j}}{\sqrt{d}}$$

as before, but the non-abelian aggregation of the weighted value vectors may now be given by

$${V}_{i} = {\sum }_{j = 0}^{i} {α}_{i , j} ( {\prod }_{m = j}^{i} {P}_{i + j - m} ) {v}_{j} .$$

And the output yᵢ may be given by yᵢ=f(Vᵢ)+Pᵢxᵢ. When Rᵢ=Pᵢ=R for all i, then

$${A}_{i , j} = \frac{{q}_{i}^{T} {R}^{( i - j )} {k}_{j}}{\sqrt{d}}$$

as before, but

$${V}_{i} = {\sum }_{j = 0}^{i} {α}_{i , j} {R}^{( i - j + 1 )} {v}_{j}$$

and yᵢ=f(Vᵢ)+Rxᵢ. The output of the final attention layer may pass through a non-abelian layer and the input to the output layer maybe a non-abelian sum of the following form

$${\sum }_{j = 0}^{i} ( {\prod }_{m = j}^{i} {P}_{i + j - m} ) {y}_{j}$$

where yᵢ is the output of the final attention layer. Alternatively, when Pᵢ=R for all i, the input to the output layer maybe a non-abelian sum of the following form

$${\sum }_{j = 0}^{i} {R}^{i - j + 1} {y}_{j} .$$

### Second Aspect

A second aspect described in this specification relates to a hierarchical transformer architecture that enables infinite context by having attention scores in the final layer being independent of the positions of the key and value vectors.

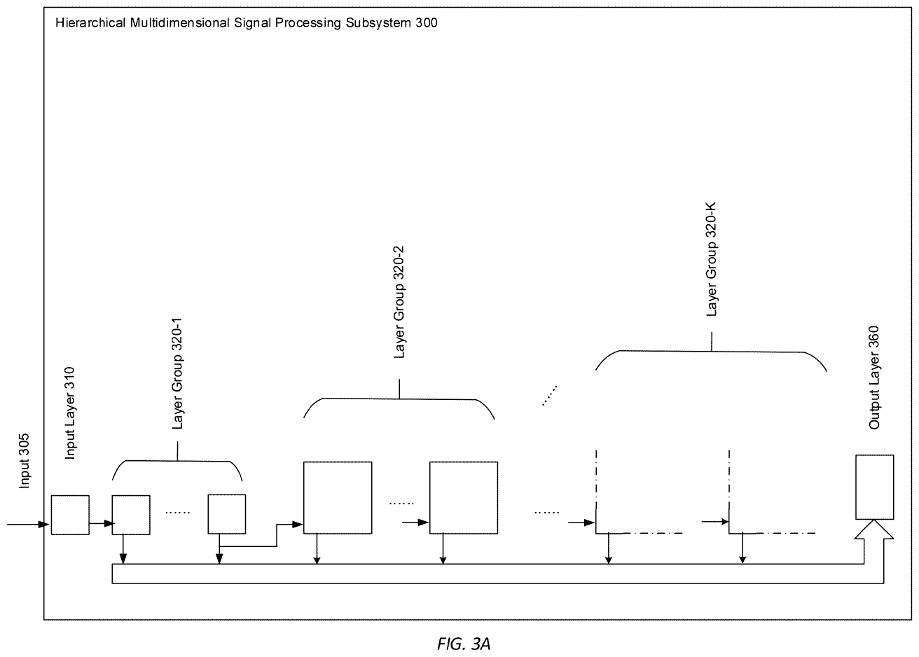

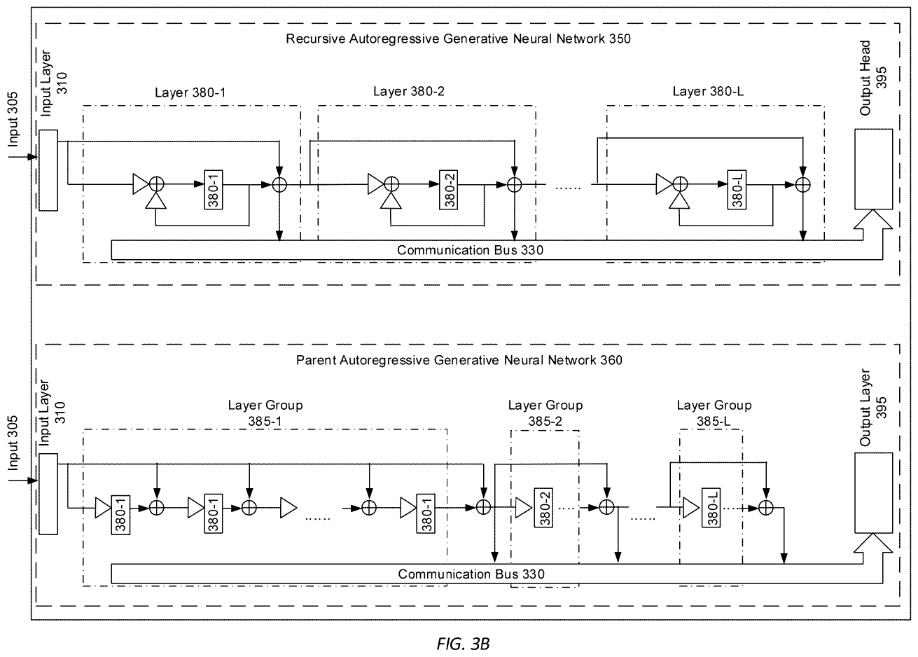

An example of the second aspect can be realized in a hierarchical multidimensional signal processing subsystem 300 as illustrated in FIG. 3A, the subsystem 300 being configured to process a multidimensional signal of values 305, and comprising: an input layer 310 configured to receive the multidimensional signal of values 305 and to generate a corresponding multidimensional signal of embeddings from the values, wherein in some implementations the input layer 310 may include or be implemented using an embedding and custom embedding subsystem 200 as described with reference to FIG. 2; a plurality of processing layer groups 320-1, 320-2, . . . , 320-K arranged from left to right, each processing layer group 320-k comprising multiple processing layers (not all shown) and being configured to receive embeddings or contextualized embeddings from a preceding layer group and to generate updated contextualized embeddings for a position based on embeddings or contextualized embeddings at positions within a context window associated with that group, wherein the context window associated with a processing layer group 320-k for higher k is greater than the context window associated with a processing layer group 320-j for lower j, and wherein a final processing layer group 320-K has a context window that effectively extends across all positions of the multidimensional signal; a communication bus 330 illustrated as extending in a left-to-right direction and configured to receive representations from the input layer 310 and from each of the processing layer groups 320-1, 320-2, . . . , 320-K, such that the input layer 310 and each processing layer group 320-k provide their respective embeddings or contextualized embeddings to the communication bus 330 while continuing to pass embeddings or contextualized embeddings forward to a next processing layer group; and an output layer 340 coupled to the communication bus 330 and configured to obtain one or more representations from the communication bus 330 and to generate outputs, such as predicted next values, class labels, similarity scores, alignment scores, or other scores, for example for use by prediction and scoring module(s) 150 of FIG. 1.

An example of the second aspect relates to an autoregressive generative neural network for predicting a new value in a multidimensional signal of values, comprising: an input layer configured to receive a multidimensional signal of values and generate a multidimensional signal of embeddings; multiple processing layers wherein each processing layer may be configured to receive at each of the positions the corresponding output from a previous processing layer at each of the corresponding positions and wherein the processing layers may be organized into a hierarchy of layer groups; each layer group has a multidimensional context window wherein the lower layer groups may have a smaller context window than higher layer groups and wherein the final layer group may have an infinite context window; each processing layer configured to generate contextual representation at a position from received representations at positions within the context window of the position and wherein each processing layer in the final layer group may generate contextual representation at a position from received representations at all positions in the context window; each processing layer in the final layer group comprising a self-attention module wherein the attention scores may be independent of the positions of key and query vectors; an output layer configured to generate the output of the autoregressive generative neural network wherein the input to the output layer may be a concatenation of the outputs of the final processing layer in each of the layer groups.

Other examples of autoregressive generative neural network may each optionally include one or more of the following features. The context window of a position may not include that position (i.e., the context window excludes the current position so that only strictly preceding positions are used). The contextual representation may be performed by a non-abelian merging unit. Each layer may comprise a self-attention module employing rotary positional encoding. The information from higher layer groups may be infused into lower groups via cross-attention and the input to the output layer may come from the highest layer in the lowest layer group. The output layer may be a vocabulary sized linear layer with SoftMax for when data values are discrete symbols, an unbounded or bounded linear regression head when data values are continuous values, a probabilistic parameter head when data is a heteroscedastic signal, or a codebook logit head when data values are latent codes. In some examples, positions may be processed in a fixed deterministic scan order (e.g., row-major or column-major); for commutative axes, any permutation of axes may yield an equivalent order and may not change model function. In other examples, positions in the context window may be deemed strictly preceding if and only if they are different from the current position, without reference to a global order. In further examples, a permutation-invariant autoregressive order may be used, such as shells grouped by slice-by-sum S=Σₘiₘ or slice-by-max Sₘₐₓ=maxₘiₘ, with ties broken by a fixed deterministic rule to preserve one-value-at-a-time decoding; alternatively, positions sharing a shell may be updated in parallel as a single slice when parallel per-slice prediction is desired.

An example of the second aspect described in this specification relates to a hierarchical sequence processing system that may be configured to receive an input sequence and generate an output, comprising: multiple processing layers wherein the processing layers may be organized into a hierarchy of layer groups; each processing layer may be configured to receive at each of the positions the corresponding output from a previous processing layer at each of the corresponding positions; the lowest processing layer in a higher-level group may be configured to receive as sequence of inputs the sequence of outputs from the highest processing layer in a preceding lower-level layer group; wherein each layer group may have a context length and the final layer group may have an infinite context length; each processing layer may be configured to generate contextual representation at a position from received representations at positions within the context length of the position and wherein each processing layer in the final layer group may generate contextual representation at a position from received representations at all preceding positions (optionally excluding the current position); each processing layer in the final layer group may comprise a self-attention module wherein the attention scores may be independent of the positions of key and query vectors

$$( i . e . {A}_{i , j} = \frac{{q}_{i}^{T} {k}_{j}}{\sqrt{d}} and {V}_{i} = {\sum }_{j = i}^{∞} {α}_{i , j} {v}_{j} ) ;$$

an output layer may be configured to generate the output of the hierarchical sequence processing system wherein the input to the output layer may be a concatenation of the outputs of the final processing layer in each of the layer groups.

Other examples of hierarchical sequence processing system can each optionally include one or more of the following features. The contextual representation may be performed by a non-abelian merging unit. Each layer may comprise a self-attention module employing rotary positional encoding. The higher layer groups may have a longer context window than the lower layer groups. The information from higher layer groups may be infused into lower groups via cross-attention and the input to the output layer may come from the highest layer in the lowest layer group. The output layer may be a vocabulary-sized linear layer with SoftMax for when data values are discrete symbols, an unbounded or bounded linear regression head when data values are continuous values, a probabilistic parameter head when data is a heteroscedastic signal, or a codebook-logit head when data values are latent codes.

Other examples of the hierarchical sequence processing system may have the following features. The lowest processing layer in a higher-level group may be configured to receive as sequence of inputs the sequence of outputs from the highest processing layer in a preceding lower-level layer group by filtering and downsampling the sequence of outputs. The filtering and downsampling may be performed by a non-abelian merging unit. Each layer may comprise a self-attention module employing rotary positional encoding. The input sequence may be a sequence of text tokens. The sequence of tokens may be filtered and downsampled to a sequence of words, then to a sequence of sentences, and then to sequence of paragraphs. The information from higher layer groups may be infused into lower groups via cross-attention and the input to the output layer may come from the highest layer in the lowest layer group. The output layer may be a vocabulary-sized linear layer with SoftMax for when data values are discrete symbols, an unbounded or bounded linear regression head when data values are continuous values, a probabilistic parameter head when data is a heteroscedastic signal, or a codebook-logit head when data values are latent codes.

The hierarchical sequence processing system may be a text processing system comprising a knowledge base, wherein the knowledge base may be a collection of sentences, and the context in lower layer groups may be limited to the input sequence, whereas the context in the final layer group may include the entire history of the input sequence and also the entire knowledge base with no limit on the context length. The knowledge base may be a knowledge graph of data triples. The system may further comprise a vector database that stores the key and value vectors corresponding to each of the positions in each of the sentences in the knowledge base for each of the processing layers in the final layer group, wherein the key and value vectors may be obtained by pre-processing the knowledge base using the hierarchical text processing system. The self-attention module may query the vector database and retrieve the most relevant value vectors. The sentences in the knowledge base may be derived from a knowledge graph of data triples.

### Third Aspect

A third aspect in this specification relates to a recursive transformer architecture that predicts not only the next data value, but also the contextual correction embedding that modifies the base embedding of the predicted data value giving the contextualized embedding of the data value which can then be used in the next prediction cycle.

An example of the third aspect described in this specification can be realized in a recursive autoregressive generative neural network for predicting the next value in a sequence of values, comprising: an input layer, a plurality of processing layers, an output head, and a storage device; wherein the input layer is configured to receive a sequence of values and generate a sequence of embeddings; and wherein the plurality of processing layers are arranged in a stacked configuration, and wherein each processing layer is configured to: at each iteration i of position i in the sequence, wherein i≥0 and wherein the history of position i consists of positions {0, . . . , i−1}, 1) for each of the positions {0, . . . , i}, a) receive embeddings from a preceding layer, wherein the preceding layer for the first processing layer is the input layer, b) modify the received embedding at the position, using the contextual correction embedding for the position retrieved from the storage device, to obtain the updated contextualized embedding at the position, and wherein the updated contextualized embedding is the same as the received embedding at position 0 (since its history is empty), and c) output the updated contextualized embedding at the position (which forms the received embedding for the next layer), 2) a) compute the contextual correction embedding for the next position i+1 from the updated contextualized embeddings at positions {0, . . . , i}, and b) output the contextual correction embedding for the next position i+1; wherein the output head is configured to predict, at each position i in the sequence, the value at position i+1 in the sequence, wherein the prediction may be based in part on the updated contextual embedding at position i from the final processing layer; and wherein the storage device is configured to store the contextual correction embeddings generated at each layer at iterations {0, . . . , i} for further processing at iteration i+1.

The previous recursive autoregressive generative neural network wherein the output head is configured to predict the value at position i. 1 based in part on the contextualized embedding at position i and contextual correction embedding computed for position i+1.

The previous recursive autoregressive generative neural network wherein the contextual correction embedding is of the same dimensions as the received embedding and modifying the received embedding consists of adding the contextual correction embedding to the received embedding.

The previous recursive autoregressive generative neural network wherein the network consists of a single processing layer that receives a base embedding from the input layer, computes and outputs an updated contextualized embedding, and produces the contextual correction embedding for the next position, with the output head predicting the next value from the updated contextualized embedding.

The previous recursive autoregressive generative network wherein the updated contextualized embeddings are quantized to snap the embeddings to a finite set of contextualized embeddings.

Another example of the third aspect described in this specification relates to a parent autoregressive generative neural network for determining the parameters of the previous recursive autoregressive generative neural network, wherein the parent autoregressive neural network shares parameters with the recursive autoregressive generative neural network, wherein the parent network comprises of an input layer, a plurality of processing layer groups, and an output head; wherein the input layer and the output head are identical to those in the recursive autoregressive generative neural network, and wherein there exists a one-to-one correspondence between a processing layer group in the parent network and a processing layer in the recursive network and the stacking order of the processing layer groups in the parent network is the same as the stacking order of the processing layers in the recursive network. Each layer group consists of multiple layers arranged in a stacked configuration, wherein layers in a layer group are jointly parametrized with each other and share parameters with the corresponding layer in the recursive network, and wherein each layer receives the output of the previous layer and the first layer of a layer group receives the output of the final layer of the earlier layer group. Each processing layer in a layer group is configured to: at each position i in the sequence, wherein i≥0, a) receive current group embeddings from a preceding layer in the same layer group, b) receive previous group embeddings from a preceding layer group, wherein the current group embeddings are the same as previous group embeddings for the first layer in a layer group, c) compute the contextual correction embedding for the next position i+1 from the received current group embeddings at positions {0, . . . , i}, d) modify the received previous group embedding at the position, using the contextual correction embedding for the position (computed at position i−1), to obtain the updated contextualized embedding at the position, and wherein the updated contextualized embedding is the same as the received previous group embedding at position 0 (since its history is empty), and e) output the updated contextualized embedding at the position (which forms the received current group embedding for the next layer in the same group), wherein the output of the final layer of a layer group forms the previous group embedding for the next layer group; wherein the output head is configured to predict, at each position i in the sequence, the value at position i+1 in the sequence, wherein the prediction may be based in part on the updated contextualized embedding at position i from the final processing layer in the final layer group.

Another example of the third aspect can be realized in a recursive autoregressive generative neural network 350 and a corresponding parent autoregressive generative neural network 360 as illustrated in FIG. 3B. The recursive autoregressive generative neural network 350 and the parent autoregressive generative neural network 360 each comprise an input layer 310 configured to receive a sequence or multidimensional signal of values and to generate a corresponding sequence or multidimensional signal of embeddings, wherein in some implementations the input layer 310 may be the same as the input layer 310 described with reference to FIG. 3A and may include or be implemented using the embedding and custom embedding subsystem 200 of FIG. 2. The recursive autoregressive generative neural network 350 further comprises a plurality of processing layers 380-1, 380-2, . . . , 380-L arranged in a stacked configuration, a plurality of delay connections indicated in FIG. 3B by arrows having hollow or unfilled triangular arrowheads, a communication bus 330, and an output head 395 configured, at each iteration, to generate a predicted next value for the sequence or multidimensional signal. In FIG. 3B, dash-dot rectangles are used to group sets of elements that together implement a logical processing layer; for example, a dash-dot rectangle labeled “layer 380-1” encloses a neural network layer labeled 380-1 together with associated delay and combination elements, and a corresponding dash-dot rectangle within processing layer group 385-1 in the parent network 360 encloses a neural network layer also labeled 380-1 to indicate that it is the same neural network, with shared parameters, as the processing layer 380-1 in the recursive network 350. At each iteration and for each position i, each processing layer 380- [symbol] in the recursive network 350 is configured to receive a base embedding or contextualized embedding for position i from a preceding layer, to receive via the delay connections embeddings or contextualized embeddings corresponding to past positions {0, . . . , i−1} but not the current position i, to compute from the past positions a contextual correction embedding for position i, to combine the contextual correction embedding with the base embedding (for example by addition) to obtain an updated contextualized embedding for position i, to provide the updated contextualized embedding to a next processing layer 380-( [symbol] +1), and to provide one or more representations derived from that layer to the communication bus 330. The delay arrows with hollow triangular arrowheads are used schematically to indicate that the corresponding computations depend only on past positions and exclude the current position, and the delay connections may be implemented using one or more storage elements, buffers, or equivalent mechanisms. The communication bus 330 is illustrated schematically to represent communication of representations from the input layer 310 and from each processing layer 380- [symbol] to the output head 395, which is configured to obtain a plurality of representations from communication bus 330 and, at each iteration, to generate a predicted next value based at least in part on those representations; the predicted next value is appended to or otherwise incorporated into the sequence or multidimensional signal provided to input layer 310 at a subsequent iteration so that the recursive network 350 operates autoregressively across iterations. The parent autoregressive generative neural network 360 shares parameters with the recursive network 350 and comprises the input layer 310, a plurality of processing layer groups 385-1, 385-2, . . . , 385-L arranged in a stacked configuration, a communication bus 330, and the output head 395. There exists a one-to-one correspondence between each processing layer group 385- [symbol] in the parent network 360 and a processing layer 380- [symbol] in the recursive network 350, each processing layer group 385- [symbol] comprises multiple layers that are jointly parameterized with one another and share parameters with the corresponding processing layer 380- [symbol] , and a stacking order of the processing layer groups 385- [symbol] is the same as a stacking order of the processing layers 380- [symbol] such that each processing layer group 385- [symbol] realizes behavior of the corresponding processing layer 380- [symbol] unrolled for multiple applications. In FIG. 3B, internal detail of this unrolled structure is shown for processing layer group 385-1, and other processing layer groups 385- [symbol] are similar and are not shown in comparable detail. The communication bus 330 in the parent network 360 is configured to receive representations from the input layer 310 and from each processing layer group 385- [symbol] , and the output head 395 in the parent network 360 is configured to obtain a plurality of representations from communication bus 330 and to generate predicted next values based at least in part on representations provided by the processing layer groups 385- [symbol] ; thus, the number of inputs to output head 395 from the parent network 360 corresponds to the number of inputs from the recursive network 350, and the reuse of reference numerals 310 and 395 indicates that the input layer and output head may be shared or identical in structure and function across the recursive and parent networks.

Intuitively, each processing layer group in the parent network implements the behavior of the corresponding processing layer in the recursive network unrolled for as many iterations as there are layers in the group, with all layers in the group sharing parameters.

Another example of the third aspect relates to training the parent network that comprises collecting sequences of data values—whether discrete linguistic tokens, latent image codes, audio spectra, numerical telemetry, or other modality-specific representations. Training involves converting data values into embeddings via the input layer (e.g., token look-ups, linear projections, convolutional stems, or vector-quantization encoders). The resulting embeddings are propagated through one or more processing layers that each might implement multi-head self-attention, feed-forward processing, and normalization. Upon exiting the final processing layer, the embeddings are projected through an output head (e.g. a vocabulary-sized linear layer with SoftMax for when data values are discrete symbols, an unbounded or bounded linear regression head when data values are continuous values, a probabilistic parameter head when data is a heteroscedastic signal, or a codebook-logit head when data values are latent codes). A loss function appropriate to the prediction of the output head—e.g., cross-entropy, mean-squared error, Gaussian negative log-likelihood, mixture density likelihood, or perceptual similarity—is evaluated against reference targets (obtained from the training data), and all learnable parameters are updated via back-propagation in conjunction with any suitable optimization algorithm (for example, stochastic gradient descent, Adam, or variants thereof) executed on parallel processing hardware. Optional curriculum scheduling, mixed-precision arithmetic, gradient accumulation, and distributed data-parallel or pipeline-parallel execution may be employed as needed to accommodate variable sequence lengths, high-resolution inputs, or model sizes, with individual training systems freely omitting, reordering, or substituting these techniques while still falling within the scope of the present description. In some cases, loss function might also include mean-squared error terms between the input and the output of the final processing layer in each of the layer groups.

Another example of the third aspect relates to a multidimensional recursive autoregressive generative neural network for predicting the value at a target position in a multidimensional signal of values, comprising: an input layer configured to receive a multidimensional signal of values and generate a multidimensional signal of base embeddings; a plurality of processing layers arranged in a stacked configuration, each processing layer configured to receive embeddings at each of the positions from a preceding layer, wherein the preceding layer for the first processing layer is the input layer; at a target position represented by coordinates (i₀, i₁, . . . , iₙ₋₁), the network is configured to compute, for each processing layer [symbol] , a layer-specific contextual correction embedding for the target position from the set of contextualized embeddings at all positions in the context window of the target position other than the target position itself, wherein each contextualized embedding in the window is obtained by adding a contextual correction embedding to its corresponding input or base embedding at that (non-target) position; the network is further configured to output, for the target position, (i) the predicted value at the target position and (ii) the set of layer-specific contextual correction embeddings (one per processing layer), and to store the layer-specific contextual correction embeddings for use at a subsequent iteration. An output head, possibly configured per dimension, is configured to generate the prediction for the value at the target position based at least in part on the contextualized embeddings at all positions in the target's context window from the final processing layer and the final-layer contextual correction embedding at the target position. In some examples, the order in which target positions are visited is permutation-invariant and may be defined by slices such as slice-by-sum S=Σₘiₘ or slice-by-max Sₘₐₓ=maxₘiₘ, with ties within a slice broken deterministically to preserve one-value-at-a-time decoding.

In one example of the multidimensional recursive autoregressive generative neural network, the context window at a target position (i₀, i₁, . . . , iₙ₋₁) is determined solely by the preceding values along a selected axis l, i.e., by the set of positions Wᵢ(i₀, . . . , iₙ₋₁)={(i₀, . . . , jₗ, . . . , iₙ₋₁)|0≤jₗ<iₗ}, which includes all strictly preceding coordinates along axis l while holding the other coordinates fixed.

In one example of the multidimensional recursive autoregressive generative neural network the value at position (i₀, i₁, . . . , iₙ₋₁) can be predicted along any one of the l dimensions from the updated contextualized embeddings computed along the l^{th} dimension (0≤l≤n−1) at each of the positions (i₀, . . . , iₗ₋₁, jₗ, jₗ₊₁, . . . , iₙ₋₁) along the l^{th} dimension where 0≤jₗ<iₗ.

In one example of the multidimensional recursive autoregressive neural network, the network sequentially generates values within a 3×3 image in the following order wherein the coordinates on the left side of the arrow show the positions used to predict the value of the pixel at the coordinates on the right side of the arrow
→(0, 0)
(0, 0)→(0, 1)
(0, 0)→(1, 0)
(0, 1)→(1, 1) or (1, 0)→(1, 1)
(0, 0), (1, 0)→(2, 0)
(0, 1), (1, 1)→(2, 1) or (2, 0)→(2, 1)
(0, 0), (0, 1)→(0, 2)
(1, 0), (1, 1)→(1, 2) or (0, 2)→(1, 2)
(2, 0), (2, 1)→(2, 2) or (0, 2), (1, 2)→(2, 2).

### Additional Examples

In some examples, the systems and methods described in this specification are applied in vector database systems that associate custom embeddings with data values drawn from multisets of data values and organize the custom embeddings into hierarchical vector indexes using the similarity metric associated with the custom non-abelian mathematical set. In such examples, a query receiver may receive a query custom embedding representing a query item (for example, a text span, an image, a DNA subsequence, an audio segment, or a document), a similarity calculator may compute similarity scores between the query custom embedding and stored custom embeddings, a ranking module may rank the stored embeddings based on the similarity scores, and a retrieval generator may return a subset of embedding-value pairs as a retrieval result. These vector database systems can support retrieval for downstream tasks including question answering, recommendation, retrieval-augmented generation with knowledge bases, and other information-retrieval applications where the custom embeddings and similarity metric reflect richer relationships than conventional abelian embeddings.

In some examples, the systems and methods described in this specification are applied to biological and molecular sequence alignment. For example, string processing and sequence alignment systems may map characters in DNA or RNA sequences (e.g., nucleotides) or in protein sequences (e.g., amino acids) to custom embeddings, use these custom embeddings to compute context-dependent similarity matrices for pairs of sequences, and invoke dynamic programming algorithms such as Smith-Waterman or Needleman-Wunsch on the learned similarity matrices in place of conventional substitution matrices. Other examples may generate sequence-level custom embeddings using non-abelian merging operations and use the resulting embeddings and associated similarity metrics to perform global or local alignment, clustering, or multiple sequence alignment based on 1-representations, m-representations, or m-left-right-representations of sequences. Such systems may be used for applications including DNA alignment, molecular sequence alignment, phylogenetic analysis, and clustering or retrieval of related biological sequences.

In further examples relating to sequence alignment, the systems and methods described herein can use m-representations or related custom embeddings of sequences to approximate alignment scores without performing full dynamic-programming alignment, which can substantially reduce computational cost when screening large databases of sequences. For example, each biological or molecular sequence can be mapped to one or more m-representations or m-left-right-representations in a custom non-abelian mathematical set, and a similarity metric associated with the custom non-abelian set can be used to compute approximate alignment scores or distances between pairs of sequences directly from their m-representations. Such approximate scores can be used to rank or filter candidate sequences prior to applying an exact dynamic-programming algorithm, or may be used directly in applications where approximate similarity is sufficient, thereby enabling much faster approximate alignment or retrieval over large collections of DNA, RNA, or protein sequences than methods that rely exclusively on dynamic programming.

In some examples, the systems and methods described in this specification are applied to audio and speech processing, including audio command recognition and speech recognition. An audio processing system may transform an audio signal, comprising sequences of audio segments or frames, into custom embeddings using an embedding layer and non-abelian merging operations that depend on both the individual embeddings and their order, and a similarity metric computation unit may generate similarity measures between embeddings of audio segments or utterances. A command recognition system may use a classifier that consumes a custom embedding of an input utterance to produce scores over a finite set of commands, and speech-recognition systems may combine such embeddings with sequence transduction architectures described herein to predict symbol sequences (such as phonemes, characters, or wordpieces) from audio signals. These audio and speech systems can be used as front-end components for downstream tasks such as audio command recognition, continuous speech recognition, and multimodal language models that accept spoken input.

In some examples, the systems and methods described in this specification are applied to text and language processing, including machine translation, large language models, and retrieval-augmented generation. Text processing systems may transform sequences of text tokens into custom embeddings, merge token-level embeddings into sentence- or document-level embeddings, and compute similarity measures between such embeddings for tasks including document retrieval, semantic search, question answering, and clustering. Autoregressive and transformer-based architectures described in the second and third aspects can be trained on large corpora of text, optionally combined with knowledge-graph triples treated as text or as structured relationships, to implement large language models that predict next tokens, fill in masked tokens, or generate responses conditioned on prompts. In retrieval-augmented generation (RAG) settings, custom embeddings and similarity metrics may be used to populate and query vector databases or knowledge bases, and retrieved embeddings and associated content may be supplied as additional context to hierarchical or recursive architectures to generate answers, translations, or summaries.

In other examples, the systems and methods described in this specification are applied to images, video, and other multidimensional signals, including image recognition and image generation. Image processing systems may transform images, or sequences of scaled or patch-based versions of images, into partially-ordered nested multisets of embeddings, and apply non-abelian merging operations and difference operations to produce custom embeddings that depend on both the individual embeddings and their spatial or temporal order. Similarity metrics between such embeddings may be used to compute similarity between images or video clips, cluster or retrieve similar visual content, or align multidimensional signals. In further examples, custom embeddings and non-abelian merging operations may be used as components of generative models for images or videos, for example by providing richer context representations to decoders or by defining non-abelian attention or aggregation layers inside diffusion or transformer-based image generation models.

In some examples, the first aspect provides an induction bias that more closely reflects the way composition operates in many real-world domains. By requiring custom embeddings to reside in custom non-abelian mathematical sets and by using merging operations that are associative but not commutative, the systems described herein can represent structures in which order and grouping both matter, such as sequences of linguistic tokens, DNA bases, amino acids, control commands, or image patches, without collapsing distinct compositions into the same abelian sum. This induction bias can enable learning algorithms to capture asymmetric relationships, directional dependencies, and order-sensitive patterns that are difficult to represent with purely commutative embedding aggregations, and can thereby improve performance or robustness in applications including vector database retrieval, DNA and molecular sequence alignment, audio command recognition, speech recognition, language processing, image recognition, and image retrieval, as described elsewhere in this specification.

In some examples, the second aspect provides a hierarchical multidimensional signal processing architecture that enables effectively infinite context while mitigating “recall in the middle” effects observed in conventional transformer architectures. By organizing processing layers into layer groups with progressively larger context windows and by allowing a final layer group to have a context window that effectively spans all positions of a sequence or multidimensional signal, the architecture can attend to and integrate information from any position, including positions in the middle of long sequences, without requiring all layers to operate at the maximum context. In addition, the architecture can separate language modeling from factual or relational knowledge by representing facts or relationships in one or more knowledge bases or vector databases and representing language sequences in the hierarchical architecture, optionally training by treating language as knowledge graphs and learning mappings between text, graph-structured data, and custom embeddings. This separation allows factual knowledge to be updated or extended independently of the language model parameters and can facilitate retrieval-augmented generation, question answering, and translation in which a hierarchical subsystem 300 is used primarily for language modeling while factual content is obtained from external knowledge bases or vector databases populated with custom embeddings as described herein.

In some examples, the third aspect provides a recursive and parent autoregressive architecture that reduces or eliminates the need to apply many additional contextualization layers after each prediction, as is typically done in conventional autoregressive models. In the recursive autoregressive generative neural network 350, each processing layer is configured to compute a contextual correction embedding for a position from past positions only and to combine the correction with a base embedding to produce an updated contextualized embedding, and the output head 395 is configured to generate a predicted next value that is appended back into the input sequence or multidimensional signal. Rather than predicting a value and then passing the extended sequence through an entire stack of contextualization layers, the architecture computes and applies the contextual correction directly at each iteration, and the parent autoregressive generative neural network 360 realizes multiple such correction steps by unrolling the underlying layer with shared parameters. This can reduce the number of full forward passes or distinct layers required per predicted value, and can thereby reduce computational cost, latency, or memory usage in autoregressive generation settings, including large language models, audio and speech models, and multidimensional signal models that predict future frames, patches, or measurements.

In some examples, a vector database system stores custom embeddings for basic linguistic units, such as characters, subword units, or tokens, and word-level or sentence-level custom embeddings are obtained on demand by composing the stored embeddings for constituent units. For example, a tokenization module may map an input word or sentence to a sequence of tokens, a query interface may retrieve the corresponding custom embeddings of the tokens from a vector database or knowledge base, and a merging module may apply one or more non-abelian merging operations, as described for the first aspect, to generate a custom embedding for the word or sentence from the multiset or sequence of token embeddings. In such examples, explicit custom embeddings for all words or sentences in a vocabulary need not be stored in the database, and changes to token-level custom embeddings propagate automatically to composed word-level or sentence-level custom embeddings. The resulting on-demand word or sentence embeddings can be used for tasks including similarity search, retrieval, clustering, translation, question answering, or retrieval-augmented generation, and may be combined with the sequence-processing architectures described herein.

In some examples, the same token-level storage and on-demand composition mechanism is used in retrieval-augmented generation settings. For example, a retrieval system may store custom embeddings for tokens or short phrases from documents in a vector database or knowledge base, and, at query time, a query sentence can be mapped to a sequence of tokens, the corresponding token-level custom embeddings can be retrieved from the vector database, and one or more non-abelian merging operations as described herein can be applied to compose a custom embedding for the query sentence from the multiset or sequence of token embeddings. The composed sentence-level custom embedding can then be used as a query embedding for similarity search against custom embeddings associated with stored documents, passages, or knowledge-graph fragments, and retrieved content can be provided as additional context to a language model, hierarchical multidimensional signal processing architecture, or recursive and parent architectures described herein to generate answers, translations, or other responses. In such examples, updates to token-level custom embeddings or to the contents of the knowledge base automatically affect both retrieval and the composed query embeddings, and the use of non-abelian merging operations allows the composed sentence embeddings to reflect both the identities of the constituent tokens and their order and grouping.

In some examples, the systems and methods described in this specification are applied to stitching or concatenating multidimensional signals along a chosen axis while preserving information about the relative positions of the constituent signals. For example, a multidimensional signal merging unit may receive a first custom numeric representation of a first multidimensional input signal and a second custom numeric representation of a second multidimensional input signal, wherein both representations comprise a vector component and a plurality of matrix components that commute with one another and are associated with coordinate axes in a bijective manner. A merging module may generate a custom numeric representation of a concatenated multidimensional signal along a concatenation axis by computing a product of the corresponding matrix components associated with the concatenation axis, preserving the matrix components associated with non-concatenation axes, and computing a vector component that is equal to the vector component of the first custom numeric representation plus a transformed vector component derived from the second custom numeric representation. Such stitching operations can be used to represent concatenated image tiles, concatenated temporal segments of audio or telemetry, or concatenated segments of DNA or molecular sequences as a single custom embedding while retaining information about segment order and alignment along the concatenation axis.

In some examples, alignment systems described herein perform multi-stage alignment in which magnitude-vector-based rough alignment scores are used to filter or prioritize candidate pairs before computing full alignment scores. For example, a similarity unit may receive a first and second custom numeric representation, each with a vector component, compute corresponding magnitude vectors whose elements are Euclidean norms of consecutive non-overlapping pairs of elements in the vector components, and compute a rough alignment score as a similarity measure between the magnitude vectors. Such rough alignment scores can be used to preselect or rank candidate pairs of multidimensional signals-including biological or molecular sequences, images, audio segments, or telemetry windows-before invoking more expensive alignment computations that operate directly on the full vector components or on m-representations. This can reduce the number of full alignment evaluations required per query and can substantially accelerate approximate alignment or retrieval over large collections of signals.

In some examples, the systems and methods described in this specification are applied in multidimensional transduction systems that use self-attention to compute context-aware representations for positions in a multidimensional signal using orthogonal matrices associated with coordinate axes. For example, a multidimensional transduction subsystem may receive a multidimensional signal of input representations, compute query, key, and value vectors for each position, and compute attention scores between a target position and other positions in the multidimensional signal. An aggregation module may then generate a context-aware representation for the target position as a vector sum of transformed value vectors, where each value vector is multiplied by an exponentiated orthogonal matrix that depends on the relative position of the value vector with respect to the target position along each coordinate axis, and where orthogonal matrices are associated with coordinate axes in a bijective manner and commute with one another. Such multidimensional attention mechanisms can be used for tasks including image or video segmentation, scene understanding, or multidimensional sensor fusion, where the relative positions of values along multiple axes contribute to the context and the orthogonal matrices encode this relative positional information in a compact and differentiable manner.

In some examples, the systems and methods described in this specification are applied to telemetry data analysis and data from arrays of physical sensors. In such examples, data from one or more sensors over time can be treated as sequences or multidimensional signals of data values, and data from an array of sensors can be treated as a partially ordered nested multiset of data values, with one dimension for sensor identity and one or more dimensions for time or other coordinates. Custom embeddings and non-abelian merging operations may be used to generate representations for individual sensors, groups of sensors, or time windows, and similarity metrics between such embeddings may be used to detect anomalies, identify operating modes, cluster similar segments of telemetry, or retrieve historical episodes similar to a current condition. Sequence and multidimensional transduction architectures described herein may be trained on such telemetry signals to predict future measurements, detect faults, or generate control-relevant summaries, and the use of non-abelian merging can enable the representations to capture both the identities of sensors and the ordering or structure of their readings.

In some examples, an example of the first aspect is realized in sequence transduction systems and multidimensional transduction systems that transform input sequences or multidimensional signals into output sequences or multidimensional signals using custom embeddings and non-abelian summation. For example, a sequence transduction system may comprise one or more sequence transduction subsystems, each configured to receive as input the outputs of a preceding subsystem and to generate non-abelian context vectors for an input sequence using self-attention with orthogonal matrices independent of the input values, and a multidimensional transduction system may similarly compute non-abelian context vectors over neighborhoods in a multidimensional signal. The resulting context vectors or merged custom embeddings can then be supplied to an output layer to predict output sequences, segmentations, or labels for the input signals. Such sequence and multidimensional transduction systems can be used for tasks including sequence-to-sequence prediction, segmentation, tagging, or structured prediction for text, audio, images, video, and telemetry signals, and the non-abelian context computation allows the systems to encode richer ordering and grouping information than conventional abelian context aggregation.

In some examples, embedding function determination methods described in this specification are realized in unsupervised training methods that operate on multisets or partially ordered multisets of data values. In such examples, a training method may obtain a set of training data comprising multisets of data values drawn from a predetermined source set, train an embedding function that maps data values to custom embeddings in a custom non-abelian mathematical set, and obtain trained values of the embedding function parameters. Training may include selecting a training sample from the set of multisets, selecting a set of positions in the training sample, processing the data values at the selected positions in accordance with the current embedding function parameters to generate a set of custom embeddings, computing a score that reflects the likelihood that the data values will be found in their respective positions in the multiset, and adjusting the embedding function parameters to increase the score. Training may further include sampling a set of data values from a preconfigured distribution over the source set of all possible data values, processing the sampled data values to generate a set of custom embeddings, computing a score for the sampled values, and adjusting the embedding function parameters to decrease that score. In this way, the embedding function learns to assign higher scores to configurations that resemble observed multisets in the training data and lower scores to configurations unlikely to occur in any training multiset.

In some examples, unsupervised training methods operate on sequences of data values, such as sequences of discrete linguistic tokens, latent image codes, audio spectra, numerical telemetry, or other modality-specific representations. Such methods may convert data values into embeddings or custom embeddings via an input layer—for example, via token lookups, linear projections, convolutional stems, or vector-quantization encoders—and then propagate the resulting embeddings through one or more processing layers that implement multi-head self-attention, feedforward processing, and normalization, as described for the second and third aspects. Upon exiting the final processing layer, the embeddings or contextualized embeddings are projected through an output head, which may be a vocabulary-sized linear layer with SoftMax when data values are discrete symbols, an unbounded or bounded linear regression head when data values are continuous, a probabilistic parameter head when data is heteroscedastic, or a codebook-logit head when data values are latent codes. A loss function appropriate to the prediction of the output head-such as cross-entropy, mean-squared error, Gaussian negative log-likelihood, mixture density likelihood, or perceptual similarity—is evaluated against reference targets obtained from the training data, and all learnable parameters are updated via backpropagation with any suitable optimization algorithm (for example, stochastic gradient descent, Adam, or variants thereof). Such training methods can be applied to sequences or multidimensional signals in text, audio, image, telemetry, and other domains.

In some examples, unsupervised training methods include knowledge-graph-based techniques in which the training data comprises a knowledge graph consisting of data triples, each triple comprising a head data value, a tail data value, and a relationship selected from a predetermined set of relationships. An embedding function may receive data values and relationship values and map them to custom embeddings in a common custom non-abelian mathematical set, and training may comprise processing each data triple to generate a head embedding, a tail embedding, and a relationship embedding; merging the head embedding and the relationship embedding to obtain a merged embedding; computing a score from the merged embedding and the tail embedding that represents the likelihood that the head and tail data values are related via the relationship; and adjusting the embedding function parameters to increase the score for triples drawn from the knowledge graph and to decrease the score for triples sampled from a background distribution over possible triples. In some examples, knowledge-graph training includes joint training on both knowledge graphs and multisets or partially ordered multisets of data values, optionally using distance metrics between merged embeddings and tail embeddings, and the knowledge graph itself may be derived from multisets of data values (for example, where relationships indicate positional relationships between pairs of data values) or from existing embeddings (for example, where relationships indicate similarity between embeddings).

In other examples, embedding function determination methods can be realized in co-occurrence-matrix-based training techniques. In such examples, the set of training data comprises a co-occurrence matrix of data values derived from partially ordered multisets or sequences of data values, wherein the data values are elements of a predetermined finite set. An embedding function receives a data value and maps the data value to a custom embedding in a custom non-abelian mathematical set, and training may comprise selecting a row from the co-occurrence matrix and adjusting the embedding function parameters to decrease a weighted sum of squared distances between custom embeddings of data values that co-occur more frequently and to increase the weighted sum of squared distances between custom embeddings of data values that co-occur less frequently. Such training schemes enable learning custom embeddings that reflect co-occurrence structure in the training data and can be used as an alternative or complement to sequence-based or knowledge-graph-based training.

In some examples, the systems and methods described in this specification are applied to training large language models using a multi-phase training pipeline. For example, a corpus of textual data comprising sequences of words or tokens may be used for an initial training (pre-training) phase, in which a sequence-to-sequence transducer architecture processes input tokens and predicts subsequent tokens, thereby learning to model the conditional distribution of next tokens given preceding context. The resulting language model may then be refined through supervised training, wherein a curated set of prompt-response pairs is obtained and model parameters are optimized to produce high-quality, contextually appropriate responses aligned with human-provided examples. Subsequently, one or more objective functions may be applied within a reinforcement-learning-style framework, wherein the model receives reward signals derived from sources such as direct human feedback, automated verification systems, or domain-specific metrics, and each training iteration updates the model parameters to maximize expected reward across a broad range of tasks, including complex problem-solving and conversational assistance. In such examples, custom embeddings and non-abelian merging operations described in the first aspect, together with hierarchical and recursive architectures described in the second and third aspects, can be employed as components of the language model to provide richer context representations and improved control over inductive biases.

In some examples, embedding function determination methods and sequence or multidimensional signal processing architectures described in this specification are trained using supervised training methods. In such examples, the training data includes pairs or tuples comprising an input multiset, sequence, or multidimensional signal of data values and one or more target outputs, such as class labels, real-valued targets, alignment targets, or structured outputs. An embedding function and associated modules (for example, an input layer 310 or an embedding and custom embedding subsystem 200) convert the input data values into embeddings or custom embeddings in a custom non-abelian mathematical set, and one or more architectures described herein (for example, a hierarchical multidimensional signal processing a subsystem 300, a recursive autoregressive generative neural network 350, or a parent autoregressive generative neural network 360) process the embeddings or custom embeddings to generate contextualized embeddings. A prediction and scoring module 150 receives the contextualized embeddings and generates predicted outputs, and a supervised loss function-such as cross-entropy, mean-squared error, margin-based loss, or other task-appropriate losses—is evaluated based on differences between the predicted outputs and the target outputs for each labeled training example. Parameters of the embedding function, custom embedding modules, and processing architectures are then updated to minimize the supervised loss, thereby biasing the learned representations and architectures toward solving the labeled tasks, including supervised classification, regression, alignment, or structured prediction tasks over multisets, sequences, or multidimensional signals.

In other examples, supervised training methods are employed in a fine-tuning or multi-task setting. For example, a model comprising an embedding and custom embedding subsystem 200 together with one or more of the subsystems 300, 350, and 360 may first be trained using unsupervised methods on unlabeled multisets, sequences, or multidimensional signals, and then further trained using supervised loss functions on curated labeled datasets. The labeled datasets may include, without limitation, examples for DNA alignment or molecular sequence classification, audio command recognition, speech recognition transcripts, language-to-language translation pairs, document classification labels, question-answer pairs, image or video labels, or retrieval-augmented generation tasks in which correct responses are provided for prompts conditioned on retrieved content from a vector database or knowledge base. In such fine-tuning or multi-task settings, the supervised loss functions may be applied to outputs of prediction and scoring module(s) 150 at one or more positions in a sequence or multidimensional signal, and gradients may be propagated through the contextualized embeddings produced by subsystems 300, 350, or 360 and through the embedding function and custom embedding modules so that the entire system is adapted to the supervised tasks while retaining the inductive biases provided by the custom non-abelian embedding structures and hierarchical or recursive processing architectures.

In some implementations of the first aspect, each orthogonal matrix associated with a coordinate axis is a block-diagonal orthogonal matrix in a real vector space, having along its diagonal one or more 2×2 orthogonal blocks and, in some implementations, one or more 1×1 identity blocks. Because the 2×2 orthogonal blocks and any 1×1 identity blocks are arranged along the diagonal, the block-diagonal orthogonal matrices associated with different axes commute with one another, and powers of such block-diagonal orthogonal matrices can be computed efficiently. The block-diagonal structure enables the same orthogonal matrices to be used both to define linear-transformation components of composite custom embeddings and to support the definition of magnitude vectors or other derived representations.

In some examples of the first aspect, the vector component of a composite custom embedding is partitioned into consecutive non-overlapping blocks of two elements, each such two-element block corresponding to a 2×2 block of the associated block-diagonal orthogonal matrices, and a magnitude vector is defined whose elements are norms (for example, Euclidean norms) of the respective two-element blocks. The resulting magnitude vector provides a compact representation that is invariant or approximately invariant to certain transformations (such as shifts along one or more axes) while retaining useful information about the structure of the underlying multidimensional signal, and can be used for similarity computation, retrieval, or as an input to downstream prediction and scoring modules.

In some examples, the first aspect provides an embedding scheme that combines non-commutative but associative composition with compatibility with transformer-style architectures. In such examples, each custom embedding resides in a custom non-abelian mathematical set and can be represented, for example, as a pair or tuple comprising a vector component and one or more linear-transformation components. Non-abelian merging operations on custom embeddings are defined so that the linear-transformation components capture order-sensitive and grouping-sensitive structure and the merging operation is associative but not commutative, thereby providing a useful induction bias for sequences, multisets, and multidimensional signals in which the order of composition matters. At the same time, the transformer architecture can remain largely unchanged by using only the vector component of each custom embedding for attention-score computation, feedforward processing, and prediction in output heads, while the linear-transformation components are propagated and updated internally as part of the custom embedding. In this way, existing transformer implementations can be extended to support non-abelian composition by modifying how embeddings are updated and merged, without requiring changes to attention-score computation or output heads, and the non-abelian structure can provide richer contextual representations while preserving compatibility with standard transformer blocks.

In some examples of the first aspect, the systems and methods described in this specification are applied to one-dimensional signal processing, such as text processing, using affine-matrix-based custom embeddings. For example, an embedding function may map each token in a sequence to an affine transformation, such as a matrix in homogeneous coordinates with a linear part and a translation part, thereby representing the token as an affine operator that acts on a latent space. A sequence of tokens can then be represented by composing their corresponding affine transformations, so that the order in which tokens are composed affects the resulting transformation, and associativity of matrix multiplication ensures that different groupings of the same token sequence produce the same composite transformation. In such examples, the custom embedding for a token or sequence may be represented as an affine matrix together with a derived vector component, and prediction and scoring modules may use only the vector component for computing attention scores, similarity measures, or classification outputs, rather than operating on the full matrix. This can provide a richer internal representation than generic matrix embeddings, because the affine structure captures both linear and translational effects and supports non-commutative composition, while restricting scoring and prediction to the vector component simplifies interfaces to downstream models and avoids the complexity and instability that can arise from scoring directly over full matrix-valued embeddings.

In some examples of the first aspect, the linear-transformation components of custom embeddings are constrained to be orthogonal or orthogonal matrices, which can improve numerical stability and gradient behavior during training. For example, in vector-linear transformation or VLT/PMVLT-based custom embeddings, the linear-transformation components associated with coordinate axes or with non-abelian merging operations may be chosen from a family of orthogonal matrices that preserve Euclidean norms. Because orthogonal matrices do not expand or contract vector norms under multiplication, repeated application of such matrices within sequences of merging or context-computation steps does not cause systematic blow-up or die-down of the magnitudes of embedding vectors, and gradients propagated through the corresponding operations are less prone to exploding or vanishing. In some implementations, these orthogonal matrices may be parameterized and updated during training subject to orthogonality constraints, or may be derived from parameter vectors via orthogonalization procedures, and may be used both as components of custom embeddings and as positional or relational transformations inside hierarchical or recursive architectures. Constraining the linear-transformation components of custom embeddings to be orthogonal or orthogonal can thus provide a technical benefit by stabilizing gradients and improving training convergence in deep architectures that apply many successive non-abelian merging or attention operations.

In some examples of the first aspect, base matrices associated with one or more coordinate axes are chosen from a family of block-circulant matrices of a common size that commute with one another. In certain implementations, at least some of the block-circulant matrices are orthogonal or unitary, so that applying powers of the base matrices preserves norms of vectors in the vector space. Because block-circulant matrices of a given size share a common eigenbasis given by a discrete Fourier transform operator, the system can implement multiplication by a base matrix, or by an integer power of a base matrix, by applying a discrete Fourier transform to a vector component, scaling transform-domain coefficients by eigenvalues of the base matrix raised to a corresponding integer exponent, and applying an inverse discrete Fourier transform. In such examples, matrix-vector products involving the base matrices or their powers are performed using FFT and inverse FFT operations while the base matrices remain independent of the input data values and commute with one another as required.

In some examples of the first aspect, sequence analysis systems maintain numeric representations for biological, molecular, or other one-dimensional sequences in one or more databases and perform alignment operations using only the stored numeric representations. For example, a system may obtain first and second numeric representations corresponding to respective sequences from a vector database, construct one or more alignment transformations from stored base matrices and candidate offsets, apply the alignment transformations to the vector component of the first numeric representation, compute similarity scores with the vector component of the second numeric representation, and output an alignment result determined from the similarity scores, without retrieving the underlying sequences or per-position embedding vectors.

In some examples of the first aspect, a dimension of the vector space and sizes of the base matrices used to construct numeric representations are fixed for a given application, so that each numeric representation has the same size regardless of the number of input data values in the underlying signal or sequence. For example, sequences of different lengths, such as short DNA subsequences and longer genomic regions, can be represented as numeric embeddings having identical vector and matrix dimensions, enabling storage of heterogeneous sequences in a single vector database schema and allowing similarity computation, alignment, clustering, or retrieval procedures to operate directly on fixed-size records.

In some examples of the first aspect, streaming encoders maintain an evolving numeric representation for a prefix of a one-dimensional input signal or multidimensional input signal as new input data values arrive. At each update step, the encoder obtains a numeric representation for one or more newly received data values, merges the new numeric representation with a current numeric representation using associative merging operations described herein, and stores an updated numeric representation without recomputing matrix components or vector components associated with previously processed positions. Such streaming encoders can maintain compact state for telemetry streams, molecular sequences acquired over time, or continuously recorded audio, and the maintained numeric representation can be queried, transmitted, or used for downstream tasks without retaining the full history of input data values.

In some examples of the first aspect, systems maintain numeric representations for segments of longer signals, such as consecutive windows of a DNA sequence, fragments of a document, or tiles of an image, and compute numeric representations for concatenated or reordered signals solely by merging the segment-level numeric representations. For example, a genomic analysis system may compute numeric representations for multiple contiguous regions along a chromosome and later obtain a numeric representation for a larger region by merging the numeric representations of constituent regions along a genomic coordinate axis using merging operations for a designated concatenation axis, without recomputing per-position embeddings for the constituent regions.

In some examples of the first aspect, numeric representations corresponding to a collection of sequences or multidimensional signals are merged using associative merging operations that permit arbitrary grouping of intermediate merges while preserving the final result. For example, numeric representations for multiple segments of a multidimensional signal may be partitioned across processing devices, merged locally on each device to obtain partial numeric representations, and then merged again to obtain a numeric representation for the full signal, with the final numeric representation being invariant to the partitioning or grouping of segments as long as the order of segments along each coordinate axis is preserved.

In some examples of the first aspect, systems that analyze large collections of sequences or multidimensional signals use numeric representations as a first-stage scoring or filtering mechanism. For a query sequence or signal, the system may compute one or more numeric representations, retrieve numeric representations for stored sequences or signals from a vector database, and compute approximate similarity or alignment scores directly from pairs of numeric representations using algebraic operations involving the vector components and matrix components. The system can then select a subset of candidate sequences or signals based on the approximate scores for more detailed analysis, or return results directly when approximate similarity or alignment is sufficient for an application.

In some examples of the first aspect, alignment operations are performed along a subset of coordinate axes while preserving structure along remaining axes by manipulating matrix components associated with selected axes. For instance, a multidimensional analysis system may represent a signal using matrix components for spatial axes and one or more additional axes representing experimental conditions or modalities, and perform alignment by applying alignment transformations to matrix components associated with a spatial axis while leaving matrix components for other axes unchanged. This allows relative offsets to be estimated along a chosen axis while maintaining information encoded along the remaining axes.

In some examples of the first aspect, numeric representations are computed at multiple scales for the same underlying data. For example, a biological sequence processing system may compute numeric representations for short subsequences, genes, exons, or larger genomic regions, and may obtain numeric representations for higher-level structures by merging numeric representations for lower-level structures using associative merging operations. Because the numeric representations at each scale share the same vector-space dimension and matrix component sizes, hierarchical indexes can store and compare representations across scales and can navigate between fine-grained and coarse-grained summaries of the same underlying sequence or multidimensional signal.

In some examples of the first aspect, a PMVLE merging system and a multidimensional signal alignment system store axis-specific base matrices and associated integer exponents, maintain metadata linking each matrix component to a coordinate axis, and optionally share identical base matrices across axes while implementing merging operations using matrix-vector multiplication followed by vector addition. For example, for each coordinate axis in a coordinate axis system, the system may store a base matrix and represent each matrix component of a custom numeric representation or PMVLE in integer form as an integer exponent of the corresponding base matrix, with the base matrices themselves stored separately from the integer exponents. The system may compute dimensional powered orthogonal matrices and other powered matrices for early positions and reuse them for later positions by multiplying a stored powered matrix by the base matrix for a given axis instead of recomputing the powered matrix from an identity matrix. The system may maintain, for each matrix component, an axis identifier such as an axis index or name so that a mapping between coordinate axes and matrix components is a bijection and matrix components can be manipulated on a per-axis basis when performing concatenation, alignment or axis-specific transformations. In some examples of the first aspect, base matrices associated with at least two coordinate axes are identical, while separate matrix components and axis identifiers are still maintained for each axis in custom numeric representations. In such examples, merging operations on numeric representations may be implemented by multiplying matrix components associated with a concatenation axis, applying a resulting matrix to a vector component of one numeric representation using matrix-vector multiplication, and adding the transformed vector component to a vector component of another numeric representation to obtain a merged vector component, and repeated application of this merging operation is associative when a grouping of merges preserves the order of positions along each coordinate axis.

In some examples of the first aspect, aggregation, alignment and merging of numeric representations are accelerated by executing matrix-matrix and matrix-vector multiplications on a graphics processing unit. For example, a PMVLE aggregation system may batch embedding vectors for multiple positions of a multidimensional input signal, construct corresponding dimensional powered orthogonal matrices from axis-specific base matrices and integer exponents, and apply the powered matrices to the embedding vectors using matrix-vector or matrix-matrix multiplications performed by a graphics processing unit, followed by parallel reductions on the graphics processing unit to obtain a vector component of a numeric representation. In some examples of the first aspect, a multidimensional signal alignment system constructs batches of alignment matrices by raising base orthogonal matrices associated with coordinate axes to powers corresponding to candidate alignment offsets, applies the alignment matrices to vector components of numeric representations, and computes similarity scores between transformed vector components and other vector components in parallel on the graphics processing unit to identify candidate alignments having maximum similarity scores. In further examples of the first aspect, a streaming encoder or multidimensional signal merging unit maintains batches of numeric representations for positions of one-dimensional or multidimensional input signals and invokes kernels on a graphics processing unit to multiply matrix components, apply resulting matrices to vector components, and accumulate merged vector components in parallel to generate merged numeric representations for long sequences or large batches of signals.

In some examples of the first aspect, numeric representations, PMVLEs or other custom numeric representations produced by aggregation, alignment or merging systems are used as inputs to neural-network-based models and stored in databases such as vector databases. For example, an image processing system may transform an image or image tile into a custom numeric representation and provide a vector component, optionally together with selected matrix components or magnitude vectors derived from the vector component, as input to a convolutional or transformer-based neural network configured for object recognition in images. In another example, a sequence processing system may transform a one-dimensional input signal indexed by temporal coordinates into numeric representations for subsequences or windows and provide vector components as embeddings to a transducer configured for temporal sequence prediction. In some examples of the first aspect, custom numeric representations for multiple modalities, such as an image and an associated text caption, are merged along a designated concatenation axis to obtain a fused custom numeric representation, and the fused custom numeric representation is stored in a vector database together with references to underlying modalities. Downstream models can retrieve fused custom numeric representations from the database and use them in multimodal tasks such as cross-modal retrieval, multimodal classification, recommendation or other data-fusion applications.

In some examples of the first aspect, multidimensional alignment results computed from numeric representations are used for synchronization, registration and correlation of multidimensional input signals. For example, an audio-video processing system may use multidimensional alignment offsets to synchronize separate audio and video streams, and a medical-imaging system may use spatial alignment offsets to register two-dimensional or three-dimensional scans taken at different times or from different modalities. A telemetry system may use alignment offsets to correlate sensor readings from different devices or time bases. In some examples of the first aspect, multidimensional numeric representations and alignment procedures are applied to time-synchronized sensor data from autonomous-vehicle perception modules, where camera images, LiDAR range-depth maps, radar range-Doppler grids or occupancy grids are represented as multidimensional input signals, converted to custom numeric representations, and aligned in order to register sensor modalities into a common coordinate frame or compensate for vehicle motion. In some examples of the first aspect, a multidimensional signal alignment system includes a visualization component configured to display a multidimensional alignment result as a visualization overlay showing spatial offsets between multidimensional input signals by rendering one signal as a reference image, spatial map or grid and drawing indications of alignment offsets, such as shifted contours, grids or outlines, corresponding to another signal shifted by estimated alignment offsets along one or more coordinate axes. In some examples of the first aspect, alignment is performed using a multi-stage procedure in which a similarity unit first computes magnitude vectors from vector components of numeric representations, determines rough similarity scores between the magnitude vectors, and restricts a plurality of candidate alignments to candidate alignments whose rough similarity scores satisfy a threshold before computing similarity scores using full vector components and matrix components. In further examples of the first aspect, for one-dimensional input signals, an alignment unit represents vector components of numeric representations as complex vectors, computes complex-valued similarity measures such as complex inner products or frequency-domain correlations, obtains analytic estimates of alignment offsets from phases or arguments of the similarity measures, and refines each analytic estimate by evaluating similarity scores over a discrete neighborhood of integer offsets around the analytic estimate.

In some examples of the first aspect, a multidimensional signal merging unit maintains a merged custom numeric representation as a current state for a sequence or stream of multidimensional input signals and updates this state using merging operations along a concatenation axis. For example, the concatenation axis may correspond to a temporal axis for sequentially recorded data signals such as temporally ordered audio segments, telemetry windows or other time-indexed multidimensional input signals, and the system may obtain a numeric representation for each new multidimensional input signal and merge the numeric representation with the current state without recomputing the merged custom numeric representation from previously processed multidimensional input signals. Because a dimension of a vector space and sizes of base matrices are fixed for an application, merging any number of numeric representations yields a merged custom numeric representation having a fixed-size vector component and fixed-size matrix components. In some examples of the first aspect, a multidimensional signal merging unit normalizes a merged vector component using a scaling factor computed from magnitudes or norms of constituent vector components or elements of associated magnitude vectors, so that after a merged vector component is obtained by adding a vector component of a first numeric representation to a transformed version of a vector component of a second numeric representation, the merged vector component is scaled by the scaling factor to improve numerical stability or enforce bounded norms while preserving directional information contributed by the constituent vector components.

In some examples of the first aspect, a one-dimensional streaming encoder receives a one-dimensional input signal comprising an ordered sequence of input data values, obtains a one-dimensional signal of numeric representations in which each numeric representation corresponds to a position in the sequence and comprises a vector component in a fixed-dimension vector space and a matrix component in a CNM set of matrices acting on the vector space by matrix-vector multiplication, and performs a sequence of merging operations in an order of positions. The streaming encoder may output the vector component of a final merged numeric representation as a numeric embedding of the one-dimensional input signal and supply this numeric embedding to a neural-network-based model configured for classification, prediction, retrieval or anomaly detection on one-dimensional signals or sequences, including temporal sequence prediction. In some examples of the first aspect, the CNM set is a matrix group or a linear-transformation semigroup equipped with matrix multiplication as a non-abelian associative binary operation, and there exist pairs of distinct matrix components for which an order of matrix multiplication affects a product of the matrix components. In further examples of the first aspect, vector components and matrix entries are quaternion-valued or dual-quaternion-valued, and matrices implement quaternion or dual-quaternion linear transformations on the vector components.

In some examples of the first aspect, a multidimensional signal such as an image is represented in a coordinate axis system in which a minimal bounding prism has one corner at an origin. When the image or signal is shifted in the coordinate axis system by integer offsets along one or more coordinate axes, the exponents of the base orthogonal matrices used for the matrix components of a powered matrix vector linear embedding (PMVLE) are correspondingly changed by the offsets. For example, when the image is shifted by a first number of positions along a first coordinate axis and a second number of positions along a second coordinate axis, a first matrix component may change from a base orthogonal matrix raised to a first exponent to the same base orthogonal matrix raised to a sum of the first exponent and the first number, and a second matrix component may change from a base orthogonal matrix raised to a second exponent to the same base orthogonal matrix raised to a sum of the second exponent and the second number. In addition, a vector component of a PMVLE representation of the shifted image may be obtained by multiplying a vector component of a PMVLE representation of the unshifted image by an alignment matrix defined as a product of powers of base orthogonal matrices corresponding to the respective integer offsets along the coordinate axes.

In some examples, when two multidimensional input signals are concatenated along a selected concatenation coordinate axis, lengths of minimal bounding prisms along non-concatenation coordinate axes are required to match. For example, for each coordinate axis other than the concatenation axis, a length, along that coordinate axis, of a minimal bounding prism that encloses a first multidimensional input signal may be equal to a length, along that coordinate axis, of a minimal bounding prism that encloses a second multidimensional input signal. In such examples, numeric representations of the first and second multidimensional input signals may include matrix components associated with the non-concatenation coordinate axes that are identical between the numeric representations, and a merged numeric representation may be generated by updating only a matrix component associated with the concatenation axis and a vector component of the numeric representation while leaving matrix components associated with non-concatenation coordinate axes unchanged.

In another example, the lengths of minimal bounding prisms along one or more non-concatenation coordinate axes for two multidimensional input signals to be concatenated along a concatenation coordinate axis need not match initially. For each non-concatenation coordinate axis, a first length, along that axis, of a minimal bounding prism that encloses a first multidimensional input signal and a second length, along that axis, of a minimal bounding prism that encloses a second multidimensional input signal may be determined, and when the first length and the second length differ, a minimal bounding prism for at least one of the multidimensional input signals may be extended along that non-concatenation coordinate axis so that both multidimensional input signals share a common length equal to a maximum of the first length and the second length. Embedding vectors for positions introduced by the extension may be assigned so that undefined positions correspond to zero embedding vectors or to neutral embedding vectors that do not change a powered-matrix aggregation result. Matrix components associated with the extended non-concatenation coordinate axis in numeric representations of the multidimensional input signals may be updated so that each such matrix component is equal to a base matrix for that coordinate axis raised to a power equal to the common length along that axis. After these updates, a merged numeric representation may be generated by applying a concatenation operation along the concatenation coordinate axis as described herein.

In some examples, a multidimensional input signal representing an image defined on a two-dimensional Cartesian grid is re-indexed in a polar coordinate representation prior to PMVLE aggregation. A coordinate-axis system is defined with a first coordinate axis corresponding to a radius index and a second coordinate axis corresponding to an angle index obtained by sampling an angular coordinate around a selected center point of the image. The coordinate-axis system is Cartesian in index space, with positions identified by pairs of radius and angle indices. A PMVLE aggregation unit may associate a base orthogonal matrix with the radius axis and a base orthogonal matrix with the angle axis, construct a positional powered matrix for each position as a product of the base matrices raised to powers corresponding to the radius and angle indices, apply the positional powered matrix to an embedding vector at that position, and aggregate the transformed embedding vectors into a vector component of a numeric representation. Matrix components of the numeric representation may be equal to the base matrices raised to powers corresponding to lengths, along the radius and angle axes, of a minimal bounding prism that encloses the polar representation of the image. In such examples, a rotation of the image in the plane by an integer multiple of the angular sampling interval corresponds to a shift of the image content along the angle axis while leaving radius indices unchanged, and a PMVLE numeric representation of the rotated image can be related to a PMVLE numeric representation of the unrotated image by updating the exponent associated with the angle axis and multiplying the vector component of the unrotated representation by an alignment matrix equal to the base matrix associated with the angle axis raised to a power corresponding to the angular offset.

In some implementations of a polar-coordinate or angle-indexed PMVLE, the base orthogonal matrix associated with an angle axis is chosen so that a full 360-degree rotation corresponds to an identity transformation on the matrix component for that axis. For example, if the angle axis comprises a discrete set of L angular positions covering a full 360-degree range, the base orthogonal matrix R_θ for the angle axis may be selected to have finite order L under matrix multiplication so that R_θ\hat{ }L is equal to an identity matrix. In examples in which R_θ is implemented as a block-diagonal orthogonal matrix with 2×2 rotation submatrices, each 2×2 submatrix may be chosen as a rotation by an angle that is an integer multiple of 2π/L so that raising R_θ to the L-th power results in each 2×2 block returning to an identity matrix. In such examples, rotating an image by an integer multiple of the angular sampling interval and then by a full 360-degree cycle leaves the matrix component associated with the angle axis unchanged, and angular offsets can be represented by integer exponents modulo L or by real-valued exponents whose values differ by integer multiples of L corresponding to the same physical orientation.

In some examples, an image or multidimensional signal is re-indexed in a log-polar coordinate system prior to PMVLE aggregation so that both rotation and isotropic scaling become shifts along coordinate axes. A coordinate-axis system is defined with a first axis corresponding to a log-radius coordinate p obtained by applying a monotonically increasing function such as a logarithm to a radius coordinate and a second axis corresponding to a discrete angle index sampling orientation around a center point. The PMVLE aggregation unit associates a base orthogonal matrix R_ρ with the log-radius axis and a base orthogonal matrix R_θ with the angle axis, constructs a positional powered matrix for each position as a product of R_ρ raised to an exponent derived from the log-radius coordinate and R_θ raised to an exponent derived from the angle index, applies the positional powered matrix to an embedding vector at that position, and aggregates the transformed embedding vectors into a vector component of a numeric representation. Matrix components may be set equal to R_ρ and R_θ raised to powers corresponding to lengths of a minimal bounding prism along the log-radius and angle axes. In such examples, an isotropic scaling of the image that multiplies radius values by a positive factor corresponds to an additive offset along the log-radius axis, and a rotation corresponds to an offset along the angle axis, so that PMVLE numeric representations of scaled and rotated versions of an image can be related to a PMVLE numeric representation of a reference image by updating exponents associated with the log-radius and angle axes according to scale and rotation offsets and multiplying the vector component of the reference representation by an alignment matrix equal to a product of powers of R_ρ and R_θ corresponding to the offsets.

Although many examples describe multidimensional signals directly on Cartesian spatial grids, in some examples a signal that is naturally defined in another coordinate system, such as a polar, cylindrical, spherical, or log-polar coordinate system, is sampled or re-indexed onto a discrete multidimensional grid whose axes correspond to indices derived from the non-Cartesian coordinates. For example, an image defined in Cartesian x-y space may be mapped to a regular grid of radius indices and angle indices obtained from polar coordinates relative to a selected origin, and a three-dimensional volume may be mapped to radius, polar-angle, and azimuth-angle indices obtained from spherical coordinates. In such examples, the coordinate axes used by PMVLE constructions are Cartesian in index space, with mutually orthogonal axes corresponding to the index dimensions, and base matrices associated with these axes operate on an embedding vector space in the same manner as for purely Cartesian spatial axes, while the underlying physical coordinates of the original signal are encoded indirectly through an index-to-coordinate mapping.

In some examples, an additional coordinate axis represents a discrete orientation of an object or signal relative to a reference frame. The orientation axis may take on a finite set of orientation indices corresponding to discrete rotations, for example indices 0, 1, 2, and 3 corresponding to orientations of 0°, 90°, 180°, and 270° about a fixed origin. A base orthogonal matrix is associated with the orientation axis in the same manner as for spatial axes, and a matrix component of a numeric representation corresponding to the orientation axis is equal to the base orthogonal matrix raised to a power corresponding to the orientation index. The base orthogonal matrix for the orientation axis may be chosen to have finite order equal to the number of discrete orientations so that raising the base orthogonal matrix to a power corresponding to a full 360-degree rotation returns an identity matrix. Rotating an object from a first discrete orientation to a second discrete orientation can then be represented by changing only the exponent associated with the orientation matrix component and, in some implementations, by multiplying a vector component of a numeric representation for the first orientation by a power of the base orthogonal matrix for the orientation axis corresponding to the change in orientation, thereby treating rotation as a shift along the orientation axis analogous to shifts along spatial axes.

In some examples, a multidimensional input signal is represented with respect to a plurality of coordinate-axis systems rather than a single coordinate-axis system. Each coordinate-axis system may be a Cartesian coordinate system having a plurality of mutually orthogonal axes and may be related to one or more other coordinate-axis systems by a transformation such as a rigid rotation, reflection, scaling, or a change of variables that maps Cartesian spatial coordinates to alternative coordinates such as polar or log-polar coordinates. For each coordinate-axis system, a PMVLE aggregation unit may generate a numeric representation of the same underlying multidimensional input signal using a corresponding set of base matrices and lengths of minimal bounding prisms along the axes of that coordinate-axis system, so that the multidimensional input signal is associated with a plurality of numeric representations, each corresponding to a different coordinate-axis system, analogous to left-right or multi-directional representations described for one-dimensional sequences.

In some examples, a plurality of coordinate-axis systems are defined as rotated versions of a reference Cartesian coordinate-axis system for images or multidimensional signals. For example, four coordinate-axis systems may be defined corresponding to rotations of 0 degrees, 90 degrees, 180 degrees, and 270 degrees about an origin, with each coordinate-axis system having its own x- and y-axes that are obtained by rotating a reference pair of axes. A PMVLE aggregation unit may, for each such rotated coordinate-axis system, treat a multidimensional input signal as being defined on a grid indexed by coordinates of that system and may generate a corresponding numeric representation having a vector component and matrix components associated with the rotated x- and y-axes using base matrices that may be shared or distinct across coordinate-axis systems. In some implementations, base matrices associated with axes in different rotated coordinate-axis systems are chosen so that relationships between numeric representations reflect the underlying rotations in the signal domain, and multiple rotated numeric representations may be used jointly in downstream processing to improve robustness to rotations, providing a higher-dimensional analogue of left-right or bidirectional sequence representations in which the same underlying sequence is processed in opposite directions.

In some examples, a multidimensional input signal is embedded with respect to both a Cartesian spatial coordinate-axis system and one or more non-Cartesian coordinate systems that have been mapped to Cartesian index axes, such as polar or log-polar coordinate systems. For example, an image may be embedded using a first PMVLE aggregation defined on a Cartesian x-y grid, a second PMVLE aggregation defined on a polar grid of radius and angle indices derived from the same image, and, in some examples, a third PMVLE aggregation defined on a log-polar grid with axes corresponding to log-radius and angle indices. Each aggregation produces a numeric representation of the image with respect to the corresponding coordinate axes, and the set of these numeric representations may be treated as a multi-coordinate representation of the image that captures complementary invariances and sensitivities associated with different coordinate systems.

In some examples, a multi-coordinate representation of a signal is maintained as a collection or multiset of numeric representations, with one numeric representation per coordinate-axis system as described above. For example, a representation of an image may comprise a collection of PMVLE numeric representations respectively corresponding to a Cartesian coordinate-axis system, one or more rotated Cartesian coordinate-axis systems, and one or more polar or log-polar coordinate-axis systems. The collection may be used directly as a set of custom embeddings for downstream tasks, for example by applying attention or selection mechanisms over the collection. In other examples, the collection of numeric representations associated with a plurality of coordinate-axis systems is combined into a single numeric representation using an abelian composition operation over the collection; for example, vector components of the numeric representations for different coordinate-axis systems may be combined by an abelian operation such as an elementwise sum, weighted sum, or average to yield a composite vector component, while matrix components may be combined by storing a tuple of matrix components per coordinate-axis system or by defining an abelian operation on matrix components such as concatenation into a block-diagonal matrix or a direct-sum construction. In such examples, the collection of numeric representations across coordinate-axis systems forms a multiset of custom embeddings in a CNM set, and an abelian operation of the CNM set may be used to perform a composition over the multiset to obtain a single composite embedding that is less sensitive to the choice of coordinate-axis system and may provide increased invariance to rotations, reflections, or scalings of the underlying signal.

In some examples, downsampled and upsampled versions of a multidimensional input signal are modeled as the same underlying signal expressed in scaled Cartesian coordinate-axis systems. For example, a first coordinate-axis system may correspond to a fine-resolution grid in which successive coordinate values along an axis represent a first physical spacing, and a second coordinate-axis system may correspond to a coarser grid in which successive coordinate values represent a larger physical spacing, such as an integer multiple of the first spacing. A PMVLE aggregation unit may generate a numeric representation of the signal on each such scaled Cartesian coordinate-axis system using base matrices associated with the axes and lengths of minimal bounding prisms expressed in the units of the corresponding coordinate system. Each numeric representation captures information at a different effective resolution or scale, and the set of these representations may be stored and used jointly as a multi-scale representation of the signal or combined by an abelian operation on vector components to form a composite multi-scale embedding, while the details of interpolation, resampling, and filtering between resolutions are handled by embedding functions or preprocessing modules.

In some examples, a composite multidimensional input signal is formed from a plurality of component multidimensional input signals that occupy disjoint or partially overlapping subsets of a common domain. For example, a set of images or image fragments having irregular or “puzzle-piece” support shapes may together fill a larger image region when fitted into a common bounding region, with each component image or fragment defined only on a subset of positions within that region. A coordinate-axis system and a minimal bounding prism having one corner at an origin may be defined so that the minimal bounding prism encloses the union of the supports of all component multidimensional input signals. For each component multidimensional input signal, undefined positions within the minimal bounding prism may be treated as having embedding vectors equal to zero vectors or neutral embedding vectors that do not change a PMVLE aggregation result. A PMVLE aggregation unit may map each defined input data value of a component multidimensional input signal to an embedding vector, map undefined positions within the minimal bounding prism to zero embedding vectors, construct positional powered matrices for positions within the minimal bounding prism using base matrices and coordinate values along the axes, apply the positional powered matrices to the embedding vectors, and sum the resulting transformed embedding vectors to obtain a vector component of a numeric representation for that component multidimensional input signal, while matrix components are set equal to base matrices raised to powers equal to lengths, along the axes, of the common minimal bounding prism. In such examples, when the minimal bounding prism and associated matrix components are matched across component representations, a numeric representation of a composite multidimensional input signal corresponding to the union of the component signals may be obtained as an abelian sum of the vector components of the numeric representations of the component signals, and this construction generalizes to n-dimensional signals whose supports are irregular subsets of a common n-dimensional minimal bounding prism.

In some examples, a multidimensional input signal is decomposed into a finite set of constituent parts, each defined on a subset of positions within a common minimal bounding prism and assigned a numeric representation having a vector component and matrix components determined by lengths of the minimal bounding prism along the coordinate axes. For each constituent part, a desired final position within a recomposed multidimensional input signal is specified; when the current position of the constituent part already matches the desired position, no shift is applied and the numeric representation of the part is used directly after, if necessary, updating matrix components so that all constituent parts share identical matrix components corresponding to the common minimal bounding prism. When a constituent part must be moved to a different position, an alignment transform is applied to its numeric representation to shift the vector component to the desired position while updating matrix components as needed so that, after adjustment, all constituent parts again share the same matrix components. Reconstructing the signal from its constituent parts is then performed in the numeric representation space by an abelian sum of the vector components of all adjusted constituent-part representations together with the shared matrix components. In some examples, this construction is used to concatenate two multidimensional input signals along a concatenation direction that is not aligned with any single coordinate axis by decomposing each signal into constituent parts, applying alignment transforms only to those parts whose positions must change in the concatenated layout, matching matrix components to a common minimal bounding prism, and then obtaining a numeric representation of the concatenated signal by abelian summation of the resulting vector components.

In some examples, a multidimensional input signal has five data dimensions corresponding to three spatial coordinates, time, and a channel index. For example, a medical imaging system may acquire a time series of three-dimensional volumes, where each volume comprises multiple channels such as different MRI contrasts or derived feature maps, and a coordinate-axis system is defined with axes (x, y, z, t, c) indexing spatial position, time, and channel. A PMVLE aggregation unit may associate a base matrix with each of the five axes and, for each position within a minimal bounding prism defined over the 5D grid, map the input data value to an embedding vector, construct a positional powered matrix as a product of the base matrices raised to powers corresponding to the coordinate values along the axes, apply the powered matrix to the embedding vector, and aggregate the transformed embedding vectors into a vector component of a numeric representation, while matrix components are set equal to the base matrices raised to powers corresponding to lengths, along each axis, of the minimal bounding prism. In such examples, the numeric representation provides a fixed-size embedding of the full 5D spatiotemporal, multi-channel signal regardless of the number of spatial locations, time points, or channels in the underlying data.

In some examples, a multidimensional input signal represents multispectral or hyperspectral video data with axes corresponding to spatial coordinates, time, and wavelength or spectral band indices, optionally together with one or more additional axes such as altitude or feature-channel index. For example, a remote sensing system may acquire a sequence of satellite images over time with hundreds of spectral bands, and a coordinate-axis system may be defined with axes (x, y, t, λ) or (x, y, z, t, λ, c) where λ indexes spectral bands and c indexes derived feature channels. A PMVLE aggregation unit may assign base matrices to each axis of this 5D or 6D coordinate-axis system, define a minimal bounding prism enclosing the sampled domain, and generate a numeric representation by mapping each data value to an embedding vector, applying positional powered matrices constructed from the base matrices and coordinate values, and summing the transformed embedding vectors, with matrix components equal to the base matrices raised to powers corresponding to lengths along the axes. The resulting numeric representation yields a fixed-size embedding of the multispectral or hyperspectral video signal that is independent of the number of spatial locations, time steps, spectral bands, or feature channels.

In some examples, a multidimensional input signal corresponds to scientific or experimental data indexed by more than four data dimensions, such as three spatial dimensions, time, variable index, subject index, condition index, or trial index. For example, outputs from a numerical simulation may be defined on a 5D grid with axes (x, y, z, t, v) where v indexes physical variables such as pressure, temperature, and velocity components, or experimental recordings may be defined on axes (x, y, z, t, subject, condition). A coordinate-axis system is defined with one axis per data dimension, and a PMVLE aggregation unit associates a base matrix with each axis and constructs a minimal bounding prism enclosing the support of the signal. For each position in the n-dimensional grid, the PMVLE aggregation unit maps the input data value to an embedding vector, applies a positional powered matrix derived from the base matrices and coordinate values, and aggregates the transformed embedding vectors, while matrix components of the numeric representation are set to base matrices raised to powers corresponding to lengths along each axis of the minimal bounding prism. This yields a fixed-size numeric representation of n-dimensional signals for arbitrary n, enabling storage and downstream processing of high-dimensional scientific and experimental data in a unified embedding format.

In some examples of the recursive autoregressive generative neural network, modifying the received embedding at a position using the contextual correction embedding for the position retrieved from the storage device comprises applying one or more learned transformations to a combination of the received embedding and the contextual correction embedding rather than only adding the contextual correction embedding to the received embedding. For example, a combined embedding may be formed by concatenating the received embedding and the contextual correction embedding to obtain a higher-dimensional vector, and a learned projection such as a linear or multilayer transformation may be applied to the combined embedding to obtain an updated contextualized embedding at the position that has the same embedding dimension as the received embedding. In some examples, the combination of the received embedding and the contextual correction embedding may further include operations such as gating, elementwise addition, or elementwise multiplication before or after the learned projection, and the resulting updated contextualized embedding is output at the position and used as the received embedding for a subsequent layer or iteration of the recursive autoregressive generative neural network as described elsewhere herein.

In some examples, molecular structures such as small molecules or macromolecular complexes are discretized as two-dimensional signals and processed using the same numeric representation and alignment methods described herein for multidimensional input signals. For example, a molecular structure may be represented as a two-dimensional grid whose entries encode pairwise relationships between atoms or residues, such as contact values, inter-atomic distances, or interaction strengths, or as a two-dimensional image-like representation of the structure. A coordinate-axis system is defined with two spatial axes indexing rows and columns of the grid, a minimal bounding prism is chosen to enclose the two-dimensional domain, and a numeric representation of the discretized molecular structure is generated by mapping grid values to embedding vectors, constructing positional powered matrices from base matrices associated with the axes and coordinate values, applying the positional powered matrices to the embedding vectors, and aggregating the transformed embedding vectors into a vector component with matrix components equal to the base matrices raised to powers corresponding to lengths along the axes. Numeric representations of two discretized molecular structures may then be aligned using the multidimensional alignment system described herein, and the resulting alignment offsets and similarity scores may be interpreted as identifying aligned substructures or motifs in the molecular structures and used to retrieve additional molecular structures from a database based on similarity of numeric representations.

In another example, a multi-turn chatbot conversation between a user and an automated agent is modeled as a two-dimensional signal defined on a discrete grid in which a first coordinate axis indexes tokens produced by the user and a second coordinate axis indexes tokens produced by the chatbot. For a simple conversation in which the user produces two words, the chatbot produces two words, and the user produces two additional words, and in which each word is treated as a separate token, the six tokens may be associated, in temporal order, with grid indices (0, 0), (1, 0), (1, 1), (1, 2), (2, 2), and (3, 2), where the first component of each index corresponds to a user-axis index and the second component corresponds to a chatbot-axis index. When these occupied positions are plotted on the two-dimensional grid, they trace out a ladder-like pattern in which horizontal runs along one axis correspond to consecutive tokens from a single speaker and vertical transitions between the axes correspond to turn changes between the user and the chatbot. In some examples, a positional powered-matrix vector lattice embedding (PMVLE) subsystem associates a first base orthogonal matrix with the user-axis and a second base orthogonal matrix with the chatbot-axis. Each token at coordinate (i, j) is mapped to an embedding vector and a positional powered matrix obtained by raising the base orthogonal matrix for the user-axis to a power corresponding to i and raising the base orthogonal matrix for the chatbot-axis to a power corresponding to j and multiplying the resulting powers in a fixed order. The embedding and positional powered matrix together define a custom numeric representation of the token at that grid position. A two-dimensional transformer architecture is then applied to the grid of token positions, with self-attention layers defined over the two-dimensional lattice rather than a one-dimensional sequence. In some examples, each attention head is configured to attend over neighborhoods in the two-dimensional grid that are defined in terms of both the user-axis index and the chatbot-axis index, so that attention patterns can simultaneously capture dependencies within a user utterance, within a chatbot response, and across turn boundaries along the ladder pattern. The two-dimensional transformer receives, as input, the custom numeric representations for occupied grid positions and is trained with an autoregressive objective to predict, for each training step, a next token and its associated grid coordinate extending the ladder pattern. The two-dimensional transformer thus implements text token prediction directly over the two-dimensional turn-taking grid, instead of reducing the grid to a one-dimensional sequence, while still leveraging the PMVLE-based positional structure on both axes. The custom numeric representations output by the two-dimensional transformer, or intermediate custom numeric representations associated with the multi-turn dialogue, may be stored in a database and used for downstream tasks such as dialogue-state classification, retrieval of similar conversations, or conditioning of a language model in a retrieval-augmented chatbot system.

In light of the foregoing examples, it will be understood that a person of ordinary skill in the art can readily devise numerous variations and substitutions without departing from the scope of the described systems and methods. For example, operations that combine embeddings or intermediate representations (including but not limited to simple addition, concatenation followed by learned projection, gating, elementwise multiplication, or multi-layer transformations) may be interchanged or composed in different orders; aggregations over collections of embeddings may use abelian or non-abelian operations, alternative norms, or learned pooling functions; coordinate-axis systems may be chosen from among multiple Cartesian or index-based reparameterizations (including scaled, rotated, or reindexed versions) for the same underlying signal; and parameters may be shared, tied, or derived across layers or networks by direct reuse or by learned mappings. Unless expressly stated otherwise, such variations, substitutions, and rearrangements are intended to be encompassed by the present disclosure, and the specific examples herein are illustrative rather than limiting.

In some examples, a system of one or more computers may be configured to perform the operations described herein by virtue of software, firmware, hardware, or any combination thereof installed on the system and executable to cause the system to perform the operations. In some examples, one or more computer programs include instructions which, when executed by data-processing apparatus (e.g., one or more processors, GPUs, TPUs, FPGAs, or ASICs), cause the apparatus to perform the operations. In further examples, logic may be realized as microcode, programmable logic, or fixed-function circuitry.

In one example, the system includes one or more computers having one or more processors and memory (e.g., volatile and/or non-volatile storage). The memory or other computer-readable storage media (e.g., flash memory, solid-state drives, magnetic or optical media) store instructions, programs, modules, models, data structures, and parameters that, when executed or accessed by a processor, configure the processor to carry out the methods disclosed herein. As used herein, the phrase “non-transitory computer-readable storage medium” excludes transitory propagating signals per se.

It will be appreciated by those skilled in the art that modifications, substitutions, and combinations can be made to the examples described without departing from the spirit and scope of the disclosure as defined by the claims. Features and components disclosed in connection with the first aspect, the second aspect, and the third aspect may be used individually or in any technically compatible combination unless expressly stated otherwise; for example, modules, data structures, training schemes, retrieval mechanisms, non-abelian merging operations, and flow arrangements described for one aspect may be incorporated into or interchanged with counterparts of another aspect. System examples may correspond to method examples and vice versa. Unless expressly stated otherwise, “a,” “an,” and “the” mean “one or more,” “or” means “and/or,” and “including” and “comprising” are open-ended and do not exclude additional elements or acts.

Unless a particular order is expressly required, the steps of any method disclosed herein may be performed in any suitable order, with steps added, omitted, executed in parallel, or repeated while remaining within the scope of the claims. Headings and reference numerals are for convenience and do not limit the claims. Where any claim is drafted in means-plus-function form, corresponding structure includes the implementations disclosed herein and equivalents thereof.

I claim:

1. A data processing system configured to process multidimensional input data signals using a coordinate axis system having a plurality of coordinate axes, wherein the number of coordinate axes matches the number of data dimensions of the multidimensional input data signal being processed, and to generate a custom numeric representation of the multidimensional input data signal being processed, wherein the custom numeric representation comprises a vector component from a vector space and a set of matrix components that act on the vector space by matrix-vector multiplication, the set of matrix components comprising one matrix component for each coordinate axis of the coordinate axis system, wherein the embedding dimension of the vector space is independent of the signal size and signal support shape of the multidimensional input data signal being processed, the data processing system comprising:
one or more processors; and
one or more non-transitory computer readable storage devices storing instructions that when executed by the one or more processors cause the one or more processors to:
obtain a set of base matrices configured to act on the vector-space by matrix-vector multiplication, the set of base matrices comprising one base matrix for each coordinate axis of the coordinate axis system, wherein the base matrices are independent of the input data values and mutually commute, wherein each base matrix has a size that is independent of the signal size and signal support shape of the multidimensional input signal being processed;
receive a multidimensional input signal comprising a plurality of input data values arranged according to a coordinate axis system defining a position of the input data values;
map each input data value to a corresponding embedding vector that is an element of the vector space to generate a multidimensional array of embedding vectors;
compute, for each position in the multidimensional array of embedding vectors, a positional matrix that is computed from the product, over the coordinate axes, of the base matrix associated with that coordinate axis raised to a power corresponding to the index of the position along that axis;
multiply the embedding vector at each position by the positional matrix at the position to obtain a multidimensional array of transformed embedding vectors;
perform vector addition on the transformed embedding vectors into an aggregated vector;
output a custom numeric representation comprising:
a vector component that corresponds to the aggregated vector; and
a plurality of matrix components, one matrix component for each coordinate axis, wherein, for each coordinate axis, a matrix component of the custom numeric representation is equal to the base matrix associated with that coordinate axis raised to a power corresponding to a length, along that coordinate axis, of a minimal bounding prism that encloses the multidimensional input signal; and
store the custom numeric representation in the one or more non-transitory computer readable storage devices for use by one or more downstream processing tasks.

2. The system of claim 1, wherein the multidimensional input signal comprises at least one of an image, a video frame sequence, an audio spectrogram, a text, or a multidimensional sensor measurement.

3. The system of claim 1, wherein the multidimensional input signal comprises an image represented by pixel values on a two-dimensional grid having a height and a width,
wherein the coordinate axis system comprises two coordinate axes respectively corresponding to the height and the width of the image, and
wherein the fixed embedding dimension of the vector space and the sizes of the base matrices are independent of the height and the width of the image and of a signal support shape of the image within the two-dimensional grid.

4. The system of claim 1, wherein the multidimensional input signal comprises an audio signal represented as a one-dimensional sequence of audio samples having a length along a temporal axis, the coordinate axis system comprises a single coordinate axis corresponding to the temporal axis, and the fixed embedding dimension of the vector space and the sizes of the base matrices are independent of the length of the audio signal.

5. The system of claim 1, wherein the vector addition of transformed embedding vectors is performed by:
storing, for each coordinate axis, the corresponding base matrix and integer exponents representing indices of positions along that coordinate axis;
computing positional matrices for positions along the coordinate axis system and storing the computed positional matrices in the one or more non-transitory computer readable storage devices;
for respective positions along a coordinate axis of the plurality of coordinate axes, exploiting associativity of matrix multiplication by computing a positional matrix for a later position along that coordinate axis by multiplying the base matrix for that coordinate axis by a previously computed positional matrix for an earlier position along that coordinate axis;
for positions that require a positional matrix that has already been computed, obtaining the positional matrix from the one or more non-transitory computer readable storage devices instead of recomputing the positional matrix from the base matrix and integer exponents; and
accumulating the transformed embedding vectors into the vector component of the custom numeric representation as a streaming sequence of additions without recomputing positional matrices or powered matrices that have already been generated.

6. The system of claim 1, wherein the base matrices are orthogonal matrices and are implemented as block diagonal matrices with 2×2 orthogonal submatrices.

7. The system of claim 1, wherein a dimension of the vector space and a size of each respective base matrix are fixed for an application such that a size of the custom numeric representation stored for each multidimensional input signal is independent of a number of input data values in the multidimensional input signal.

8. A data alignment system configured to align multidimensional input data signals using a coordinate axis system having a plurality of coordinate axes, wherein the number of coordinate axes matches the number of data dimensions of the multidimensional input data signals being aligned, and custom numeric representations, wherein a custom numeric representation comprises a vector component that is an element of a vector space of fixed embedding dimension, and a set of orthogonal matrix components that act on the vector space by matrix-vector multiplication, the set of orthogonal matrix components comprising one orthogonal matrix component for each coordinate axis of the coordinate axis system, the data alignment system comprising:
one or more processors; and
one or more non-transitory computer-readable storage devices storing instructions that when executed by the one or more processors cause the one or more processors to:
obtain a set of base orthogonal matrices configured to act on the vector-space by matrix-vector multiplication, the set of base orthogonal matrices comprising one base orthogonal matrix for each coordinate axis, wherein the base orthogonal matrices are independent of the input data values and commute with one another, wherein the embedding dimension of the vector space and the size of the base orthogonal matrices are independent of signal size and signal support shape of multidimensional input signals to be aligned, and wherein the number of coordinate axes is equal to the number of data dimensions of the multidimensional input signals; and
obtain first and second custom numeric representations corresponding to a given pair of multidimensional input signals, wherein the orthogonal matrix component of each custom numeric representation associated with a coordinate axis is computed from the base orthogonal matrix for that coordinate axis raised to a power corresponding to a length, along that coordinate axis, of a minimal bounding prism that encloses the corresponding multidimensional input signal;
compute, for a plurality of candidate alignments, a transformed first vector, for a given candidate alignment by:
determining, for each coordinate axis, an alignment offset specified by the candidate alignment;
computing an alignment matrix equal to a product, over the coordinate axes, of the base orthogonal matrix for that coordinate axis raised to a power corresponding to the alignment offset along that axis; and
multiplying the vector component of the first custom numeric representation by the alignment matrix;
compute a similarity score between the transformed first vector and the vector component of the second custom numeric representation;
identify a maximum similarity score among the candidate alignments and output the alignment corresponding to the maximum similarity score as a multidimensional alignment result; and
store the multidimensional alignment result in the one or more non-transitory computer readable storage devices for synchronization, registration, or correlation of the multidimensional input signals.

9. The system of claim 8, wherein the first and second multidimensional input signals are of different sizes along at least one coordinate axis, and wherein the multidimensional alignment result is computed using the first and second custom numeric representations without requiring resampling or resizing of either multidimensional input signal.

10. The system of claim 8, wherein computing the similarity score further comprises:
computing magnitude vectors from the vector components of the first and second custom numeric representations by grouping consecutive elements into fixed-size blocks and taking a norm of each block;
computing a rough similarity score between the magnitude vectors; and
restricting the plurality of candidate alignments to candidates whose rough similarity score exceeds a threshold before computing similarity using the full vector components.

11. The system of claim 8, wherein for one-dimensional input signals the data alignment system is configured to compute an analytic estimate of the alignment offset from complex representations of pairs of vector components, and to refine the estimate by evaluating similarity scores over a discrete neighborhood of integer offsets around the analytic estimate.

12. The system of claim 8, wherein computing the similarity scores and identifying the multidimensional alignment result are performed using only the first and second custom numeric representations and the base orthogonal matrices stored in the one or more non-transitory computer-readable storage devices, without accessing the multidimensional input signals or any multidimensional arrays of embedding vectors corresponding to individual input data values.

13. The system of claim 8, wherein each base orthogonal matrix is implemented as a block-diagonal matrix with 2-by-2 orthogonal submatrices.

14. The system of claim 13, wherein the one or more processors are further configured to:
compute, for each custom numeric representation, a magnitude vector by grouping elements of a vector component of the custom numeric representation into consecutive two-element blocks and
compute, for each respective block, a norm of the two elements of the block, and to use similarity between magnitude vectors corresponding to first and second custom numeric representations as a shift-invariant proxy for similarity between the first and second multidimensional input signals to restrict candidate alignment offsets or candidate pairs of custom numeric representations considered by the data alignment system.

15. The system of claim 14, wherein the multidimensional input signals are one-dimensional input signals, and the one or more processors are further configured to compute, for each of the one-dimensional input signals, an m-abs representation by:
computing, for each contiguous subsequence of length m of the one-dimensional input signal, a custom numeric representation of the subsequence;
computing a magnitude vector from a vector component of the custom numeric representation of each subsequence;
performing an abelian summation of the magnitude vectors of all subsequences of length m to obtain the m-abs representation of each one-dimensional input signal; and
using similarity between the m-abs representations of the one-dimensional input signals to restrict candidate pairs of custom numeric representations or candidate alignment offsets considered by the data alignment system.

16. The system of claim 14, wherein the multidimensional input signals are two-dimensional input signals defined on respective two-dimensional grids, and the one or more processors are further configured to compute, for each of the two-dimensional input signals, an (n,m)-abs representation by:
computing, for each n-by-m sub-window of the two-dimensional grid, a custom numeric representation of the sub-window;
computing a magnitude vector from a vector component of the custom numeric representation of each sub-window; and
performing an abelian summation of the magnitude vectors of all n-by-m sub-windows to obtain the (n,m)-abs representation of each two-dimensional input signal; and
using similarity between the (n,m)-abs representations of the two-dimensional input signals to restrict candidate pairs of custom numeric representations or candidate alignment offsets considered by the data alignment system.

17. The system of claim 14, further comprising a database stored in the one or more non-transitory computer-readable storage devices and storing, for a plurality of multidimensional input signals, corresponding custom numeric representations and corresponding magnitude vectors, m-abs representations for one-dimensional input signals, and (n,m)-abs representations for two-dimensional input signals, wherein the one or more processors are configured to:
obtain a query custom numeric representation and a corresponding magnitude vector, m-abs representation, or (n,m)-abs representation for a query multidimensional input signal;
compute similarity scores between the query magnitude vector, m-abs representation, or (n,m)-abs representation and magnitude vectors, m-abs representations, or (n,m)-abs representations stored in the database for multidimensional input signals having the same dimensionality as the query multidimensional input signal;
identify candidate database signals based on the similarity scores; and, for the candidate database signals, compute multidimensional alignment results using the data alignment system.

18. The system of claim 17, wherein the one or more processors are further configured to provide one or more custom numeric representations retrieved from the database for the candidate database signals, together with corresponding multidimensional alignment results or similarity scores, as conditioning information to an autoregressive generative model in a retrieval-augmented generation system, and to use the multidimensional alignment results or similarity scores to select or weight database records that are supplied to the autoregressive generative model as context for generating outputs.

19. The system of claim 17, wherein the first and second multidimensional input signals are one-dimensional text signals comprising sequences of text tokens, and the database stores custom numeric representations corresponding to text segments derived from one-dimensional text signals, and wherein the one or more processors are configured, in a retrieval-augmented generation system, to obtain a custom numeric representation corresponding to a query one-dimensional text signal, compute similarity scores and multidimensional alignment results between the custom numeric representation of the query one-dimensional text signal and custom numeric representations stored in the database using the data alignment system, select one or more text segments from the database based on the similarity scores and multidimensional alignment results, and provide the selected text segments as retrieved context for a text generation system.

20. A computer-implemented merging system for generating a custom numeric representation of a concatenated multidimensional input signal from custom numeric representations of constituent multidimensional input signals comprising:
a coordinate axis system having a plurality of coordinate axes, wherein the number of coordinate axes matches the number of data dimensions of the multidimensional input data signals being concatenated, and
custom numeric representations, wherein a custom numeric representation comprises a vector component that is an element of a vector space of fixed embedding dimension, and a set of matrix components that act on the vector space by matrix-vector multiplication, the set of matrix components comprising one matrix component for each coordinate axis of the coordinate axis system,
the merging system comprising:
one or more processors; and
one or more non-transitory computer readable storage devices storing instructions that when executed by the one or more processors cause the one or more processors to:
receive a first custom numeric representation corresponding to a first multidimensional input signal and a second custom numeric representation corresponding to a second multidimensional input signal;
identify a concatenation axis along which the first and second input signals are to be concatenated, wherein, for each coordinate axis other than the concatenation axis,
a length, along that coordinate axis, of a minimal bounding prism that encloses the
first multidimensional input signal is equal to a length, along that coordinate axis,
of a minimal bounding prism that encloses the second multidimensional input signal,
and wherein matrix components associated with the non-concatenation coordinate axes
in the first and second custom numeric representations are identical;
compute a merged matrix component along the concatenation axis by multiplying the matrix components of the first and second custom numeric representations along that concatenation axis;
generate a merged vector component by adding the vector component of the first custom numeric representation to a transformed version of the vector component of the second custom numeric representation, the transformation being performed by applying the matrix component associated with the concatenation axis of the first custom numeric representation to the vector component of the second custom numeric representation; and
output a merged custom numeric representation comprising the merged vector component and the merged matrix components for storage or further processing.

21. The system of claim 20, wherein the concatenation axis corresponds to a temporal axis for sequentially recorded data signals.

22. The system of claim 20, wherein the one or more processors are configured to apply the merging operation repeatedly to custom numeric representations corresponding to a sequence of multidimensional input signals to obtain a merged custom numeric representation for the sequence, and wherein the merged custom numeric representation is independent of an order of grouping of the merging operations that preserves an order of the sequence of multidimensional input signals.

23. The system of claim 20, wherein the merged custom numeric representation is stored as a current state for a stream of multidimensional input signals and is updated when a new multidimensional input signal in the stream is received by merging the current state with a custom numeric representation corresponding to the new multidimensional input signal without recomputing the merged custom numeric representation from previously processed multidimensional input signals.
